(19) United States
(12) Patent Application Publication
(10) Pub. No.: US 2025/0123528 A1
(43) Pub. Date: Apr. 17, 2025

(54) TEMPERATURE AND THERMAL COMFORT MAPPING OF AN ENCLOSED ENVIRONMENT

(71) Applicant: View, Inc., Milpitas, CA (US)

(72) Inventors: Jack Kendrick Rasmus-Vorrath, Mountain House, CA (US); Nidhi Satyacharan Tiwari, San Jose, CA (US); Piers Iain Ivo Octavian MacNaughton, San Jose, CA (US); Ranojoy Dutta, San Jose, CA (US); Nitesh Trikha, Pleasanton, CA (US); Ahmed Mustafa, Fremont, CA (US); Robert Michael Martinson, Palo Alto, CA (US)

(21) Appl. No.: 18/286,521

(22) PCT Filed: Apr. 12, 2022
(86) PCT No.: PCT/US2022/024313

§ 371 Date: Oct. 11, 2023

Related U.S. Application Data
Application No. PCT/US2022/024313 is a continuation-in-part of application No. PCT/US2021/033544, filed on May 21, 2021.
(63) Continuation-in-part of application No. PCT/US2021/017603, filed on Feb. 11, 2021.
Application No. PCT/US2021/033544 is a continuation-in-part of application No. 17/250,586, filed on Feb. 5, 2021, now Pat. No. 12,124,147.
Application No. 17/250,586 is a continuation-in-part of application No. PCT/US19/23268, filed on Mar. 20, 2019.
Application No. PCT/US19/23268 is a continuation-in-part of application No. 16/013,770, filed on Jun. 20, 2018, now Pat. No. 10,802,372.
Application No. 16/013,770 is a continuation of application No. 15/347,677, filed on Nov. 9, 2016, now Pat. No. 10,048,561.
Application No. 15/347,677 is a continuation-in-part of application No. PCT/US2015/029675, filed on May 7, 2015.
Application No. 15/347,677 is a continuation-in-part of application No. 13/772,969, filed on Feb. 21, 2013, now Pat. No. 9,638,978.
Application No. PCT/US2019/046524 is a continuation-in-part of application No. 16/438,177, filed on Jun. 11, 2019, now Pat. No. 11,405,465.
Application No. 16/438,177 is a continuation of application No. 14/391,122, filed on Oct. 7, 2014, now Pat. No. 10,365,531.
(60) Provisional application No. 63/173,759, filed on Apr. 12, 2021.
(60) Provisional application No. 63/029,301, filed on May 22, 2020.
(60) Provisional application No. 63/033,474, filed on Jun. 2, 2020.
(60) Provisional application No. 63/145,333, filed on Feb. 3, 2021.
(60) Provisional application No. 63/075,569, filed on Sep. 8, 2020.
(60) Provisional application No. 62/975,677, filed on Feb. 12, 2020.
(60) Provisional application No. 62/805,841, filed on Feb. 14, 2019.
(60) Provisional application No. 62/646,260, filed on Mar. 21, 2018.
(60) Provisional application No. 62/745,920, filed on Oct. 15, 2018.
(60) Provisional application No. 62/764,821, filed on Aug. 15, 2018.
(60) Provisional application No. 62/666,572, filed on May 3, 2018.
(60) Provisional application No. 61/991,375, filed on May 9, 2014.
(60) Provisional application No. 61/624,175, filed on Apr. 13, 2012.

(51) Int. Cl. G02F 1/163; E06B 9/24; G02B 5/20; G05B 19/048

(52) U.S. Cl. CPC G02F 1/163; G05B 19/048; E06B 2009/2464; G02B 5/20; Y02P 90/84

(57) ABSTRACT

Changing environmental characteristics of an enclosure are controlled to promote thermal comfort, health, wellness, and/or performance for occupant(s) of the enclosure using sensor data, three-dimensional modeling, physical properties of the enclosure, and machine learning (e.g., Artificial Intelligence).

### RELATED APPLICATIONS

This application claims priority to U.S. Provisional Patent Application Ser. No. 63/173,759, filed Apr. 12, 2021, titled “TEMPERATURE AND THERMAL COMFORT MAPPING OF AN ENCLOSED ENVIRONMENT.” This application claims priority to, and is a Continuation-In-Part, of International Patent Application Serial No. PCT/US21/33544, filed May 21, 2021, titled, “ENVIRONMENTAL ADJUSTMENT USING ARTIFICIAL INTELLIGENCE” which claims priority from U.S. Provisional Patent Application Ser. No. 63/029,301, filed May 22, 2020, titled “ENVIRONMENTAL ADJUSTMENT USING ARTIFICIAL INTELLIGENCE,” and U.S. Provisional Patent Application Ser. No. 63/033,474, filed Jun. 2, 2020, titled “ENVIRONMENTAL ADJUSTMENT USING ARTIFICIAL INTELLIGENCE.” International Patent Application Serial No. PCT/US21/33544 is also a Continuation-in-Part of International Patent Application Serial No. PCT/US21/30798, filed May 5, 2021, titled “DEVICE ENSEMBLES AND COEXISTENCE MANAGEMENT OF DEVICES,” which claims priority from U.S. Provisional Patent Application Ser. No. 63/020,819, Filed May 6, 2020, titled “DEVICE ENSEMBLES AND COEXISTENCE MANAGEMENT OF DEVICES,” U.S. Provisional Patent Application Ser. No. 63/034,792, filed Jun. 4, 2020, titled “DEVICE ENSEMBLES AND COEXISTENCE MANAGEMENT OF DEVICES,” and U.S. Provisional Patent Application Ser. No. 63/079,851, filed Sep. 17, 2020, titled “DEVICE ENSEMBLES AND COEXISTENCE MANAGEMENT OF DEVICES.” International Patent Application Serial No. PCT/US21/33544 is also a Continuation-in-Part of International Patent Application Serial No. PCT/US21/15378 filed Jan. 28, 2021, titled “Sensor Calibration and Operation,” that claims priority from U.S. Provisional Patent Application Ser. No. 62/967,204, filed Jan. 29, 2020, titled “SENSOR CALIBRATION AND OPERATION.” International Patent Application Serial No. PCT/US21/33544 is also a Continuation-in-Part of International Patent Application Serial No. PCT/US21/17603, filed Feb. 11, 2021, titled “PREDICTIVE MODELING FOR TINTABLE WINDOWS,” which claims priority from 63/145,333, filed Feb. 3, 2021, titled “PREDICTIVE MODELING FOR TINTABLE WINDOWS,” from 63/075,569, filed Sep. 8, 2020, titled “PREDICTIVE MODELING FOR TINTABLE WINDOWS,” and from 62/975,677, filed Feb. 12, 2020, titled “VIRTUAL SKY SENSORS AND SUPERVISED CLASSIFICATION OF SENSOR RADIATION FOR WEATHER MODELING.” International Patent Application Serial No. PCT/US21/33544 is also a Continuation-in-Part of U.S. patent application Ser. No. 17/250,586, filed Feb. 5, 2021, titled “CONTROL METHODS AND SYSTEMS USING EXTERNAL 3D MODELING AND NEURAL NETWORKS,” that is a National Stage Entry of International Patent Application Serial No. PCT/US19/46524, filed Aug. 14, 2019, titled “CONTROL METHODS AND SYSTEMS USING EXTERNAL 3D MODELING AND NEURAL NETWORKS” that claims priority to (I) U.S. Provisional Patent Application Ser. No. 62/764,821, filed Aug. 15, 2018, titled “CONTROL METHODS AND SYSTEMS USING EXTERNAL 3D MODELING AND NEURAL NETWORKS,” (II) U.S. Provisional Patent Application Ser. No. 62/745,920, filed Oct. 15, 2018, titled “CONTROL METHODS AND SYSTEMS USING EXTERNAL 3D MODELING AND NEURAL NETWORKS,” and (III) U.S. Provisional Patent Application Ser. No. 62/805,841, filed Feb. 14, 2019, titled “CONTROL METHODS AND SYSTEMS USING EXTERNAL 3D MODELING AND NEURAL NETWORKS;” International Patent Application Serial No. PCT/US19/46524 is also a Continuation-in-Part of International Patent Application Serial No. PCT/US19/23268, filed Mar. 20, 2019, titled “CONTROL METHODS AND SYSTEMS USING EXTERNAL 3D MODELING AND SCHEDULE-BASED COMPUTING,” which claims benefit of U.S. Provisional Patent Application Ser. No. 62/646,260, filed Mar. 21, 2018, titled “METHODS AND SYSTEMS FOR CONTROLLING TINTABLE WINDOWS WITH CLOUD DETECTION,” and of U.S. Provisional Patent Application Ser. No. 62/666,572, filed May 3, 2018, titled “CONTROL METHODS AND SYSTEMS USING EXTERNAL 3D MODELING AND SCHEDULE-BASED COMPUTING.” International Patent Application Serial No. PCT/US21/33544 is also a Continuation-in-Part of U.S. patent application Ser. No. 16/982,535, filed Sep. 18, 2020, titled “CONTROL METHODS AND SYSTEMS USING EXTERNAL 3D MODELING AND SCHEDULE-BASED COMPUTING,” that is a National Stage Entry of PCT/US19/23268, filed Mar. 20, 2019. International Patent Application Serial No. PCT/US21/33544 is also a Continuation-in-Part of U.S. patent application Ser. No. 16/950,774, filed Nov. 17, 2020, titled “DISPLAYS FOR TINTABLE WINDOWS,” which is a Continuation of U.S. patent application Ser. No. 16/608,157, filed Oct. 24, 2019, titled “DISPLAYS FOR TINTABLE WINDOWS,” which is a National Stage Entry of International Patent Application Serial No. PCT/US18/29476, filed Apr. 25, 2018, titled “DISPLAYS FOR TINTABLE WINDOWS,” which claims priority from (i) U.S. Provisional Patent Application Ser. No. 62/607,618, filed Dec. 19, 2017, titled “ELECTROCHROMIC WINDOWS WITH TRANSPARENT DISPLAY TECHNOLOGY FIELD,” (ii) U.S. Provisional Patent Application Ser. No. 62/523,606, filed Jun. 22, 2017, titled “ELECTROCHROMIC WINDOWS WITH TRANSPARENT DISPLAY TECHNOLOGY,” (iii) U.S. Provisional Patent Application Ser. No. 62/507,704, filed May 17, 2017, titled “ELECTROCHROMIC WINDOWS WITH TRANSPARENT DISPLAY TECHNOLOGY,” (iv) U.S. Provisional Patent Application Ser. No. 62/506,514, filed May 15, 2017, titled “ELECTROCHROMIC WINDOWS WITH TRANSPARENT DISPLAY TECHNOLOGY,” and (v) U.S. Provisional Patent Application Ser. No. 62/490,457, filed Apr. 26, 2017, titled “ELECTROCHROMIC WINDOWS WITH TRANSPARENT DISPLAY TECHNOLOGY.” International Patent Application Serial No. PCT/US21/33544 is also a Continuation-In-Part of U.S. patent application Ser. No. 17/083,128, filed Oct. 28, 2020, titled “BUILDING NETWORK,” which is a Continuation of U.S. patent application Ser. No. 16/664,089, filed Oct. 25, 2019, titled “BUILDING NETWORK,” that is a National Stage Entry of International Patent Application Serial No. PCT/US19/30467, filed May 2, 2019, titled “EDGE NETWORK FOR BUILDING SERVICES,” which claims priority from U.S. Provisional Patent Application Ser. No. 62/666,033, filed May 2, 2018, titled “EDGE NETWORK FOR BUILDING SERVICES,” U.S. patent application Ser. No. 17/083,128, is also a Continuation-In-Part of International Patent Application Serial No. PCT/US18/29460, filed Apr. 25, 2018, titled “TINTABLE WINDOW SYSTEM FOR BUILDING SERVICES,” that claims priority from U.S. Provisional Patent Application Ser. No. 62/607,618, from U.S. Provisional Patent Application Ser. No. 62/523,606, from U.S. Provisional Patent Application Ser. No. 62/507,704, from U.S. Provisional Patent Application Ser. No. 62/506,514, and from U.S. Provisional Patent Application Ser. No. 62/490,457. International Patent Application Serial No. PCT/US21/33544 is also a Continuation-In-Part of U.S. patent application Ser. No. 17/081,809, filed Oct. 27, 2020, titled “Tintable Window System Computing Platform,” which is a Continuation of U.S. patent application Ser. No. 16/608,159, filed Oct. 24, 2019, titled “Tintable Window System Computing Platform,” that is a National Stage Entry of International Patent Application Serial No. PCT/US18/29406, filed Apr. 25, 2018, titled “Tintable Window System Computing Platform,” which claims priority from U.S. Provisional Patent Application Ser. No. 62/607,618, U.S. Provisional Patent Application Ser. No. 62/523,606, from U.S. Provisional Patent Application Ser. No. 62/507,704, U.S. Provisional Patent Application Ser. No. 62/506,514, and from U.S. Provisional Patent Application Ser. No. 62/490,457. This application is also a Continuation-in-Part of International Patent Application Serial No. PCT/US21/052587, filed Sep. 29, 2021, titled, “DISPLAY CONSTRUCT FOR MEDIA PROJECTION AND WIRELESS CHARGING” which claims priority from U.S. Provisional Patent Application No. 63/246,770, filed Sep. 21, 2021, titled “DISPLAY CONSTRUCT FOR MEDIA PROJECTION AND WIRELESS CHARGING,” U.S. Provisional Patent Application Ser. No. 63/212,483, filed Jun. 18, 2021, titled “DISPLAY CONSTRUCT FOR MEDIA PROJECTION AND WIRELESS CHARGING,” U.S. Provisional Patent Application Ser. No. 63/170,245, filed Apr. 2, 2021, titled “DISPLAY CONSTRUCT FOR MEDIA PROJECTION AND WIRELESS CHARGING,” U.S. Provisional Patent Application Ser. No. 63/154,352, filed Feb. 26, 2021, titled “DISPLAY CONSTRUCT FOR MEDIA PROJECTION AND WIRELESS CHARGING,” U.S. Provisional Patent Application Ser. No. 63/115,842, filed Nov. 19, 2020, titled “DISPLAY CONSTRUCT FOR MEDIA PROJECTION,” U.S. Provisional Patent Application Ser. No. 63/211,400, filed Jun. 16, 2021, titled “DISPLAY CONSTRUCT AND FRAMING FOR MEDIA PROJECTION,” U.S. Provisional Patent Application Ser. No. 63/135,021, filed Jan. 8, 2021, titled “CONFIGURATION OF MEDIA DISPLAY IN A FACILITY,” and U.S. Provisional Patent Application Ser. No. 63/247,684 filed Sep. 23, 2021, titled “CONFIGURATION ASSOCIATED WITH MEDIA DISPLAY IN A FACILITY.” International Patent Application Serial No. PCT/US21/052587 is also a Continuation-In-Part from International Patent Application Serial No. PCT/US20/53641, filed Sep. 30, 2020, titled “TANDEM VISION WINDOW AND MEDIA DISPLAY,” which claims priority from U.S. Provisional Patent Application Ser. No. 62/911,271, filed Oct. 5, 2019, titled “TANDEM VISION WINDOW AND TRANSPARENT DISPLAY,” from U.S. Provisional Patent Application Ser. No. 62/952,207, filed Dec. 20, 2019, titled “TANDEM VISION WINDOW AND TRANSPARENT DISPLAY,” from U.S. Provisional Patent Application Ser. No. 62/975,706, filed Feb. 12, 2020, titled “TANDEM VISION WINDOW AND MEDIA DISPLAY,” from U.S. Provisional Patent Application Ser. No. 63/085,254, filed Sep. 30, 2020, titled “TANDEM VISION WINDOW AND MEDIA DISPLAY.” International Patent Application Serial No. PCT/US20/53641 is also a Continuation-in-Part of U.S. patent application Ser. No. 16/950,774, filed Nov. 17, 2020, titled “DISPLAYS FOR TINTABLE WINDOWS,” which is a Continuation-in-Part of U.S. patent application Ser. No. 16/608,157, filed Oct. 24, 2019, titled “DISPLAYS FOR TINTABLE WINDOWS,” which is a National Stage Entry of International Patent Application Serial No. PCT/US18/29476, filed Apr. 25, 2018, titled “DISPLAYS FOR TINTABLE WINDOWS,” which claims priority from (i) U.S. Provisional Patent Application Ser. No. 62/607,618, filed Dec. 19, 2017, titled “ELECTROCHROMIC WINDOWS WITH TRANSPARENT DISPLAY TECHNOLOGY FIELD,” (ii) U.S. Provisional Patent Application Ser. No. 62/523,606, filed Jun. 22, 2017, titled “ELECTROCHROMIC WINDOWS WITH TRANSPARENT DISPLAY TECHNOLOGY,” (iii) U.S. Provisional Patent Application Ser. No. 62/507,704, filed May 17, 2017, titled “ELECTROCHROMIC WINDOWS WITH TRANSPARENT DISPLAY TECHNOLOGY,” (iv) U.S. Provisional Patent Application Ser. No. 62/506,514, filed May 15, 2017, titled “ELECTROCHROMIC WINDOWS WITH TRANSPARENT DISPLAY TECHNOLOGY,” and (v) U.S. Provisional Patent Application Ser. No. 62/490,457, filed Apr. 26, 2017, titled “ELECTROCHROMIC WINDOWS WITH TRANSPARENT DISPLAY TECHNOLOGY.” International Patent Application Serial No. PCT/US20/53641 is also a Continuation-In-Part of U.S. patent application Ser. No. 17/083,128, filed Oct. 28, 2020, titled “BUILDING NETWORK,” which is a Continuation of U.S. patent application Ser. No. 16/664,089, filed Oct. 25, 2019, titled “BUILDING NETWORK,” that is a National Stage Entry of International Patent Application Serial No. PCT/US19/30467, filed May 2, 2019, titled “EDGE NETWORK FOR BUILDING SERVICES,” which claims priority from U.S. Provisional Patent Application Ser. No. 62/666,033, filed May 2, 2018, U.S. patent application Ser. No. 17/083,128, is also a Continuation-In-Part of International Patent Application Serial No. PCT/US18/29460, filed Apr. 25, 2018 titled “TINTABLE WINDOW SYSTEM FOR BUILDING SERVICES,” which claims priority from U.S. Provisional Patent Application Ser. No. 62/607,618, U.S. to U.S. Provisional Patent Application Ser. No. 62/523,606, from U.S. Provisional Patent Application Ser. No. 62/507,704, from U.S. Provisional Patent Application Ser. No. 62/506,514, and from U.S. Provisional Patent Application Ser. No. 62/490,457. International Patent Application Serial No. PCT/US20/53641 is also a Continuation-In-Part of U.S. patent application Ser. No. 17/081,809, filed Oct. 27, 2020, titled “TINTABLE WINDOW SYSTEM COMPUTING PLATFORM,” which is a Continuation of U.S. patent application Ser. No. 16/608,159, filed Oct. 24, 2019, titled “TINTABLE WINDOW SYSTEM COMPUTING PLATFORM,” that is a National Stage Entry of International Patent Application Serial No. PCT/US18/29406, filed Apr. 25, 2018, titled “TINTABLE WINDOW SYSTEM COMPUTING PLATFORM,” which claims priority from U.S. Provisional Patent Application Ser. No. 62/607,618, U.S. Provisional Patent Application Ser. No. 62/523,606, U.S. Provisional Patent Application Ser. No. 62/507,704, U.S. Provisional Patent Application Ser. No. 62/506,514, and U.S. Provisional Patent Application Ser. No. 62/490,457. International Patent Application Serial No. PCT/US21/052587 is also a Continuation-in-Part from U.S. patent application Ser. No. 17/338,562, filed Jun. 3, 2021, titled “DISPLAYS FOR TINTABLE WINDOWS,” which is a continuation of U.S. patent application Ser. No. 16/950,774, filed Nov. 17, 2020, titled “DISPLAYS FOR TINTABLE WINDOWS”. This application is also a Continuation-in-Part of to International Patent Application Serial No. PCT/US21/15378 filed Jan. 28, 2021, titled “Sensor Calibration and Operation,” that claims priority from U.S. Provisional Patent Application Ser. No. 62/967,204, filed Jan. 29, 2020, titled, “SENSOR CALIBRATION AND OPERATION.” International Patent Application Serial No. PCT/US21/15378 is also a Continuation-in-Part of U.S. patent application Ser. No. 17/083,128, filed Oct. 28, 2020, titled, “BUILDING NETWORK,” which is (i) a Continuation of U.S. patent application Ser. No. 16/664,089, filed Oct. 25, 2019, titled, “BUILDING NETWORK,” and (ii) a Continuation-in-Part to International Patent Application Serial No. PCT/US18/29460, filed Apr. 25, 2018, titled, “TINTABLE WINDOW SYSTEM FOR BUILDING SERVICES”. International Patent Application Serial No. PCT/US21/15378 is also a Continuation-in-Part of U.S. patent application Ser. No. 16/447,169, filed Jun. 20, 2019, titled, “SENSING AND COMMUNICATIONS UNIT FOR OPTICALLY SWITCHABLE WINDOW SYSTEMS,” which (I) claims priority from U.S. Provisional Patent Application Ser. No. 62/858,100, filed Jun. 6, 2019, titled, “SENSING AND COMMUNICATIONS UNIT FOR OPTICALLY SWITCHABLE WINDOW SYSTEMS,” and (II) is a Continuation-in-Part of International Patent Application Serial No. PCT/US19/30467, filed May 2, 2019, titled, “EDGE NETWORK FOR BUILDING SERVICES,” which claims benefit from U.S. Provisional Patent Application Ser. No. 62/803,324, filed Feb. 8, 2019, titled, “SENSING AND COMMUNICATIONS UNIT FOR OPTICALLY SWITCHABLE WINDOW SYSTEMS,” U.S. Provisional Patent Application Ser. No. 62/768,775, filed Nov. 16, 2018, titled, “SENSING AND COMMUNICATIONS UNIT FOR OPTICALLY SWITCHABLE WINDOW SYSTEMS,” U.S. Provisional Patent Application Ser. No. 62/688,957, filed Jun. 22, 2018, titled, “SENSING AND COMMUNICATIONS UNIT FOR OPTICALLY SWITCHABLE WINDOW SYSTEMS,” and U.S. Provisional Patent Application Ser. No. 62/666,033, filed May 2, 2018, titled, “EDGE NETWORK FOR BUILDING SERVICES.” This application is also a Continuation-in-Part of International Patent Application Serial No. PCT/US21/43143, filed Jul. 26, 2021, titled “ATMOSPHERIC ADJUSTMENT IN AN ENCLOSURE,” which claims priority to U.S. Provisional Patent Application Ser. No. 63/057,120, filed Jul. 27, 2020, titled “ATMOSPHERIC QUALITY ADJUSTMENT IN AN ENCLOSURE,” to U.S. Provisional Patent Application Ser. No. 63/078,805, filed Sep. 15, 2020, titled “ATMOSPHERIC ADJUSTMENT IN AN ENCLOSURE,” and to International Patent Application Serial No. PCT/US21/15378. International Patent Application Serial No. PCT/US21/43143 also claims priority to International Patent Application Serial No. PCT/US21/27418, filed Apr. 15, 2021, titled “INTERACTION BETWEEN AN ENCLOSURE AND ONE OR MORE OCCUPANTS” that claims priority from U.S. Provisional Patent Application Ser. No. 63/080,899, filed Sep. 21, 2020, titled “INTERACTION BETWEEN AN ENCLOSURE AND ONE OR MORE OCCUPANTS,” from U.S. Provisional Application Ser. No. 63/052,639, filed Jul. 16, 2020, titled “INDIRECT INTERACTIVE INTERACTION WITH A TARGET IN AN ENCLOSURE,” and from U.S. Provisional Application Ser. No. 63/010,977, filed Apr. 16, 2020, titled “INDIRECT INTERACTION WITH A TARGET IN AN ENCLOSURE.” Each of the above mentioned patent document which is incorporated herein by reference in its entirety.

### BACKGROUND

Occupants of an enclosure (e.g., facility, building, or office) may benefit from certain environmental characteristic(s). For example, health, wellness and/or performance of an individual in an environment of an enclosure may be improved when the environment is adjusted, e.g., in terms of environmental characteristics such as light, (e.g., visual comfort), heat (e.g., thermal comfort), air quality, noise (e.g., noise privacy), carbon dioxide level, VOC, humidity, potential pathogen load, ventilation, and the like. The environmental characteristic(s) can be adjusted to match requested comfort, health, and/or safety standards. The enclosure may include a workplace, a hospital, a transit hub, a building, a vehicle, or a facility. Conventional sensor feedback to environmental inputs, such as HVAC systems, may not be sufficient to achieve this objective. For instance, such sensor feedback does not consider the ever-changing environmental conditions such as people count and/or activities within the enclosure. For instance, a traditional sensor network may not consider the use case and/or occupant behaviors that can led to sub-optimal, unhealthy, and/or dangerous conditions including, e.g., occupant proximity, pathogen load, increased viral exposure, visual glare, thermal discomfort, and/or reduced privacy. In some instances, it may be difficult and/or expensive to provide sensor placement at a sufficiently high density to accurately characterize the sensed environmental conditions for all locations of interest within the enclosure.

Uncontrolled thermal conditions can impact the comfort and/or health of occupants in commercial and residential building environments. Thermal gradients in occupant environments may be computed, monitored, and maintained to optimize thermal comfort and facilitate compliance with jurisdictional and/or industry guidelines on environmental conditions and facility (e.g., building) controls. Standard equations exist to estimate thermal comfort of occupants. However, these standard equations they rely on input parameters that are at times difficult to measure, such as clothing worn and/or individual metabolic rate.

### SUMMARY

Various aspects disclosed herein alleviate at least part of the shortcomings related to monitoring and adjustment of thermal comfort for occupants of an enclosure.

Various aspects disclosed herein may relate to maintaining thermal comfort in an enclosure based at least in part on collecting temperature measurements from temperature sensors mounted at locations in the enclosure. One or more environmental characteristics biasing the temperature measurements with respect to atmospheric (e.g., air) temperatures of volumes of the atmosphere (e.g., air) adjacent locations of the sensors may be quantified. Bias in the temperature measurements may be corrected using the environmental characteristics as correction factors to generate corrected temperature measurements. The corrected temperature measurements may be extrapolated according to a plurality of grid points arranged between respective locations of the temperature sensors based at least in part on an estimate of heat transfer in the enclosure, e.g., to generate grid point temperatures. The grid point temperatures may be converted to a (e.g., two dimensional or three dimensional) mapping of thermal comfort. The resulting mapping may be used to control one or more environmental characteristics of the enclosure in order to obtain a target thermal comfort.

In another aspect, a method comprises: collecting temperature measurements from a plurality of temperature sensors mounted at locations in an enclosure, wherein one or more of the temperature sensors are subject to temperature biasing by one or more environmental characteristics; applying the temperature measurements to a bias-correcting model and thereby correcting bias in the temperature measurements and generating corrected temperature measurements; and controlling, based at least in part on the corrected temperature measurements, an environment of the enclosure to maintain a thermal profile in the enclosure.

In some embodiments, the controlling includes controlling one or more elements of the enclosure. In some embodiments, the one or more elements include a building system, a climate control element, heating, ventilation, and air conditioning (HVAC) system, a tint level of a tintable window, or a combination thereof. In some embodiments, the plurality of temperature sensors includes a first subset of temperature sensors and a second subset of temperature sensors, the first subset of temperature sensors includes the one or more temperature sensors that are subject to the temperature biasing by the one or more environmental characteristics, the second subset of temperature sensors does not include the one or more temperature sensors that are subject to the temperature biasing by the one or more environmental characteristics, and the bias-correcting model is applied to the first subset of temperature sensors and not to the second subset of temperature sensors. In some embodiments, at least one temperature sensor of the one or more temperature sensors that are subject to the temperature biasing by the one or more environmental characteristics is disposed in an envelope of the enclosure. In some embodiments, at least one temperature sensor of the one or more temperature sensors that are subject to the temperature biasing by the one or more environmental characteristics is disposed in a framing portion of a window or door, a mullion, and/or a transom. In some embodiments, at least one temperature sensor of the one or more temperature sensors that are subject to the temperature biasing by the one or more environmental characteristics is disposed in a southern facing or partially southern facing wall of the enclosure. In some embodiments, the environmental characteristics include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the environmental characteristics are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the method further comprises collecting data regarding the environmental characteristics, wherein the bias-correcting model is based, at least in part, on the data. In some embodiments, the collecting the data comprises collecting data from a façade-level oriented photosensor reading, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the collecting the data and the collecting the temperature measurements are performed at least partially concurrently. In some embodiments, the bias-correcting model comprises a machine learning model. In some embodiments, the bias-correcting model comprises associating bias among (i) temperature measurements in the empirical data from sensors in the standardized sensor installation configurations and (ii) auxiliary temperature measurements of volumes of air at or adjacent to the standardized sensor installation configurations across a range of one or more environmental characteristics. In some embodiments, the method further comprises repeating the applying. In some embodiments, the repeating is performed at regular intervals. In some embodiments, the applying is performed at one or more times when biasing of the one or more temperature sensors is estimated and/or predicted. In some embodiments, the one or more times are based, at least in part, on weather conditions, predicted weather conditions, predicted sun irradiation, measured sun irradiation, occupation of the enclosure, a schedule, a timetable of the enclosure, operation of one or more building systems, or a combination thereof. In some embodiments, the one or more times are based, at least in part, on one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the one or more times are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the applying comprises transforming the temperature measurements to the corrected temperature measurements based at least in part on empirical data collected with standardized sensor installation configurations across a range of the one or more environmental characteristics. In some embodiments, the method further comprises extrapolating the corrected temperature measurements according to a plurality of grid points arranged between the locations of the temperature sensors based at least in part on an estimate of heat transfer in the enclosure to generate grid point temperatures. In some embodiments, extrapolating the corrected temperature measurements comprises projecting temperature gradients extending from the locations of the temperature sensors to the grid points. In some embodiments, the temperature gradients are calculated from a heat transfer rate. In some embodiments, the heat transfer rate is characterized by heat conduction. In some embodiments, the heat transfer rate is characterized by heat convection. In some embodiments, the temperature gradients are modeled based at least in part on a physics simulation. In some embodiments, the physics simulation comprises computational fluid dynamics. In some embodiments, the temperature gradients are based at least in part on an overall heat transfer coefficient. In some embodiments, the overall heat transfer coefficient includes a statistical computation of radiant temperatures associated with surfaces in the enclosure. In some embodiments, the statistical computation includes a computation of a central tendency of the radiant temperatures associated with surfaces in the enclosure. In some embodiments, the statistical computation comprises a computation of mean, median, mode, or range, of radiant temperatures associated with surfaces in the enclosure. In some embodiments, the overall heat transfer coefficient comprises an outlier exclusion of radiant temperatures associated with surfaces in the enclosure. In some embodiments, the method further comprises converting the grid point temperatures to a mapping of a thermal profile. In some embodiments, mapping of the target thermal profile is utilized to define an operative temperature at a specified grid point that combines a corresponding grid point temperature and an estimated statistical computation based at least in part on a radiant temperature to generate estimated radiant temperature. In some embodiments, the estimated radiant temperature is determined based at least in part on an amount of sunlight illuminating the specified grid point. In some embodiments, the operative temperature at the grid point combines a corresponding estimated air speed, relative humidity, and/or metabolic rate of an occupant of the enclosure. In some embodiments, the plurality of grid points are arranged according to a homogeneous grid. In some embodiments, the plurality of grid points are arranged according to a non-homogeneous grid. In some embodiments, the non-homogeneity of the non-homogeneous grid relates to an area of interest. In some embodiments, the non-homogeneity of the non-homogeneous grid relates to a grid density. In some embodiments, the non-homogeneity of the non-homogeneous grid relates to a grid resolution. In some embodiments, the control of one or more environmental characteristics of the enclosure uses a hierarchical control system. In some embodiments, the method further comprises determining that the one or more of the temperature sensors are subject to a temperature bias, wherein the determining is based, at least in part, on the collected temperature measurements. In some embodiments, the determining is further based, at least in part, on environmental characteristics that include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the determining is further based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof.

In another aspect, a non-transitory computer readable program instructions, when read by one or more processors, causes the one or more processors to execute, or direct execution of, any of the methods disclosed above.

In another aspect, a non-transitory computer readable program instructions, when read by one or more processors, causes the one or more processors to execute operations comprising: collecting, or directing the collection of, temperature measurements from a plurality of temperature sensors mounted at locations in an enclosure, wherein one or more of the temperature sensors are subject to temperature biasing by one or more environmental characteristics; applying, or directing the application of, the temperature measurements to a bias-correcting model and thereby correcting bias in the temperature measurements and generating corrected temperature measurements; and controlling, or directing the control of, based at least in part on the corrected temperature measurements, the environment of the enclosure to maintain a thermal profile in the enclosure.

In some embodiments, the program instructions are inscribed in a non-transitory media or in a non-transitory medium. In some embodiments, at least two of the operations are executed by the same processor of the one or more processors. In some embodiments, at least two of the operations are executed by different processors of the one or more processors.

In another aspect, an apparatus comprising at least one controller comprising circuitry, which at least one controller is configured to: collect, or direct the collection of, temperature measurements from a plurality of temperature sensors mounted at locations in an enclosure, wherein one or more of the temperature sensors are subject to temperature biasing by one or more environmental characteristics; apply, or direct the application of, the temperature measurements to a bias-correcting model and thereby correcting bias in the temperature measurements and generating corrected temperature measurements; and control, or direct the control of, based at least in part on the corrected temperature measurements, the environment of the enclosure to maintain a thermal profile in the enclosure.

In some embodiments, at least two of the operations are performed by the same controller of the at least one controller. In some embodiments, at least two of the operations are performed by different controllers of the at least one controller. In some embodiments, the at least one controller comprises circuitry. In some embodiments, the at least one controller comprises one or more processors. In some embodiments, the controlling includes controlling one or more elements of the enclosure. In some embodiments, the one or more elements include a building system, a climate control element, heating, ventilation, and air conditioning (HVAC) system, a tint level of a tintable window, or a combination thereof. In some embodiments, the plurality of temperature sensors includes a first subset of temperature sensors and a second subset of temperature sensors, the first subset of temperature sensors includes the one or more temperature sensors that are subject to the temperature biasing by the one or more environmental characteristics, the second subset of temperature sensors does not include the one or more temperature sensors that are subject to the temperature biasing by the one or more environmental characteristics, and the bias-correcting model is applied to the first subset of temperature sensors and not to the second subset of temperature sensors. In some embodiments, at least one temperature sensor of the one or more temperature sensors that are subject to the temperature biasing by the one or more environmental characteristics is disposed in an envelope of the enclosure. In some embodiments, at least one temperature sensor of the one or more temperature sensors that are subject to the temperature biasing by the one or more environmental characteristics is disposed in a framing portion of a window or door, a mullion, and/or a transom. In some embodiments, at least one temperature sensor of the one or more temperature sensors that are subject to the temperature biasing by the one or more environmental characteristics is disposed in a southern facing or partially southern facing wall of the enclosure. In some embodiments, the environmental characteristics include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the environmental characteristics are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the at least one controller is configured to collect, or direct the collection of, data regarding the environmental characteristics, wherein the bias-correcting model is based, at least in part, on the data. In some embodiments, the collection of the data comprises collecting data from a façade-level oriented photosensor reading, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the collection of the data and the collecting the temperature measurements are performed at least partially concurrently. In some embodiments, the bias-correcting model comprises a machine learning model. In some embodiments, the bias-correcting model comprises associating bias among (i) temperature measurements in the empirical data from sensors in the standardized sensor installation configurations and (ii) auxiliary temperature measurements of volumes of air at or adjacent to the standardized sensor installation configurations across a range of one or more environmental characteristics. In some embodiments, the at least one controller is configured to repeat, or direct the repeating of, the application. In some embodiments, the repeating of the application is performed at regular intervals. In some embodiments, the application is performed at one or more times when biasing of the one or more temperature sensors is estimated and/or predicted. In some embodiments, the one or more times are based, at least in part, on weather conditions, predicted weather conditions, predicted sun irradiation, measured sun irradiation, occupation of the enclosure, a schedule, a timetable of the enclosure, operation of one or more building systems, or a combination thereof. In some embodiments, the one or more times are based, at least in part, on one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the one or more times are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the application comprises transforming the temperature measurements to the corrected temperature measurements based at least in part on empirical data collected with standardized sensor installation configurations across a range of the one or more environmental characteristics. In some embodiments, the at least one controller is configured to extrapolate, or direct the extrapolation of, the corrected temperature measurements according to a plurality of grid points arranged between the locations of the temperature sensors based at least in part on an estimate of heat transfer in the enclosure to generate grid point temperatures. In some embodiments, the extrapolation of the corrected temperature measurements comprises projecting temperature gradients extending from the locations of the temperature sensors to the grid points. In some embodiments, the temperature gradients are calculated from a heat transfer rate. In some embodiments, the heat transfer rate is characterized by heat conduction. In some embodiments, the heat transfer rate is characterized by heat convection. In some embodiments, the temperature gradients are modeled based at least in part on a physics simulation. In some embodiments, the physics simulation comprises computational fluid dynamics. In some embodiments, the temperature gradients are based at least in part on an overall heat transfer coefficient. In some embodiments, the overall heat transfer coefficient includes a statistical computation of radiant temperatures associated with surfaces in the enclosure. In some embodiments, the statistical computation includes a computation of a central tendency of the radiant temperatures associated with surfaces in the enclosure. In some embodiments, the statistical computation comprises a computation of mean, median, mode, or range, of radiant temperatures associated with surfaces in the enclosure. In some embodiments, the overall heat transfer coefficient comprises an outlier exclusion of radiant temperatures associated with surfaces in the enclosure. In some embodiments, the at least one controller is further configured to convert, or direction the conversion of, the grid point temperatures to a mapping of a thermal profile. In some embodiments, mapping of the target thermal profile is utilized to define an operative temperature at a specified grid point that combines a corresponding grid point temperature and an estimated statistical computation based at least in part on a radiant temperature to generate estimated radiant temperature. In some embodiments, the estimated radiant temperature is determined based at least in part on an amount of sunlight illuminating the specified grid point. In some embodiments, the operative temperature at the grid point combines a corresponding estimated air speed, relative humidity, and/or metabolic rate of an occupant of the enclosure. In some embodiments, the plurality of grid points are arranged according to a homogeneous grid. In some embodiments, the plurality of grid points are arranged according to a non-homogeneous grid. In some embodiments, the non-homogeneity of the non-homogeneous grid relates to an area of interest. In some embodiments, the non-homogeneity of the non-homogeneous grid relates to a grid density. In some embodiments, the non-homogeneity of the non-homogeneous grid relates to a grid resolution. In some embodiments, the control of one or more environmental characteristics of the enclosure uses a hierarchical control system. In some embodiments, the controller is further configured to determine, or direct the determination, that the one or more of the temperature sensors are subject to a temperature bias, wherein the determining is based, at least in part, on the collected temperature measurements. In some embodiments, the determining is further based, at least in part, on environmental characteristics that include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the determining is further based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof.

In another aspect, a method for maintaining a thermal profile in an enclosure, the method comprises: collecting temperature measurements from a plurality of temperature sensors mounted at locations in the enclosure, wherein a first subset of temperature sensors of the plurality of temperature sensors are each disposed in a framing portion of a window or door, a mullion, and/or a transom; applying the temperature measurements of the first subset of temperature sensors to a bias-correcting model and thereby reducing bias in the temperature measurements of the first subset of temperature sensors and generating corrected temperature measurements; and controlling, based at least in part on the corrected temperature measurements, the environment of the enclosure to maintain the thermal profile in the enclosure.

In some embodiments, the controlling is further based, at least in part, on the corrected temperature measurements and the temperature measurements of one or more temperature sensors of the plurality of temperature sensors. In some embodiments, one or more temperature sensors of the first subset of temperature sensors is disposed in a southern facing or partially southern facing wall of the enclosure. In some embodiments, the environmental characteristics include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the environmental characteristics are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the plurality of temperature sensors further includes a second subset of temperature sensors, and the bias-correcting model is applied to the first subset of temperature sensors and not to the second subset of temperature sensors. In some embodiments, the second subset of temperature sensors are not disposed in a framing portion of a window or door, a mullion, and/or a transom. In some embodiments, the second subset of temperature sensors are each disposed in a framing portion of a window or door, a mullion, and/or a transom.

In another aspect, a non-transitory computer readable program instructions, when read by one or more processors, causes the one or more processors to execute any of the methods disclosed above.

In another aspect, an apparatus for maintaining a thermal profile in an enclosure, the apparatus comprising at least one controller comprising circuitry, which at least one controller is configured to: collect, or direct collection of, temperature measurements from a plurality of temperature sensors mounted at locations in the enclosure, wherein a first subset of temperature sensors of the plurality of temperature sensors are each disposed in a framing portion of a window or door, a mullion, and/or a transom; apply, or direct application of, the temperature measurements of the first subset of temperature sensors to a bias-correcting model and thereby reducing bias in the temperature measurements of the first subset of temperature sensors and generating corrected temperature measurements; and control, or direct the control of, based at least in part on the corrected temperature measurements, the environment of the enclosure to maintain the thermal profile in the enclosure.

In some embodiments, the controlling is further based, at least in part, on the corrected temperature measurements and the temperature measurements of one or more temperature sensors of the plurality of temperature sensors. In some embodiments, one or more temperature sensors of the first subset of temperature sensors is disposed in a southern facing or partially southern facing wall of the enclosure. In some embodiments, the environmental characteristics include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof. In some embodiments, the environmental characteristics are based, at least in part, on data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof. In some embodiments, the plurality of temperature sensors further includes a second subset of temperature sensors, and the bias-correcting model is applied to the first subset of temperature sensors and not to the second subset of temperature sensors. In some embodiments, the second subset of temperature sensors are not disposed in a framing portion of a window or door, a mullion, and/or a transom. In some embodiments, the second subset of temperature sensors are each disposed in a framing portion of a window or door, a mullion, and/or a transom.

In another aspect, a method for maintaining a thermal profile in an enclosure, the method comprises: collecting temperature measurements from a plurality of temperature sensors mounted at locations in the enclosure, wherein a first subset of temperature sensors of the plurality of temperature sensors are each subject to a temperature bias gradient of at least about 5° C. per hour and/or a temperature difference from one or more other temperature sensors of at least about 5° C.; applying the temperature measurements of the first subset of temperature sensors to a bias-correcting model and thereby correcting bias in the temperature measurements of the first subset of temperature sensors and generating corrected temperature measurements; and controlling, based at least in part on the corrected temperature measurements, the environment of the enclosure to maintain a thermal profile in the enclosure.

In some embodiments, the temperature difference is at least about 10° C., about 15° C., about 20° C., about 25° C., about 30° C., about 35° C., and/or about 40° C. In some embodiments, the temperature gradient is at least about 10° C. per hour or about 15° C. per hour. In some embodiments, the method further comprises determining that the first subset of temperature sensors are subject to a temperature bias, wherein the determining is based, at least in part, on the collected temperature measurements. In some embodiments, the determining is further based, at least in part, on environmental characteristics that include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof.

In another aspect, a non-transitory computer readable program instructions, when read by one or more processors, causes the one or more processors to execute any of the methods disclosed above.

In another aspect, an apparatus comprises at least one controller comprising circuitry, which at least one controller is configured to: collect, or direct collection of, temperature measurements from a plurality of temperature sensors mounted at locations in the enclosure, wherein a first subset of temperature sensors of the plurality of temperature sensors are each subject to a temperature bias gradient of at least about 5° C. per hour and/or a temperature difference from one or more other temperature sensors of at least about 5° C.; apply, or direct application of, the temperature measurements of the first subset of temperature sensors to a bias-correcting model and thereby correcting bias in the temperature measurements of the first subset of temperature sensors and generating corrected temperature measurements; and control, or direct the control of, based at least in part on the corrected temperature measurements, the environment of the enclosure to maintain a thermal profile in the enclosure.

In another aspect, a method for maintaining a target thermal profile in an enclosure, the method comprises: (A) collecting temperature measurements from temperature sensors mounted at locations in the enclosure; (B) quantifying one or more environmental characteristics biasing the temperature measurements with respect to temperatures of volumes of air at or adjacent to the locations of the sensors; (C) correcting bias in the temperature measurements based at least in part on the one or more environmental characteristics as one or more correction factors to generate corrected temperature measurements; (D) extrapolating the corrected temperature measurements according to a plurality of grid points arranged between the locations of the temperature sensors based at least in part on an estimate of heat transfer in the enclosure to generate grid point temperatures; (E) converting the grid point temperatures to a mapping of a thermal profile; and (F) using the mapping to control the one or more environmental characteristics of the enclosure in order to obtain the target thermal profile.

In some embodiments, at least one of the temperature sensors is disposed in a device ensemble mounted at a location of the locations. In some embodiments, a plurality of the temperature sensors is disposed in a plurality of device ensembles, and wherein at least one of the device ensembles is disposed in window framing of exterior windows of the enclosure. In some embodiments, the correction factors transform the temperature measurements to the corrected temperature measurements based at least in part on empirical data collected with standardized sensor installation configurations across a range of the one or more environmental characteristics. In some embodiments, the correction factors are derived at least in part by a machine learning module that associates bias among (i) temperature measurements in the empirical data from sensors in the standardized sensor installation configurations and (ii) auxiliary temperature measurements of volumes of air at or adjacent to the standardized sensor installation configurations across the range of the one or more environmental characteristics. In some embodiments, the one or more environmental characteristics includes an outside air temperature, solar angle, solar intensity, solar radiation wavelength, tint states of windows, sensor orientation, mullion properties, paint properties, proximity to HVAC diffuser, or insulation properties. In some embodiments, the windows include at least one tintable window. In some embodiments, the at least one tintable window includes at least one electrochromic window. In some embodiments, extrapolating the corrected temperature measurements comprises projecting temperature gradients extending from the locations of the temperature sensors to the grid points. In some embodiments, the temperature gradients are calculated from a heat transfer rate. In some embodiments, the heat transfer rate is characterized by heat conduction. In some embodiments, the heat transfer rate is characterized by heat convection. In some embodiments, the temperature gradients are modeled based at least in part on a physics simulation. In some embodiments, the physics simulation comprises computational fluid dynamics. In some embodiments, the temperature gradients are based at least in part on an overall heat transfer coefficient. In some embodiments, the overall heat transfer coefficient includes a statistical computation of radiant temperatures associated with surfaces in the enclosure. In some embodiments, the statistical computation includes a computation of a central tendency of the radiant temperatures associated with surfaces in the enclosure. In some embodiments, the statistical computation comprises a computation of mean, median, mode, or range, of radiant temperatures associated with surfaces in the enclosure. In some embodiments, the overall heat transfer coefficient comprises an outlier exclusion of radiant temperatures associated with surfaces in the enclosure. In some embodiments, mapping of the target thermal profile is utilized to define an operative temperature at a specified grid point that combines a corresponding grid point temperature and an estimated statistical computation based at least in part on a radiant temperature to generate estimated radiant temperature. In some embodiments, the estimated radiant temperature is determined based at least in part on an amount of sunlight illuminating the specified grid point. In some embodiments, the operative temperature at the grid point combines a corresponding estimated air speed, relative humidity, and/or metabolic rate of an occupant of the enclosure. In some embodiments, the plurality of grid points are arranged according to a homogeneous grid. In some embodiments, the plurality of grid points are arranged according to a non-homogeneous grid. In some embodiments, the non-homogeneity of the non-homogeneous grid relates to an area of interest. In some embodiments, the non-homogeneity of the non-homogeneous grid relates to a grid density. In some embodiments, the non-homogeneity of the non-homogeneous grid relates to a grid resolution. In some embodiments, the control of one or more environmental characteristics of the enclosure uses a hierarchical control system. In some embodiments, controlling the one or more environmental characteristics comprises adjusting a heating, ventilation, and air conditioning (HVAC) system. In some embodiments, controlling the one or more environmental characteristics comprises regulating a velocity of an air flowing through a vent to and/or from the enclosure. In some embodiments, the hierarchical control system comprises a building management system. In some embodiments, the hierarchical control system comprises a plurality of controllers. In some embodiments, the hierarchical control system comprises a master controller that is configured to control one or more local controllers. In some embodiments, at least one of the temperature sensors is disposed in a device ensemble mounted at a location of the locations, and wherein the device ensemble is operatively coupled to the hierarchical control system. In some embodiments, the device ensemble comprises a controller. In some embodiments, the device ensemble comprises (i) sensors or (ii) a sensor and an emitter. In some embodiments, the device ensemble comprises (i) a plurality of processors or (ii) a plurality of circuit boards. In some embodiments, the plurality of circuit boards are configured to facilitate cooling of (i) the device ensemble interior environment and/or (ii) the circuit boards.

In another aspect, a non-transitory computer readable program instructions for maintaining a target thermal profile in an enclosure, the non-transitory computer readable media, when read by one or more processors, causes the one or more processors to execute any of the methods disclosed above.

In another aspect, a non-transitory computer readable program instructions for maintaining a target thermal profile in an enclosure, the non-transitory computer readable program instructions, when read by one or more processors, causes the one or more processors to execute operations comprises: (A) collecting, or directing the collection of, temperature measurements from temperature sensors mounted at locations in the enclosure; (B) quantifying, or directing quantification of, one or more environmental characteristics biasing the temperature measurements with respect to temperatures of volumes of air at or adjacent to the locations of the sensors; (C) correcting, or directing correction of, bias in the temperature measurements based at least in part on the one or more environmental characteristics as correction factors to generate corrected temperature measurements; (D) extrapolating, or directing the extrapolation of, the corrected temperature measurements according to a plurality of grid points arranged between the locations of the temperature sensors based at least in part on an estimate of heat transfer in the enclosure to generate grid point temperatures; (E) converting, or directing the conversion of, the grid point temperatures to a mapping of a thermal profile; and (F) using, or directing the use of, the mapping to control one or more environmental characteristics of the enclosure in order to obtain the target thermal profile.

In some embodiments, the program instructions are inscribed in a non-transitory media or in a non-transitory medium. In some embodiments, at least two of the operations (A) to (F) are executed by the same processor of the one or more processors. In some embodiments, at least two of the operations (A) to (F) are executed by different processors of the one or more processors.

In another aspect, an apparatus for maintaining a target thermal profile in an enclosure, the apparatus comprises at least one controller (e.g., comprising circuitry), which at least one controller is configured to: (A) operatively coupled to temperature sensors mounted at locations in the enclosure; (B) collect, or direct the collection of, temperature measurements from the temperature sensors; (C) quantify, or direct quantification of, one or more environmental characteristics biasing the temperature measurements with respect to air temperatures of volumes of air at or adjacent to the locations of the sensors; (D) correct, or direct correction of, bias in the temperature measurements based at least in part on the one or more environmental characteristics as correction factors to generate corrected temperature measurements; (E) extrapolate, or direct the extrapolation of, the corrected temperature measurements according to a plurality of grid points arranged between the locations of the temperature sensors based at least in part on an estimate of heat transfer in the enclosure to generate grid point temperatures; (F) convert, or direct the conversion of, the grid point temperatures to a mapping of a thermal profile; and (G) use, or direct the use of, the mapping to control the one or more environmental characteristics of the enclosure in order to obtain the target thermal profile.

In some embodiments, at least two of the operations (B) to (G) are performed by the same controller of the at least one controller. In some embodiments, at least two of the operations (B) to (G) are performed by different controllers of the at least one controller. In some embodiments, the at least one controller comprises circuitry. In some embodiments, the at least one controller comprises one or more processors. In some embodiments, at least one of the temperature sensors is disposed in a device ensemble mounted at a location of the locations. In some embodiments, a plurality of the temperature sensors is disposed in a plurality of device ensembles, and wherein at least one of the device ensembles is disposed in window framing of exterior windows of the enclosure. In some embodiments, the at least one controller is configured such that the correction factors transform the temperature measurements to the corrected temperature measurements based at least in part on empirical data collected with standardized sensor installation configurations across a range of the one or more environmental characteristics. In some embodiments, the at least one controller is configured to derive the correction factors at least in part by a machine learning module that associates bias among (i) temperature measurements in the empirical data from sensors in the standardized sensor installation configurations and (ii) auxiliary temperature measurements of volumes of air at or adjacent to the standardized sensor installation configurations across the range of the one or more environmental characteristics. In some embodiments, the at least one controller is configured such that the one or more environmental characteristics includes an outside air temperature, solar angle, solar intensity, solar radiation wavelength, tint states of windows, sensor orientation, mullion properties, paint properties, proximity to HVAC diffuser, or insulation properties. In some embodiments, the windows include at least one tintable window. In some embodiments, the at least one tintable window includes at least one electrochromic window. In some embodiments, the at least one controller is configured to extrapolate the corrected temperature measurements comprising projecting temperature gradients extending from the locations of the temperature sensors to the grid points. In some embodiments, the at least one controller is configured such that the temperature gradients are calculated from a heat transfer rate. In some embodiments, the at least one controller is configured such that the heat transfer rate is characterized by heat conduction. In some embodiments, the at least one controller is configured such that the heat transfer rate is characterized by heat convection. In some embodiments, the at least one controller is configured such that the temperature gradients are modeled based at least in part on a physics simulation. In some embodiments, the at least one controller is configured such that the physics simulation comprises computational fluid dynamics. In some embodiments, the at least one controller is configured such that the temperature gradients are based at least in part on an overall heat transfer coefficient. In some embodiments, the at least one controller is configured such that the overall heat transfer coefficient includes a statistical computation of radiant temperatures associated with surfaces in the enclosure. In some embodiments, the at least one controller is configured such that the statistical computation includes a computation of a central tendency of the radiant temperatures associated with surfaces in the enclosure. In some embodiments, the at least one controller is configured such that the statistical computation comprises a computation of mean, median, mode, or range, of radiant temperatures associated with surfaces in the enclosure. In some embodiments, the at least one controller is configured such that the overall heat transfer coefficient comprises an outlier exclusion of radiant temperatures associated with surfaces in the enclosure. In some embodiments, the at least one controller is configured such that mapping of the target thermal profile is utilized to define an operative temperature at a specified grid point that combines a corresponding grid point temperature and an estimated statistical computation based at least in part on a radiant temperature to generate estimated radiant temperature. In some embodiments, the at least one controller is configured such that the estimated radiant temperature is determined based at least in part on an amount of sunlight illuminating the specified grid point. In some embodiments, the at least one controller is configured such that the operative temperature at the grid point combines a corresponding estimated air speed, relative humidity, and/or metabolic rate of an occupant of the enclosure. In some embodiments, the at least one controller is configured such that the plurality of grid points are arranged according to a homogeneous grid. In some embodiments, the at least one controller is configured such that the plurality of grid points are arranged according to a non-homogeneous grid. In some embodiments, the at least one controller is configured such that the non-homogeneity of the non-homogeneous grid relates to an area of interest. In some embodiments, the at least one controller is configured such that the non-homogeneity of the non-homogeneous grid relates to a grid density. In some embodiments, the at least one controller is configured such that the non-homogeneity of the non-homogeneous grid relates to a grid resolution. In some embodiments, the apparatus comprises a hierarchical control system configured to control one or more environmental characteristics of the enclosure. In some embodiments, the at least one controller is configured to control the one or more environmental characteristics by adjusting a heating, ventilation, and air conditioning (HVAC) system. In some embodiments, the at least one controller is configured to control the one or more environmental characteristics by regulating a velocity of an air flowing through a vent to and/or from the enclosure. In some embodiments, the hierarchical control system comprises a building management system. In some embodiments, the hierarchical control system comprises a plurality of controllers. In some embodiments, the hierarchical control system comprises a master controller that is configured to control one or more local controllers. In some embodiments, at least one of the temperature sensors is disposed in a device ensemble mounted at a location of the locations, and wherein the device ensemble is operatively coupled to the hierarchical control system. In some embodiments, the device ensemble comprises a controller. In some embodiments, the device ensemble comprises (i) sensors or (ii) a sensor and an emitter. In some embodiments, the device ensemble comprises (i) a plurality of processors or (ii) a plurality of circuit boards. In some embodiments, the plurality of circuit boards is configured to facilitate cooling of (i) the device ensemble interior environment and/or (ii) the circuit boards. In some embodiments, the at least one controller is operatively coupled to a network.

In some embodiments, the network is a local network. In some embodiments, the network comprises a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. In some embodiments, the communication comprises media communication facilitating stills, music, or moving picture streams (e.g., movies or videos). In some embodiments, the communication comprises data communication (e.g., sensor data). In some embodiments, the communication comprises control communication, e.g., to control the one or more nodes operatively coupled to the networks. In some embodiments, the network comprises a first (e.g., cabling) network installed in the facility. In some embodiments, the network comprises a (e.g., cabling) network installed in an envelope of the facility (e.g., in an envelope of a building included in the facility).

In another aspect, the present disclosure provides systems, apparatuses (e.g., controllers), and/or non-transitory computer-readable medium (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product, comprising a non-transitory computer-readable medium in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable medium comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions, the non-transitory computer readable program instructions, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium. In some embodiments, the program instructions are inscribed in non-transitory computer readable media. In some embodiments, at least two of the operations are executed by one of the one or more processors. In some embodiments, at least two of the operations are each executed by different processors of the one or more processors.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically shows an example of a processing system;

FIG. 2 schematically shows an example of a control system architecture and a building;

FIG. 3 schematically shows an example of a building and a network;

FIG. 4 shows a block diagram of an example of a network of devices;

FIG. 5 schematically depicts an example of a communication network disposed in various enclosures;

FIG. 6 shows a schematic example of a sensor arrangement;

FIG. 7 shows a schematic example of a sensor arrangement and sensor data;

FIG. 8 shows an example of a topographic map of measured property values;

FIG. 9 shows an example of an apparatus, its components, and connectivity options;

FIG. 10 schematically shows an example of various views and configurations of assembly housings;

FIG. 11 shows an example of a processing sequence relating to thermal comfort;

FIG. 12 depicts an example of a floorplan in an enclosure;

FIG. 13 shows an example of plots of temperature measurements as a function of time.

FIG. 14 shows a flowchart relating to temperature measurement and processing;

FIG. 15 is an example of a floorplan user for thermal control;

FIG. 16 shows a flowchart relating to temperature measurement and processing;

FIG. 17 shows an example of temperature mapping of an enclosure;

FIG. 18 shows an example of temperature mapping of an enclosure;

FIG. 19 shows an example of temperature mapping of an enclosure;

FIG. 20 schematically depicts an example of an Artificial Intelligence (AI) engine and associated components;

FIG. 21 is a flowchart depicting an example of construction of a learning model;

FIG. 22 is a flowchart depicting an example of refinement of a learning model;

FIG. 23 is a flowchart depicting an example of modeling using a grid of vertex points;

FIG. 24 is a flowchart depicting an example of collection of sensor data;

FIG. 25 is a flowchart depicting an example of a performance of environmental adjustments;

FIG. 26 schematically shows an example of an electrochromic device;

FIG. 27 schematically shows an example of a cross-section of an Integrated Glass Unit (IGU);

FIG. 28 shows various cross sections of framing covers (e.g., framing caps);

FIGS. 29A-B shows various views of portions of framing systems; and

FIGS. 30A-30B schematically shows various views of device ensemble housings and components.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

In some embodiments, an enclosure comprises an area defined by at least one structure. The at least one structure may comprise at least one wall. An enclosure may comprise and/or enclose one or more sub-enclosures. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, the enclosure encloses an atmosphere. The atmosphere may comprise one or more gases. The gases may include inert gases (e.g., comprising argon or nitrogen) and/or non-inert gases (e.g., comprising oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), airborne agents (e.g., pollutants, Volatile organic compounds, dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), airborne agents (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network. The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory facility (e.g., vehicle) such as a car, RV, bus, train, airplane, helicopter, ship, or boat. The tintable window may be disposed in a (non-transitory) facility such as a building, and/or in a transitory vehicle such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g., noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g., cations) into the oxide may induce a visible change in a tint (e.g., color) of the oxide. For example, the oxide may transition from a colorless to a colored state. For example, intercalation of lithium ions into tungsten oxide (WO3-y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

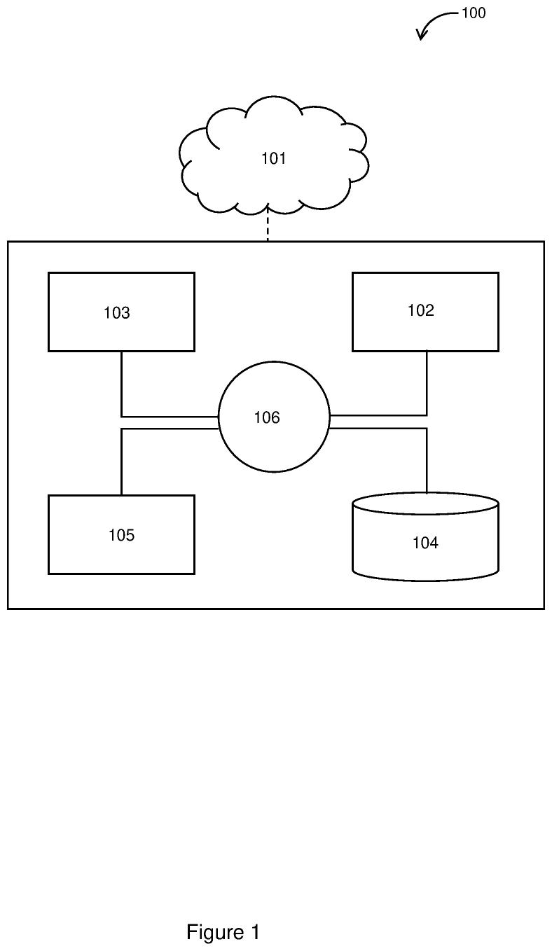

FIG. 1 shows a schematic example of a computer system 100 that is programmed or otherwise configured to perform one or more operations of any of the methods provided herein. The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or device ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 106) (also “processor,” “computer” and “computer processor” used herein). The computer system may include memory or memory location (e.g., 102) (e.g., random-access memory, read-only memory, flash memory), electronic storage unit (e.g., 104) (e.g., hard disk), communication interface (e.g., 103) (e.g., network adapter) for communicating with one or more other systems, and peripheral devices (e.g., 105), such as cache, other memory, data storage and/or electronic display adapters. In the example shown in FIG. 1, the memory 102, storage unit 104, interface 103, and peripheral devices 105 are in communication with the processing unit 106 through a communication bus (solid lines), such as a motherboard. The storage unit can be a data storage unit (or data repository) for storing data. The computer system can be operatively coupled to a computer network (“network”) (e.g., 101) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 102. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 100 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 102 or electronic storage unit 104. The machine executable or machine-readable code can be provided in the form of software. During use, the processor 106 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The signal may comprise radio signals comprising ultra-wide band radio signals. The signal may comprise visible, infrared, or ultraviolet light. The infrared sensor may detect animate objects (e.g., people). The signal may comprise an audio signal (e.g., human audio signal). The electromagnetic signal may comprise a visible, infrared, ultraviolet, ultrasound, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, visible light camera, CCD camera). The camera can be a high resolution camera (e.g., the resolution can be of at least 2 Kilo Pixel (K), 3K, 4K, or 5K camera). The sensor may comprise an accelerometer. The sensor may sense location and/or presence of people. The sensor may sense and/or locate enclosure occupants. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer). In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The devices may compromise a radio emitter and/or receiver (e.g., a wide band, or ultra-wide band radio emitter and/or receiver). The device may include a locating device. The devices may include a Global Positioning System (GPS) device. The devices may include a Bluetooth device. The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times, the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m², from about 250 m² to about 1000 m², or from about 1000 m² to about 2000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions.

In some embodiments, the sensor(s) are operatively coupled to at least one controller and/or processor. Sensor readings may be obtained by one or more processors and/or controllers. A controller may comprise a processing unit (e.g., CPU or GPU). A controller may receive an input (e.g., from at least one sensor). The controller may comprise circuitry, electrical wiring, optical wiring, socket, and/or outlet. A controller may deliver an output. A controller may comprise multiple (e.g., sub-) controllers. The controller may be a part of a control system. A control system may comprise a master controller, floor (e.g., comprising network controller) controller, a local controller. The local controller may be a window controller (e.g., controlling an optically switchable window), enclosure controller, or component controller. For example, a controller may be a part of a hierarchal control system (e.g., comprising a main controller that directs one or more controllers, e.g., floor controllers, local controllers (e.g., window controllers), enclosure controllers, and/or component controllers). A physical location of the controller type in the hierarchal control system may be changing. For example: At a first time: a first processor may assume a role of a main controller, a second processor may assume a role of a floor controller, and a third processor may assume the role of a local controller. At a second time: the second processor may assume a role of a main controller, the first processor may assume a role of a floor controller, and the third processor may remain with the role of a local controller. At a third time: the third processor may assume a role of a main controller, the second processor may assume a role of a floor controller, and the first processor may assume the role of a local controller. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater).

In one embodiment, a floor controller may direct one or more window controllers, one or more enclosure controllers, one or more component controllers, or any combination thereof. The floor controller may comprise a floor controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility.

A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer.

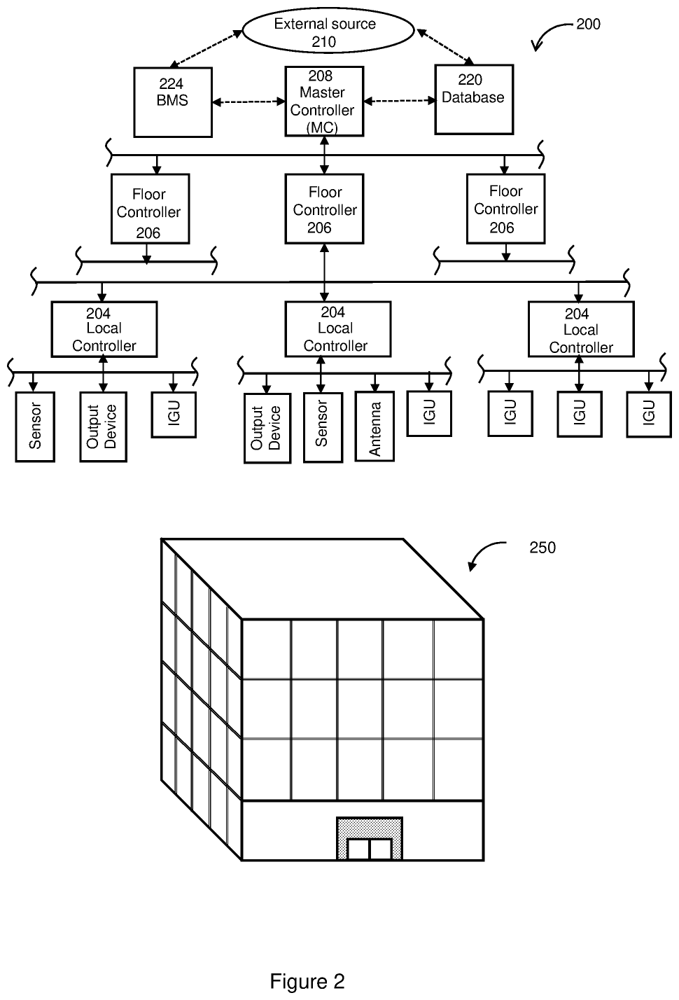

FIG. 2 shows a schematic example of an enclosure 250 featuring a control system architecture 200 comprising a master controller 208 that controls floor controllers 206, that in turn control local controllers 204. In some embodiments, a local controller controls one or more IGUs, one or more sensors, one or more output devices (e.g., one or more emitters), or any combination thereof. In the illustrative configuration of FIG. 2, the master controller is operatively coupled (e.g., communicatively coupled wirelessly and/or wired) to a building management system (BMS) 224 and to a database 220. Arrows in FIG. 2 represents communication pathways. A controller may be operatively coupled (e.g., directly/indirectly and/or wired and/wirelessly) to an external source 210. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 2, all communication arrows can be bidirectional.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by a controller) may include attenuated, modulated, varied, managed, curbed, disciplined, regulated, restrained, supervised, manipulated, and/or guided. The control may comprise controlling a control variable (e.g., temperature, power, voltage, and/or profile). The control can comprise real time or off-line control. A calculation utilized by the controller can be done in real time, and/or offline. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer.

The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., including lighting, security, occupancy, occupant behavior, HVAC, sensor, emitter, alarms, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of an air flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

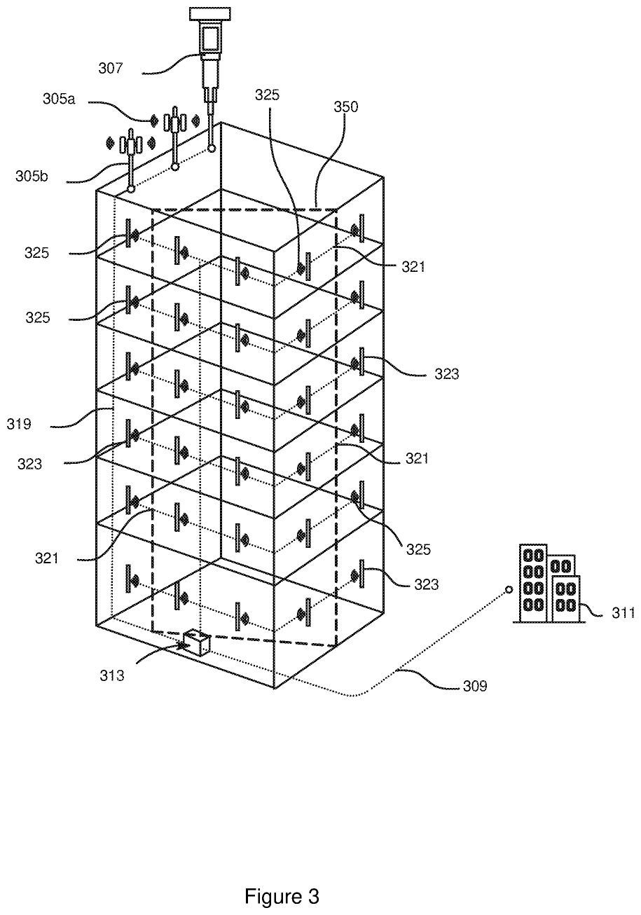

In certain embodiments, a building network infrastructure has a vertical data plane (between building floors) and a horizontal data plane (all within a single floor or multiple (e.g., contiguous) floors). In some cases, the horizontal and vertical data planes have at least one (e.g., all) data carrying capabilities and/or components that is (e.g., substantially) the same or similar data. In other cases, these two data planes have at least one (e.g., all) different data carrying capabilities and/or components. For example, the vertical data plane may contain one or more components for fast data transmission rates and/or bandwidths. In one example, the vertical data plane contains components that support at least about 10 Gigabit/second (Gbit/s) or faster (e.g., Ethernet) data transmissions (e.g., using a first type of wiring (e.g., UTP wires and/or fiber optic cables)), while the horizontal data plane contains components that support at most about 8 Gbit/s, 5 Gbit/s, or 1 Gbit/s (e.g., Ethernet) data transmissions, e.g., via a second type of wiring (e.g., coaxial cable). In some cases, the horizontal data plane supports data transmission via d.hn or MoCA standards (e.g., MoCA 2.5 or MoCA 3.0). In certain embodiments, connections between floors on the vertical data plane employ control panels with high speed (e.g., Ethernet) switches that pair communication between the horizontal and vertical data planes and/or between the different types of wiring. These control panels can communicate with (e.g., IP) addressable nodes (e.g., devices) on a given floor via the communication (e.g., d.hn or MoCA) interface and associated wiring (e.g., coaxial cables, twisted cables, or optical cables) on the horizontal data plane. Horizontal and vertical data planes in a single building structure are depicted in FIG. 3.

Data transmission, and in some embodiments voice services, may be provided in a building via wireless and/or wired communications, to and/or from occupants of the building. The data transmission and/or voice services may become difficult due in part to attenuation by building structures such as walls, floors, ceilings, and windows, in third, fourth, or fifth generation (3G, 4G, or 5G) cellular communication. Relative to 3G and 4G communication, the attenuation becomes more severe with higher frequency protocols such as 5G. To address this challenge, a building can be outfitted with components that serve as gateways or ports for cellular signals. Such gateways couple to infrastructure in the interior of the building that provide wireless service (e.g., via interior antennas and other infrastructure implementing Wi-Fi, small cell service (e.g., via microcell or femtocell devices), CBRS, etc.). The gateways or points of entry for such services may include high speed cable (e.g., underground) from a central office of a carrier and/or a wireless signal received at an antenna strategically located on the building exterior (e.g., a donor antenna and/or sky sensor on the building's roof). The high speed cable to the building can be referred to as “backhaul.”

FIG. 3 shows an example of a building with device ensembles (e.g., assemblies). As points of connection, the building can include multiple rooftop donor antennas 305, 305b as well as a sky sensor 307 for sending electromagnetic radiation (e.g., infrared, ultraviolet, and/or visible light). These wireless signals may allow a building services network to wirelessly interface with one or more communications service provider systems. The building has a control panel 313 for connecting to a provider's central office 311 via a physical line 309 (e.g., an optical fiber such as a single mode optical fiber). The control panel 313 may include hardware and/or software configured to provide functions of, for example, a signal source carrier head end, a fiber distribution headend, and/or a (e.g., bi-directional) amplifier or repeater. The rooftop donor antennas 305a and 305b allow building occupants and/or devices to access a wireless system communications service of a (e.g., 3^{rd} party) provider. the antenna and/or controller(s) may provide access to the same service provider system, a different service provider system, or some variation such as two interface elements providing access to a system of a first service provider, and a different interface element providing access to a system of a second service provider.

As shown in the example of FIG. 3, a vertical data plane may include a (e.g., high capacity, or high-speed) data carrying line 319 such as (e.g., single mode) optical fiber or UTP copper lines (of sufficient gauge). In some embodiments, at least one control panel could be provided on at least part of the floors of the building (e.g., on each floor). In some embodiments, one (e.g., high capacity) communication line can directly connect a control panel in the top floor with (e.g., main) control panel 313 in the bottom floor (or in the basement floor). Note that control panel 317 directly connects to rooftop antennas 305a, 305b and/or sky sensor 307, while control panel 313 directly connects to the (e.g., 3^{rd} party) service provider central office 311.

FIG. 3 shows an example of a horizontal data plane that may include one or more of the control panels and data carrying wiring (e.g., lines), which include trunk lines 321. In some embodiments, the trunk lines are made from coaxial cable. The trunk lines may comprise any wiring disclosed herein. The control panels may be configured to provide data on the trunk lines 321 via a data communication protocol (such as MoCA and/or d.hn). The data communication protocol may comprise (i) a next generation home networking protocol (abbreviated herein as “G.hn” protocol), (ii) communications technology that transmits digital information over power lines that traditionally used to (e.g., only) deliver electrical power, or (iii) hardware devices designed for communication and transfer of data (e.g., Ethernet, USB and Wi-Fi) through electrical wiring of a building. The data transfer protocols may facilitate data transmission rates of at least 1 Gigabits per second (Gbit/s), 2 Gbit/s, 3 Gbit/s, 4 Gbit/s, or 5 Gbit/s. The data transfer protocol may operate over telephone wiring, coaxial cables, power lines, and/or (e.g., plastic) optical fiber. The data transfer protocol may be facilitated using a chip (e.g., comprising a semiconductor device).

Each horizontal data plane may provide high speed network access to one or more device ensembles 323 (e.g., a set of one or more devices in a housing comprising an assembly of devices) and/or antennas 325, some or all of which are optionally integrated with device ensembles 323. Antennas 325 (and associated radios, not shown) may be configured to provide wireless access by any of various protocols, including, e.g., cellular (e.g., one or more frequency bands at or proximate 28 GHZ), Wi-Fi (e.g., one or more frequency bands at 2.4, 5, and 60 GHz), CBRS, and the like. Drop lines may connect device ensembles 323 to trunk lines 321. In some embodiments, a horizontal data plane is deployed on a floor of a building. The devices in the device ensemble may comprise a sensor, emitter, or antenna. The device ensemble may comprise a circuitry. The devices in the device ensemble may be operatively coupled to the circuitry.

One or more donor antennas 305a, 305b may connect to the control panel 313 via high speed lines (e.g., single mode optical fiber or copper). In the depicted example, the control panel 313 may be located in a lower floor of the building. Also as depicted, the connection to the donor antenna(s) 305a, 305b may be via one or more vRAN radios and wiring (e.g., coaxial cable).

The communications service provider central office 311 connects to ground floor control panel 313 via a high speed line 309 (e.g., an optical fiber serving as part of a backhaul). This entry point of the service provider to the building may be referred to as a Main Point of Entry (MPOE), and it may be configured to permit the building to distribute both voice and data traffic.

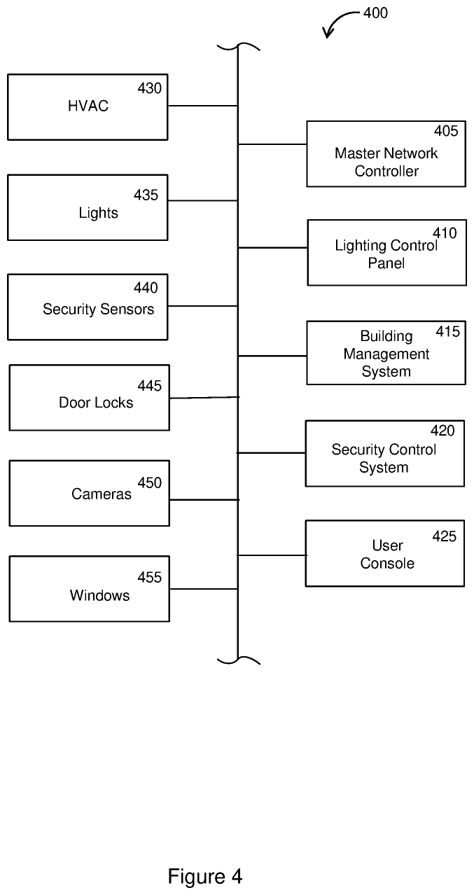

In some embodiments, a small cell system is made available to a building, at least in part, via one or more antennas. Examples of antennas, sky sensor, and control systems can be found in U.S. patent application Ser. No. 15/287,646, filed Oct. 6, 2016, which is incorporated herein by reference in its entirety. Use of a roof antenna may provide other advantages such facilitating cellular coverage to an increased area (geographically). In some embodiments, a small cell system is made available to a building, at least in part, via one or more donor antennas. FIG. 4 depicts a block diagram of an embodiment of a building network 400 for a building. Building network 400 may employ any number of different communication protocols, including BACnet. As shown, building network 400 includes a master network controller 405, a lighting control panel 410, a building management system 415, a security control system 420, and a user console 425. These different controllers and systems in the building may be used to receive input from and/or control an HVAC system 430, lights 435, security sensors 440, door locks 445, cameras 450, and tintable windows 455 of the building.

Master network controller 405 may function in a similar manner as master controller 208 described with respect to FIG. 2. Lighting control panel 410 (FIG. 4) may include circuitry to control any device disclosed herein (e.g., the interior lighting that is operatively coupled to the controller. The device may comprise interior lighting, the exterior lighting, the emergency warning lights, the emergency exit signs, and the emergency floor egress lighting, which lighting is associated with the building and is operatively coupled to the controller. Lighting control panel 410 may include other devices (e.g., an occupancy sensor). Building management system (BMS) 415 may include a computer server that receives data from, and/or issues commands to the, other systems and controllers operatively coupled to the network 400. For example, BMS 415 may receive data from and issue commands to each of the master network controller 405, lighting control panel 410, and security control system 420. Security control system 420 may include magnetic card access, turnstiles, solenoid driven door locks, surveillance cameras, burglar alarms, metal detectors, and the like. User console 425 may be a computer terminal that can be used by the building manager to schedule operations of, control, monitor, optimize, and troubleshoot the different systems of the building. Software from Tridium, Inc., may generate visual representations of data from different systems for user console 425.

Each of the different controls may control individual devices/apparatus. Master network controller 405 may control tintable windows 455. Lighting control panel 410 may control lights 435. BMS 415 may control HVAC 430. Security control system 420 may control security sensors 440, door locks 445, and cameras 450. Data may be exchanged and/or shared between (e.g., all of) the different devices and controllers that are part of the building network 400.

In some embodiments, at least a portion of the systems of BMS 415 and/or building network 400 may run according to daily, monthly, quarterly, or yearly schedules. For example, the lighting control system, the window control system, the HVAC, and the security system may operate on a 24-hour schedule accounting for when people are in the building during the work-day. At least two device categories (e.g., of 430, 435, 440, 445, 450, and 455) may run at a different schedule from each other. At least two device categories (e.g., of 430, 435, 440, 445, 450, and 455) may run at (e.g., substantially) the same schedule. For example, at night the building may enter an energy savings mode, and during the day the systems may operate in a manner that minimizes the energy consumption of the building while providing for occupant comfort, safety, and health. As another example, the systems may shut down or enter an energy savings mode over a holiday period.

The scheduling information may be combined with geographical information. Geographical information may include the latitude and/or longitude of the building. Geographical information may include information about the direction that at least one side of the building faces. Using such information, different rooms on different sides of the building may be controlled in different manners. For example, for East facing rooms of the building in the winter, the window controller may instruct the windows to have no tint in the morning so that the room warms up due to sunlight shining in the room and the lighting control panel may instruct the lights to be dim because of the lighting from the sunlight. The west facing windows may be controllable by the occupants of the room in the morning because the tint of the windows on the west side may have no impact on energy savings. The modes of operation of the east facing windows and the west facing windows may switch in the evening (e.g., when the sun is setting, the west facing windows may not be tinted to allow sunlight in for both heat and lighting).

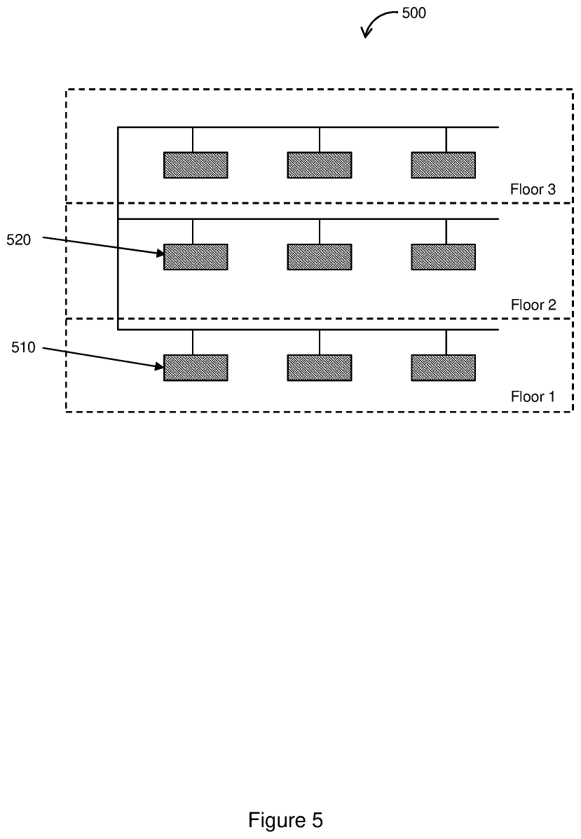

In some embodiments, a plurality of assemblies (e.g., device ensembles) are deployed as interconnected (e.g., IP) addressable nodes (e.g., devices) within a processing system throughout a particular enclosure (e.g., a building), portions thereof (e.g., rooms or floors), or spanning a plurality of such enclosures. FIG. 5 shows a schematic example of a network system within an enclosure (e.g., building) having a plurality of sub-enclosures (e.g., floors). In the example of FIG. 5, the enclosure 500 is a building having floor 1, floor 2, and floor 3. The enclosure 500 includes a network 520 (e.g., a wired network) that is provided to communicatively couple any addressable circuitry (e.g., addressable node) such as a device or to a device ensemble (also referred to herein as a″ community of components” (e.g., community of devices)) collectively represented by 510. In the example shown in FIG. 5, the three floors are sub enclosures within the enclosure 500. At least two devices can be of a different type from each other. At least two devices can be of the same type. At least two device ensembles can be of a different type from each other. At least two device ensembles can be of the same type.

In some embodiments, an enclosure includes one or more sensors. The sensor may facilitate controlling the environment of the enclosure, e.g., such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. The sensor may provide on/off indications of the occurrence and/or presence of an environmental event (e.g., one pixel sensors). In some embodiments, the accuracy and/or resolution of a sensor may be improved via artificial intelligence (abbreviated herein as “AI”) analysis of its measurements. Examples of artificial intelligence techniques that may be used include: reactive, limited memory, theory of mind, and/or self-aware techniques know to those skilled in the art). Sensors (including their circuitry) may be configured to process, measure, analyze, detect and/or react to: data, temperature, humidity, sound, force, pressure, concentration, electromagnetic waves, position, distance, movement, flow, acceleration, speed, vibration, dust, light, glare, color, gas(es) type, and/or any other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting and/or in the facility. A sensor may be optimized to performing accurate measurements of one or more environmental characteristics present in the factory setting and/or in the facility in which it is deployed.

In some embodiments, a plurality of sensors of the same type may be distributed in a plurality of locations or in a housing. For example, at least one of the plurality of sensors of the same type, may be part of an ensemble. For example, at least two of the plurality of sensors of the same type, may be part of at least two different ensembles. The device ensembles may be distributed in an enclosure. An enclosure may comprise a conference room or a cafeteria. For example, a plurality of sensors of the same type may measure an environmental characteristic (e.g., parameter) in the conference room. Responsive to measurement of the environmental parameter of an enclosure, a parameter topology of the enclosure may be generated. A parameter topology may be generated utilizing output signals from any type of sensor or device ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, piers (e.g., electricity and/or elevator pier), and/or elevators. Examples of artificial intelligence techniques that may be used include: reactive, limited memory, theory of mind, and/or self-aware techniques know to those skilled in the art). Sensors may be configured to process, measure, analyze, detect and/or react to one or more of: data, temperature, humidity, sound, force, pressure, electromagnetic waves, position, distance, movement, flow, acceleration, speed, vibration, dust, light, glare, color, gas(es), pathogen exposure (or likely pathogen exposure), and/or other aspects (e.g., characteristics) of an environment (e.g., of an enclosure). The gases may include volatile organic compounds (VOCs). The gases may include carbon monoxide, carbon dioxide, formaldehyde, Naphthalene, Taurine, water vapor (e.g., humidity), oxygen, radon, and/or hydrogen sulfide. The one or more sensors may be calibrated in a factory setting. A sensor may be optimized to be capable of performing accurate measurements of one or more environmental characteristics present in the factory setting. In some instances, a factory calibrated sensor may be less optimized for operation in a target environment. For example, a factory setting may comprise a different environment than a target environment. The target environment can be an environment in which the sensor is deployed. The target environment can be an environment in which the sensor is expected and/or destined to operate. The target environment may differ from a factory environment. A factory environment corresponds to a location at which the sensor was assembled and/or built. The target environment may comprise a factory in which the sensor was not assembled and/or built. In some instances, the factory setting may differ from the target environment to the extent that sensor readings captured in the target environment are erroneous (e.g., to a measurable extent). In this context, “erroneous” may refer to sensor readings that deviate from a specified accuracy (e.g., specified by a manufacture of the sensor). In some situations, a factory-calibrated sensor may provide readings that do not meet accuracy specifications (e.g., by a manufacturer) when operated in the target environments.

In some embodiments, processing sensor data comprises performing sensor data analysis. The sensor data analysis may comprise at least one rational decision making process, and/or learning. The sensor data analysis may be utilized to adjust and environment, e.g., by adjusting one or more components that affect the environment of the enclosure. The data analysis may be performed by a machine based system (e.g., a circuitry). The circuitry may be of a processor. The sensor data analysis may utilize artificial intelligence. The sensor data analysis may rely on one or more models (e.g., mathematical models). In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM) technique, or deep learning techniques.

In certain implementations, models such as thermal models are built in a “supervised” fashion. For example, building specialized thermal models in a “supervised” fashion may be used where (e.g., thermal and/or weather) feed data is accessible from a database. The specialized models may be trained on data for which a qualitative classification already exists. The models may be trained on data associated with (e.g., thermal) condition and the specialized model trained on a particular condition, which can be deployed when the particular condition is forecast (e.g., using weather forecast, timetable, or calendar scheduling of an event). In certain instances, leveraging third-party (e.g., weather) databases to supervise training of models optimized for performance on pre-labeled training data may obviate (1) the ‘cold-start’ problem (e.g., insufficient data available), and/or (2) the need for human intervention during model curation. Examples of supervised models that may be used in various combinations include: multilayer perceptrons, decision trees, regressions (e.g., logistic regression, linear regression, and the like), SVMs, naïve Bayes, and the like. In certain implementations, unsupervised clustering may be combined with a specialized thermal model built in a “supervised” fashion. In one example, a clustering algorithm may be used to reduce a dimensionality of a feature space of a training set used to train a supervised model in order to reduce variance of the supervised model.

In some embodiments, analysis of sensor data is performed (e.g., by the control system). The data analysis process may comprises data manipulation. The data manipulation may comprise data imputation (e.g., cleaning the raw sensor data and providing it as an output), and/or data filtering. The data filtering methods may comprise median, mean, standard deviation, or select minima as a filtering mechanism(s). The filtering may comprise performing standard deviation of measurement minimas, e.g., to derive a long term variation in a specific location. The data analysis may comprise calculating median absolute deviation (e.g., median absolute distance from the median). The filtering may be for a purpose of removing environmental noise (e.g., fluctuations).

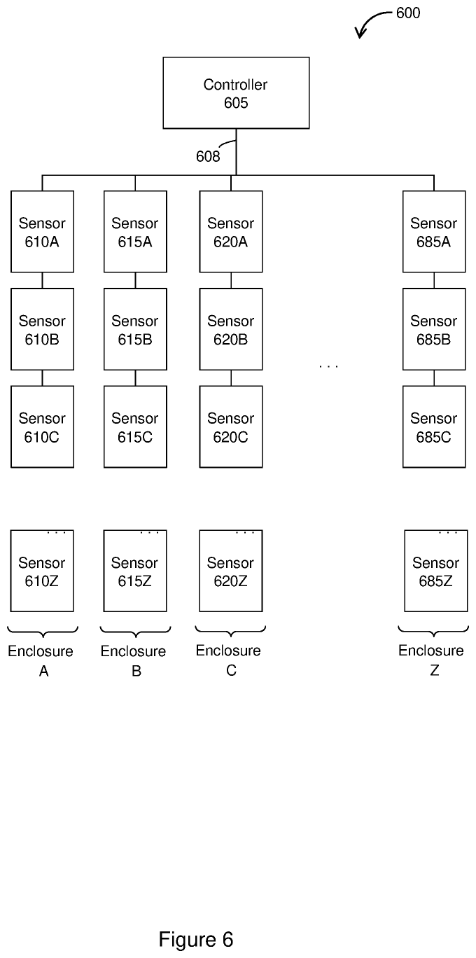

FIG. 6 shows an example of a diagram 600 of an arrangement of sensors distributed among enclosures. In the example shown in FIG. 6, a controller 605 is communicatively linked 608 with sensors located in enclosure A (sensors 610A, 610B, 610C, . . . 610Z), enclosure B (sensors 615A, 615B, 615C, 615Z), enclosure C (sensors 620A, 620B, 620C, . . . 620Z), and enclosure Z (sensors 685A, 685B, 685C, . . . 685Z). Communicatively linked comprises wired and/or wireless communication. In some embodiments, a device ensemble includes at least two sensors of a differing types. In some embodiments, a device ensemble includes at least two emitters of a differing types. In some embodiments, a device ensemble includes at least two sensors of the same type (e.g., a sensor array). In some embodiments, a device ensemble includes at least two emitters of the same type (e.g., an emitter array such as a light emitting diode array).

In some embodiments, a device ensemble includes at least two sensors of the same type. In the example shown in FIG. 6, sensors 610A, 610B, 610C, . . . 610Z of enclosure A represent an ensemble. An ensemble of sensors can refer to a collection of diverse sensors. In some embodiments, at least two of the sensors in the ensemble cooperate to determine environmental parameters, e.g., of an enclosure in which they are disposed. For example, a device ensemble may include a carbon dioxide sensor, a carbon monoxide sensor, a volatile organic chemical compound sensor, an environmental noise sensor, a light (visible, UV, and IR) sensor, a temperature sensor, and/or a humidity sensor. A device ensemble may comprise other types of sensors, and claimed subject matter is not limited in this respect. The enclosure may comprise one or more sensors that are not part of an ensemble of sensors. The enclosure may comprise a plurality of ensembles. At least two of the plurality of ensembles may differ in at least one of their sensors. At least two of the plurality of ensembles may have at least one of their sensors that is similar (e.g., of the same type). For example, an ensemble can have two motion sensors and one temperature sensor. For example, an ensemble can have a carbon dioxide sensor and an IR sensor. The ensemble may include one or more devices that are not sensors. The one or more other devices that are not sensors may include sound emitter (e.g., buzzer), and/or electromagnetic radiation emitters (e.g., light emitting diode). In some embodiments, a single sensor (e.g., not in an ensemble) may be disposed adjacent (e.g., immediately adjacent such as contacting) another device that is not a sensor.

Sensors of a device ensemble may collaborate with one another. A sensor of one type may have a correlation with at least one other type of sensor. A situation in an enclosure may affect one or more of different sensors. Sensor readings of the one or more different may be correlated and/or affected by the situation. The correlations may be predetermined. The correlations may be determined over a period of time (e.g., using a learning process). The period of time may be predetermined. The period of time may have a cutoff value. The cutoff value may consider an error threshold (e.g., percentage value) between a predictive sensor data and a measured sensor data, e.g., in similar situation(s). The time may be ongoing. The correlation may be derived from a learning set (also referred to herein as “training set”). The learning set may comprise, and/or may be derived from, real time observations in the enclosure. The observations may include data collection (e.g., from sensor(s)). The learning set may comprise sensor(s) data from a similar enclosure. The learning set may comprise third party data set (e.g., of sensor(s) data). The learning set may derive from simulation, e.g., of one or more environmental conditions affecting the enclosure. The learning set may compose detected (e.g., historic) signal data to which one or more types of noise were added. The correlation may utilize historic data, third party data, and/or real time (e.g., sensor) data. The correlation between two sensor types may be assigned a value. The value may be a relative value (e.g., strong correlation, medium correlation, or weak correlation). The learning set that is not derived from real-time measurements, may serve as a benchmark (e.g., baseline) to initiate operations of the sensors and/or various components that affect the environment (e.g., HVAC system, and/or tinting windows). Real time sensor data may supplement the learning set, e.g., on an ongoing basis or for a defined time period. The (e.g., supplemented) learning set may increase in size during deployment of the sensors in the environment. The initial learning set may increase in size, e.g., with inclusion of additional (i) real time measurements, (ii) sensor data from other (e.g., similar) enclosures, (iii) third party data, (iv) other and/or updated simulation.

In some embodiments, data from sensors may be correlated. Once a correlation between two or more sensor types is established, a deviation from the correlation (e.g., from the correlation value) may indicate an irregular situation and/or malfunction of a sensor of the correlating sensors. The malfunction may include a slippage of a calibration. The malfunction may indicate a requirement for re-calibration of the sensor. A malfunction may comprise complete failure of the sensor. In an example, a movement sensor may collaborate with a carbon dioxide sensor. In an example, responsive to a movement sensor detecting movement of one or more individuals in an enclosure, a carbon dioxide sensor may be activated to begin taking carbon dioxide measurements. An increase in movement in an enclosure, may be correlated with increased levels of carbon dioxide. In another example, a motion sensor detecting individuals in an enclosure may be correlated with an increase in noise detected by a noise sensor in the enclosure.

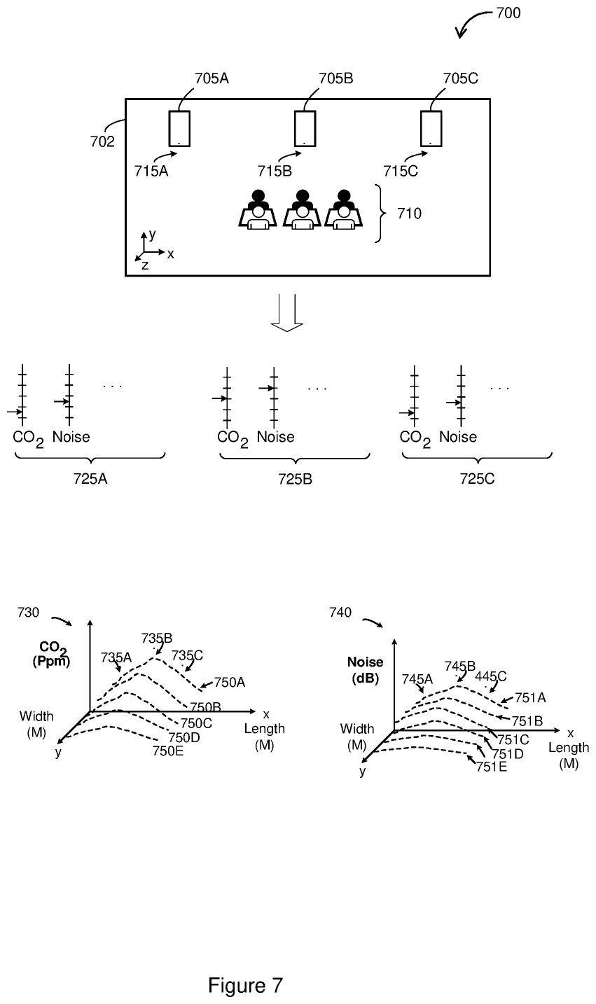

In some embodiments, detection by a first type of sensor that is not accompanied by detection by a second type of sensor, may result in a sensor posting an error message. For example, if a motion sensor detects numerous individuals in an enclosure without detecting an increase in carbon dioxide and/or noise, the carbon dioxide sensor and/or the noise sensor may be identified as having failed or as having an erroneous output. An error message may be posted. A first plurality of different correlating sensors in a first ensemble may include one sensor of a first type, and a second plurality of sensors of different types. If the second plurality of sensors indicate a correlation, and the one sensor indicates a reading different from the correlation, there is an increased likelihood that the one sensor malfunctions. If the first plurality of sensors in the first ensemble detect a first correlation, and a third plurality of correlating sensors in a second ensemble detect a second correlation different from the first correlation, there is an increased likelihood that the situation to which the first ensemble of sensors is exposed to is different from the situation to which the third ensemble of sensors are exposed to. Sensors of a device ensemble may collaborate with one another. The collaboration may comprise considering sensor data of another sensor (e.g., of a different type) in the ensemble. The collaboration may comprise trends projected by the other sensor (e.g., type) in the ensemble. The collaboration may comprise trends projected by data relating to another sensor (e.g., type) in the ensemble. The other sensor data can be derived from the other sensor in the ensemble, from sensors of the same type in other ensembles, or from data of the type collected by the other sensor in the ensemble, which data does not derive from the other sensor. For example, a first ensemble may include a pressure sensor and a temperature sensor. The collaboration between the pressure sensor and the temperature sensor may comprise considering pressure sensor data while analyzing and/or projecting temperature data of the temperature sensor in the first ensemble. The pressure data may be (i) of a pressure sensor in the first ensemble, (ii) of pressure sensor(s) in one or more other ensembles, (iii) pressure data of other sensor(s) and/or (iv) pressure data of a third party. FIG. 7 shows an example of a diagram 700 of an arrangement of device ensembles distributed within an enclosure. In the example shown in FIG. 7, a group 710 of individuals are seated in a conference room 702. The conference room includes an “X” dimension to indicate length, a “Y” dimension to indicate height, and a “Z” dimension to indicate depth. XYZ are directions in a Cartesian coordination system. Device ensembles 705A, 705B, and 705C comprise sensors can operate similar to sensors described in reference to device ensembles 323 of FIG. 3. At least two device ensembles (e.g., 705A, 705B, and 705C) may be integrated into a single sensor module. Device ensembles 705A, 705B, and 705C can include a carbon dioxide (CO₂) sensor, an ambient noise sensor, or any other sensor disclosed herein. In the example shown in FIG. 7, a first device ensemble 705A is disposed (e.g., installed) near point 715A, which may correspond to a location in a ceiling, wall, or other location to a side of a table at which the group 710 of individuals are seated. In the example shown in FIG. 7, a second device ensemble 705B is disposed (e.g., installed) near point 715B, which may correspond to a location in a ceiling, wall, or other location above (e.g., directly above) a table at which the group 710 of individuals are seated. In the example shown in FIG. 7, a third device ensemble 705C may be disposed (e.g., installed) at or near point 715C, which may correspond to a location in a ceiling, wall, or other location to a side of the table at which the relatively small group 710 of individuals are seated. Any number of additional sensors and/or sensor modules may be positioned at other locations of conference room 702. The device ensembles may be disposed anywhere in the enclosure. The location of an ensemble of sensors in an enclosure may have coordinates (e.g., in a Cartesian coordinate system). At least one coordinate (e.g., of x, y, and z) may differ between two or more device ensembles, e.g., that are disposed in the enclosure. At least two coordinates (e.g., of x, y, and z) may differ between two or more device ensembles, e.g., that are disposed in the enclosure. All the coordinates (e.g., of x, y, and z) may differ between two or more device ensembles, e.g., that are disposed in the enclosure. For example, two device ensembles may have the same x coordinate, and different y and z coordinates. For example, two device ensembles may have the same x and y coordinates, and a different z coordinate. For example, two device ensembles may have different x, y, and z coordinates. In some embodiments, one or more sensors of the device ensemble provide readings. In some embodiments, the sensor is configured to sense a parameter. The parameter may comprise temperature, particulate matter, volatile organic compounds, electromagnetic energy, pressure, acceleration, time, radar, lidar, glass vibrations, glass breakage, movement, or gas. The gas may comprise a Nobel gas. The gas may be a gas harmful to an average human. The gas may be a gas present in the ambient atmosphere (e.g., oxygen, carbon dioxide, ozone, chlorinated carbon compounds, or nitrogen). The gas may comprise radon, carbon monoxide, hydrogen sulfide, hydrogen, oxygen, water (e.g., humidity). The electromagnetic sensor may comprise an infrared, visible light, ultraviolet sensor. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The radio waves may be at a medium frequency of at least about 300 kilohertz (KHz), 500 KHz, 800 KHz, 1000 KHz, 1500 KHz, 2000 KHz, or 2500 KHz. The radio waves may be at a medium frequency of at most about 500 KHz, 800 KHz, 1000 KHz, 1500 KHz, 2000 KHz, 2500 KHz, or 3000 KHz. The radio waves may be at any frequency between the aforementioned frequency ranges (e.g., from about 300 KHz to about 3000 KHz). The radio waves may be at a high frequency of at least about 3 megahertz (MHz), 5 MHZ, 8 MHZ, 10 MHz, 15 MHZ, 20 MHz, or 25 MHz. The radio waves may be at a high frequency of at most about 5 MHz, 8 MHz, 10 MHz, 15 MHz, 20 MHZ, 25 MHz, or 30 MHz. The radio waves may be at any frequency between the aforementioned frequency ranges (e.g., from about 3 MHz to about 30 MHZ). The radio waves may be at a very high frequency of at least about 30 Megahertz (MHz), 50 MHZ, 80 MHZ, 100 MHz, 150 MHz, 200 MHz, or 250 MHz. The radio waves may be at a very high frequency of at most about 50 MHZ, 80 MHz, 100 MHZ, 150 MHz, 200 MHZ, 250 MHZ, or 300 MHz. The radio waves may be at any frequency between the aforementioned frequency ranges (e.g., from about 30 MHz to about 300 MHz). The radio waves may be at an ultra-high frequency of at least about 300 kilohertz (MHz), 500 MHZ, 800 MHz, 1000 MHz, 1500 MHZ, 2000 MHz, or 2500 MHz. The radio waves may be at an ultra-high frequency of at most about 500 MHz, 800 MHZ, 1000 MHZ, 1500 MHz, 2000 MHZ, 2500 MHZ, or 3000 MHz. The radio waves may be at any frequency between the aforementioned frequency ranges (e.g., from about 300 MHz to about 3000 MHz). The radio waves may be at a super high frequency of at least about 3 gigahertz (GHz), 5 GHZ, 8 GHZ, 10 GHZ, 15 GHZ, 20 GHZ, or 25 GHz. The radio waves may be at a super high frequency of at most about 5 GHZ, 8 GHZ, 10 GHZ, 15 GHZ, 20 GHZ, 25 GHZ, or 30 GHz. The radio waves may be at any frequency between the aforementioned frequency ranges (e.g., from about 3 GHz to about 30 GHz).

The gas sensor may sense a gas type, flow (e.g., velocity and/or acceleration), pressure, and/or concentration. The readings may have an amplitude range. The readings may have a parameter range. For example, the parameter may be electromagnetic wavelength, and the range may be a range of detected wavelengths.

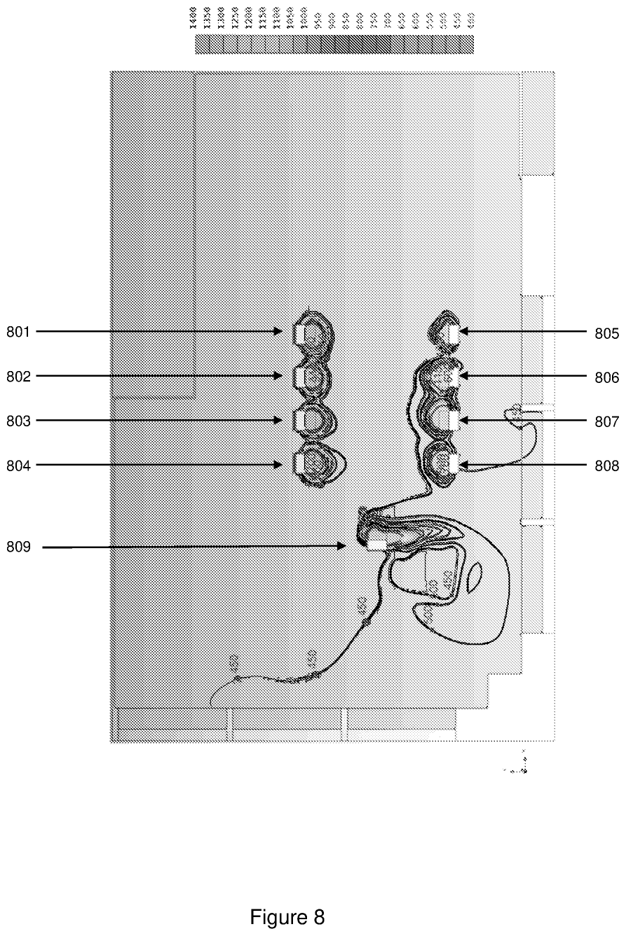

In some embodiments, the sensor data is responsive to the environment in the enclosure and/or to any inducer(s) of a change (e.g., any environmental disruptor) in this environment. The sensors data may be responsive to emitters operatively coupled to (e.g., in) the enclosure (e.g., an occupant, appliances (e.g., heater, cooler, ventilation, and/or vacuum), opening). For example, the sensor data may be responsive to an air conditioning duct, or to an open window. The sensor data may be responsive to an activity taking place in the room. The activity may include human activity, and/or non-human activity. The activity may include electronic activity, gaseous activity, and/or chemical activity. The activity may include a sensual activity (e.g., visual, tactile, olfactory, auditory, and/or gustatory). The activity may include an electronic and/or magnetic activity. The activity may be sensed by a person. The activity may not be sensed by a person. The sensors data may be responsive to the occupants in the enclosure, substance (e.g., gas) flow, substance (e.g., gas) pressure, and/or temperature. In one example, device ensembles 705A, 705B, and 705C may include a carbon dioxide (CO₂) sensor, and an ambient noise sensor. A carbon dioxide sensor of device ensemble 705A may provide a reading as depicted in sensor output reading profile 725A. A noise sensor of device ensemble 705A may provide a reading depicted in sensor output reading profile 725A. A carbon dioxide sensor of device ensemble 705B may provide a reading as depicted in sensor output reading profile 725B. A noise sensor of device ensemble 705B may provide a reading also as depicted in sensor output reading profile 725B. Sensor output reading profile 725B may indicate higher levels of carbon dioxide and noise relative to sensor output reading profile 725A. Sensor output reading profile 725C may indicate lower levels of carbon dioxide and noise relative to sensor output reading profile 725B. Sensor output reading profile 725C may indicate carbon dioxide and noise levels similar to those of sensor output reading profile 725A. Sensor output reading profiles 725A, 725B, and 725C may comprise indications representing other sensor readings, such as temperature, humidity, particulate matter, volatile organic compounds, ambient light, pressure, acceleration, time, radar, lidar, ultra-wideband radio signals, passive infrared, and/or glass breakage, movement detectors. In some embodiments, data from a sensor in a sensor in the enclosure (e.g., and in the device ensemble) is collected and/or processed (e.g., analyzed). The data processing can be performed by a processor of the sensor, by a processor of the device ensemble, by another sensor, by another ensemble, in the cloud, by a processor of the controller, by a processor in the enclosure, by a processor outside of the enclosure, by a remote processor (e.g., in a different facility), by a manufacturer (e.g., of the sensor, of the window, and/or of the building network). The data of the sensor may have a time indicator (e.g., may be time stamped). The data of the sensor may have a sensor location identification (e.g., be location stamped). The sensor may be identifiably coupled with one or more controllers. In particular embodiments, sensor output reading profiles 725A, 725B, and 725C may be processed. For example, as part of the processing (e.g., analysis), the sensor output reading profiles may be plotted on a graph depicting a sensor reading as a function of a dimension (e.g., the “X” dimension) of an enclosure (e.g., conference room 702). In an example, a carbon dioxide level indicated in sensor output reading profile 725A may be indicated as point 735A of CO₂ graph 730 of FIG. 7. In an example, a carbon dioxide level of sensor output reading profile 725B may be indicated as point 735B of CO₂ graph 730. In an example, a carbon dioxide level indicated in sensor output reading profile 725C may be indicated as point 735C of CO₂ graph 730. In an example, an ambient noise level indicated in sensor output reading profile 725A may be indicated as point 745A of noise graph 740. In an example, an ambient noise level indicated in sensor output reading profile 725B may be indicated as point 745B of noise graph 740. In an example, an ambient noise level indicated in sensor output reading profile 725C may be indicated as point 745C of noise graph 740. In some embodiments, processing data derived from the sensor comprises applying one or more models. The models may comprise mathematical models. The processing may comprise fitting of models (e.g., curve fitting). The model may be multi-dimensional (e.g., two or three dimensional). The model may be represented as a graph (e.g., 2 or 3 dimensional graph). For example, the model may be represented as a contour map (e.g., as depicted in FIG. 7). The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change. In particular embodiments, device ensembles 705A, 705B, and/or 705C, may be capable of accessing a model to permit curve fitting of sensor readings as a function of one or more dimensions of an enclosure. In an example, a model may be accessed to generate sensor profile curves 750A, 750B, 750C, 750D, and 750E, utilizing points 735A, 735B, and 735C of CO₂ graph 730. In an example, a model may be accessed to generate sensor profile curves 751A, 751B, 751C, 751B, and 751E utilizing points 745A, 745B, and 745C of noise graph 740. Additional models may utilize additional readings from device ensembles (e.g., 705A, 705B, and/or 705C) to provide curves in addition to sensor profile curves 750 and 751 of FIG. 7. Sensor profile curves generated in response to use of a model may sensor output reading profiles indicate a value of a particular environmental parameter as a function of a dimension of an enclosure (e.g., an “X” dimension, a “Y” dimension, and/or a “Z” dimension). In certain embodiments, one or more models utilized to form curves 750A-750E and 751A-751E) may provide a parameter topology of an enclosure. In an example, a parameter topology (as represented by curves 750A-750E and 751A-751E) may be synthesized or generated from sensor output reading profiles. The parameter topology may be a topology of any sensed parameter disclosed herein. In an example, a parameter topology for a conference room (e.g., conference room 702) may comprise a carbon dioxide profile having relatively low values at locations away from a conference room table and relatively high values at locations above (e.g., directly above) a conference room table. In an example, a parameter topology for a conference room may comprise a multi-dimensional noise profile having relatively low values at locations away from a conference table and slightly higher values above (e.g., directly above) a conference room table. In an example, for a carbon dioxide sensor, a relevant parameter may correspond to carbon dioxide concentration. In an example, a carbon dioxide sensor may determine that a time window during which fluctuations in carbon dioxide concentration could be minimal corresponds to a two-hour period, e.g., between 5:00 AM and 7:00 AM. Self-calibration may initiate at 5:00 AM and continue while searching for a duration within these two hours during which measurements are stable (e.g., minimally fluctuating). In some embodiments, the duration is sufficiently long to allow separation between signal and noise. In an example, data from a carbon dioxide sensor may facilitate determination that a 5-minute duration (e.g., between 5:25 AM and 5:30 AM) within a time window between 5:00 AM and 7:00 AM forms an optimal time period to collect a lower baseline. The determination can be performed at least in part (e.g., entirely) at the sensor level. The determination can be performed by one or more processors operatively couple to the sensor. During a selected duration, a sensor may collect readings to establish a baseline, which may correspond to a lower threshold. In an example, for gas sensors disposed in a room (e.g., in an office environment), a relevant parameter may correspond to gas (e.g., CO₂) levels, where desired levels are typically in a range of about 1000 ppm or less. In an example, a CO₂ sensor may determine that self-calibration should occur during a time window where CO₂ levels are minimal such as when no occupants are in the vicinity of the sensor. Time windows during which fluctuations in CO₂ levels are minimal, may correspond to, e.g., a one-hour period during lunch from about 12:00 PM to about 1:00, and during closed business hours. FIG. 8 shows a contour map example of a horizontal (e.g., top) view of an office environment depicting various levels of CO₂ concentrations. The office environment may include a first occupant 801, a second occupant 802, a third occupant 803, a fourth occupant 804, a fifth occupant 805, a sixth occupant 806, a seventh occupant 807, an eighth occupant 808, and a ninth occupant 809. The gas (CO₂) concentrations may be measured by sensors placed at various locations in the enclosure (e.g., office). In an example, for an ambient noise sensor disposed in a crowded area such as a cafeteria, a relevant parameter may correspond to sound pressure (e.g., noise) level measured in decibels above background atmospheric pressure. In an example, an ambient noise sensor may determine that self-calibration should occur during a time window while fluctuations in sound pressure level are minimal. A time window while fluctuations in sound pressure are minimal may correspond to a one-hour period from about 12:00 AM to about 1:00 AM. Self-calibration may continue with the sensor determining a duration within a window during which may be made to establish a baseline (e.g., an upper threshold). In an example, an ambient noise sensor may determine that a 10-minute duration (e.g., from about 12:30 AM to about 12:40 AM) within a time window of from about 12:00 AM to about 1:00 AM forms an optimal time to collect an upper baseline, which may correspond to an upper threshold.

At least two sensors of the plurality of sensors may be of a different type (e.g., are configured to measure different properties). Various sensor types can be assembled together (e.g., bundled up) and form a device ensemble. The plurality of sensors may be coupled to one electronic board. The electrical connection of at least two of the plurality of sensors in the sensor suit may be controlled (e.g., manually and/or automatically). For example, the device ensemble may be operatively coupled to, or comprise, a controller (e.g., a microcontroller). The controller may control and on/off connectivity of the sensor to electrical power. The controller can thus control the time (e.g., period) at which the sensor will be operative.

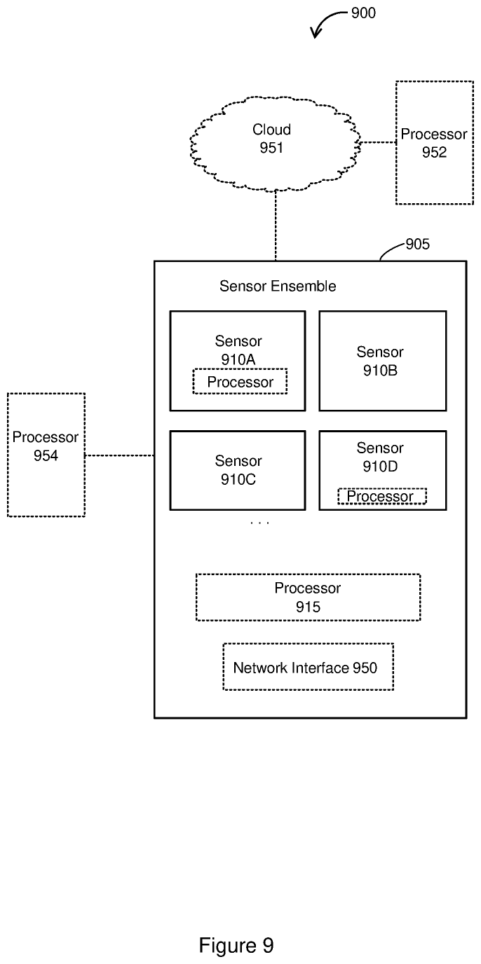

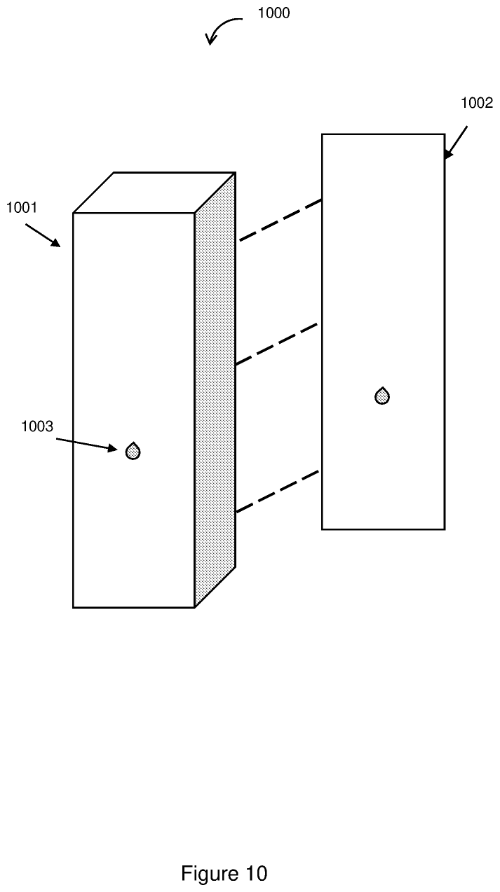

In some embodiments, baseline of one or more sensors of the device ensemble may drift. A recalibration may include one or more (e.g., but not all) sensors of a device ensemble. For example, a collective baseline drift can occur in at least two sensor types in a given device ensemble. A baseline drift in one sensor of the device ensemble may indicate malfunction of the sensor. Baseline drifts measured in a plurality of sensors in the device ensemble, may indicate a change in the environment sensed by the sensors in the device ensemble (e.g., rather than malfunction of these baseline drifted sensors). Such sensor data baseline drifts may be utilized to detect environmental changes. For example (i) that a building was erected/destroyed next to the device ensemble, (ii) that a ventilation channel was altered (e.g., damaged) next to the device ensemble, (iii) that a refrigerator is installed/dismantled next to the device ensemble, (iv) that a working location of a person is altered relative (e.g., and adjacent) to the device ensemble, (v) that an electronic change (e.g., malfunction) is experienced by the device ensemble, (vi) that a structure (e.g., interior wall) has been changed, or (vii) any combination thereof. In this manner, the data can be used e.g., to update a three-dimensional (3D) model of the enclosure. In some embodiments, one or more sensors are added or removed from a community of sensors, e.g., disposed in the enclosure and/or in the device ensemble. Newly added sensors may inform (e.g., beacon) other members of a community of sensor of its presence and relative location within a topology of the community. Examples of sensor community(ies) can be found, for example, in U.S. Provisional Patent Application Ser. No. 62/958,653 that was filed Jan. 8, 2020 titled “SENSOR AUTOLOCATION” that is incorporated by reference herein in its entirety. Sensors of a device ensemble may be organized into a sensor module. A device ensemble may comprise at least one circuit board, such as a printed circuit board, in which a number of devices (e.g., sensors and/or emitters) are adhered or affixed to the at least one circuit board. Devices can be removed from the device ensemble. For example, a sensor may be plugged and/or unplugged from the circuit board. Sensors may be individually activated and/or deactivated (e.g., using a switch). The circuit board may comprise a polymer. The circuit board may be transparent or non-transparent. The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in a mullion (e.g., of a window). The circuit board may be configured (e.g., may be of a shape) to allow the ensemble to be disposed in a frame (e.g., door frame and/or window frame). The mullion, transom, and/or frame may comprise one or more holes to allow the sensor(s) to obtain (e.g., accurate) readings. The sensor ensemble may comprise a housing. The housing may comprise one or more holes to facilitate sensor readings. The circuit board may include an electrical connectivity port (e.g., socket). The circuit board may be connected to a power source (e.g., to electricity). The power source may comprise renewable or non-renewable power source. FIG. 9 shows an example of a system 900 including an ensemble of sensors organized into a sensor module. Sensors 910A, 910B, 910C, and 910D are shown as included in a device ensemble 905. The device ensembles (including the device ensemble 905) that are organized into a sensor module may include at least 1, 2, 4, 5, 8, 10, 20, 50, or 500 sensors. The sensor module may include a number of sensors in a range between any of the aforementioned values (e.g., from about 1 to about 1000, from about 1 to about 500, or from about 500 to about 1000). Sensors of a sensor module may comprise sensors configured or designed for sensing a parameter comprising, temperature, humidity, carbon dioxide, particulate matter (e.g., between 2.5 μm and 10 μm), total volatile organic compounds (e.g., via a change in a voltage potential brought about by surface adsorption of volatile organic compound), ambient light, audio noise level, pressure (e.g., gas, and/or liquid), acceleration, time, radar, lidar, radio signals (e.g., ultra-wideband radio signals), passive infrared, glass breakage, or movement detectors. The device ensemble (e.g., 905) may comprise non-sensor devices, such as buzzers and light emitting diodes. Examples of device ensembles and their uses can be found in U.S. patent application Ser. No. 16/447,169 filed Jun. 20, 2019, titled “SENSING AND COMMUNICATIONS UNIT FOR OPTICALLY SWITCHABLE WINDOW SYSTEMS,” that is incorporated herein by reference in its entirety. In some embodiments, an increase in the number and/or types of sensors may be used to increase a probability that one or more measured property is accurate and/or that a particular event measured by one or more sensor has occurred. In some embodiments, sensors of device ensemble and/or of different device ensembles may cooperate with one another. In an example, a radar sensor of device ensemble may determine presence of a number of individuals in an enclosure. A processor (e.g., processor 915) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 950) may communicate with other device ensembles similar to device ensemble. The network interface may additionally communicate with a controller. Individual sensors (e.g., sensor 910A, sensor 910D, etc.) of a device ensemble may comprise and/or utilize at least one dedicated processor. A device ensemble may utilize a remote processor (e.g., 954) utilizing a wireless and/or wired communications link. A device ensemble may utilize at least one processor (e.g., processor 952), which may comprise a cloud-based processor coupled to a device ensemble via the cloud (e.g., 951). Processors (e.g., 952 and/or 954) may be located in the same building, in a different building, in a building owned by the same or different entity, a facility owned by the manufacturer of the window/controller/device ensemble, or at any other location. In various embodiments, as indicated by the dotted lines of FIG. 9, device ensemble 905 is not required to comprise a separate processor and network interface. These entities may be separate entities and may be operatively coupled to ensemble 905. The dotted lines in FIG. 9 designate optional features. In some embodiments, onboard processing and/or memory of one or more ensemble of sensors may be used to support other functions (e.g., via allocation of ensembles(s) memory and/or processing power to the network infrastructure of a building). In some embodiments, a plurality of sensors of the same type may be distributed in an enclosure. At least one of the plurality of sensors of the same type, may be part of an ensemble. For example, at least two of the plurality of sensors of the same type, may be part of at least two ensembles. The device ensembles may be distributed in an enclosure. An enclosure may comprise a conference room. For example, a plurality of sensors of the same type may measure an environmental parameter in the conference room. Responsive to measurement of the environmental parameter of an enclosure, a parameter topology of the enclosure may be generated. A parameter topology may be generated utilizing output signals from any type of sensor of device ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, and/or elevators. FIG. 10 shows an example of a device ensemble (e.g., an assembly) 1000 having a protective housing 1001. The housing may include mounting features that enable it to be captured in a wall-mount adapter, a window frame portion section (e.g., mullion), or a ceiling-mount adapter. The housing may expose its front face (e.g., only) to a viewer in the enclosure, as its body may be disposed within a wall mounting, ceiling mounting, or frame portion, e.g., as shown in the example of 1002. The front face may be a (e.g., reversibly openable and closeable) cover of the hosing. The housing 1001 may comprise one or more features desirable for optimal performance of modules in corresponding locations, such as one or more opening for admitting external environmental characteristic(s) into the housing to facilitate their sensing by the sensor(s). For example, the housing may comprise one or more openings (e.g., holes 1003) that facilitate air to contact temperature, humidity, pressure, and dust sensors. The opening may have any shape. The opening may comprise a straight line or a curvature. A plurality of openings may form a (e.g., natural or abstract) shape such as petals of a flower. The external housing cover may comprise smooth and/or rough portions. The rough portions may visually mask the hole(s). The external cover may have at least a portion that comprises a rough texture, e.g., that comprises a screen, cloth, embossing, scribing, or indentations. Other examples of housing features include speaker or microphone grilles and an aperture for a camera lens, motion sensor, or an ambient light sensor. The one or more openings may be exposed in the front of the housing that faces an occupant of the enclosure. The housing may be masked by a textured area surrounding and/or engulfing the openings. The textured area may be patterned or irregular. The pattern may comprise any geometric shape such as space filling polygons (e.g., squares, rectangles, hexagons, or triangles). The pattern may be devoid of space filling polygons. The space filling polygons may be of a single type or of a plurality of types (e.g., at least 2 or 3 types). The textured pattern may comprise a curved line, or a straight line. The textured pattern may be devoid of a curved line or a straight line. The textured pattern may be a mesh. The textured pattern may be formed by the same, or by a different material than the rest of the hosing. For example, the housing may be formed of plastic, and the textured area may be a mesh and/or cloth at least partially covering the openings portion of the housing. The textured pattern may comprise a shape that resembles the opening. The opening may resemble flower petals or leaves. The textured pattern may cover at least an eight, a fifth, a fourth, a third, or a half of a front portion of the housing, which front portion faces an occupant. The housing may be attached to a fixture such as wall and/or ceiling, directly, using a frame, and/or by a post or mast. In some embodiments, the housing encloses at least one circuit board. The circuit board can be configured to accommodate (or accommodate) one or more devices. The devices can be reversibly integrated into the circuit board. For example, at least one device can be inserted or extracted from the circuit board (e.g., for maintenance, repair, exchange, or removal). The board may have one side on which the circuitry and/or devices are disposed. The one side may face the front of the housing. The front of the housing may face an occupant in the enclosure in which the housing is disposed. The one side may face the back of the housing. The back of the housing may face away from an occupant in the enclosure in which the housing is disposed. The board may have two sides onto which the circuitry and/or devices are disposed. The board may have one or more holes. The holes may facilitate passing of at least one environmental characteristic. The holes may facilitate passing of gas, sound, or electromagnetic radiation. For example, a sensor may be disposed at a back of the circuit board and sense an environmental quality that reaches the sensor from the enclosure, through the one or more holes. The board may have first device(s) disposed on a first side, and circuitry disposed on a second side. The board may have first device(s) disposed on a first side, and second device(s) disposed on a second side. The board may include one or more heat sinks. The heat sink(s) may be disposed at locations that are prone to heat generation and/or accumulation. The board may be operatively coupled and/or include partition(s). The partition(s) may be utilized to reduce unwanted consequences (e.g., interference) of device coexistence in the housing and/or on the board. The housing may comprise one or more circuit boards. The circuit boards are communicatively coupled with each other (e.g., directly or indirectly). The circuit boards may be operatively (e.g., communicatively) coupled to each other by wiring and/or wireless. The circuit boards may be operatively (e.g., communicatively) coupled to the network wiring and/or wireless. The housing may comprise an elemental metal, metal alloy, polymer, resin, glass, or sapphire. The housing may corners transparent or non-transparent portions. Transparent may be to any electromagnetic radiation range disclosed herein (e.g., UV, IR, and/or visible radiation).

In some embodiments, measurements of sensors (e.g., temperature and/or humidity sensors in sensor ensembles) deployed at locations across an enclosure (e.g., spread out over a floor of a building) are used to compute spatially distributed air and/or mean radiant temperatures (MRT) in various (e.g., occupant) environments. In some embodiments, the computed temperatures are used by a control system to promote thermal comfort of occupants and/or to establish conformance to (e.g., compliance with) industry and/or jurisdictional guidelines on indoor thermal conditions. Surface temperature readings that factor into the determination of MRT may be of particular importance to the objective of minimizing virulence of pathogens, whose viability in fomites may be affected by temperature, gas (e.g., air) circulation, and/or humidity.

In some embodiments, a map of thermal comfort is assembled in order to (1) enable a facility occupant (e.g., resident or employee) and/or a facility manager, to evaluate thermal performance at various location(s) of the facility, and/or (2) adjust facility (e.g., building) parameters (e.g., HVAC settings and/or window tint levels) to achieve a target thermal comfort level. A requested process (e.g., a data pipeline) based at least in part on temperature measurements can be performed partially or entirely automatically using a controller network, e.g., as described herein. The requested process may include generation and/or utilization of a spatial map of thermal comfort. The requested process may be an ordered process. The requested process may comprise a predetermined process. To obtain meaningful accuracy, data used to estimate thermal comfort may be calibrated and/or corrected, e.g., for spurious influences. To avoid systematic errors in measurements, the calibration of temperature sensors may be conducted both at or before initial installation and again throughout the lifetime of the sensors. The initial calibration may be conducted according to a standard (laboratory) reference. Additional calibration may be based on in-use performance and/or on comparisons among the data from other sensors to identify any sensor giving contradictory data. The sensors may be calibrated using ground truth value. The sensors may be calibrated in the site at which they are installed and/or in a factory. The sensors may be self-calibrating. Examples of sensor calibration, device (e.g., sensor) ensembles, control system, and associated network, can be found in International Patent Application Serial No. PCT/US21/15378, filed Jan. 28, 2021, titled “Sensor Calibration and Operation,” which is incorporated herein by reference in its entirety.

In some embodiments, raw temperature data (e.g., direct and/or unprocessed temperature measurements) may be obtained from sensors (e.g., calibrated sensors) which are located in an enclosure. The sensors may be attached to, or installed in, various fixtures (e.g., walls or windows) of the enclosure. In some embodiments, a device ensemble comprising a temperature sensor. The device ensemble may be disposed in a floor, ceiling, wall, or any other enclosure fixture. For example, the device ensemble may be disposed within a framing portion (e.g., mullion or transom) of a window or of a door. For example, a floor of a building may have a plurality of device ensembles mounted in fixtures (e.g., pillars) in an interior of the floor. For example, a floor of a building may have a plurality of device ensembles mounted in fixtures (e.g., window framing portions) around a perimeter of the floor. As a result of the enclosed mounting of the device ensembles at a perimeter of the floor, the raw (calibrated) temperature measurements may differ from an actual temperature of the atmosphere (e.g., air) of the enclosure's interior, e.g., also in close proximity to the window framing portion in which the device ensemble is installed, e.g., due to various environmental factors. The device ensemble may comprise one or more sensors. These factors may cause a bias in the collected temperature measurements from sensors disposed in an envelope of the structure, which may be corrected using a bias correction methodology. For example, a sensor may be disposed in a temperature conducting (e.g., metallic) window mullion disposed in a southern facing, or partially southern facing (e.g., south-east or south-west facing) wall. During the day, the sun shines on the mullion, thus heating it up. The sensor disposed in, or attached to, that south facing mullion is experiencing heat greater than the heat of the interior of the room in which the mullion in disposed. In such a case, that sensor measures a temperature that is biased towards high temperature measurements at least in part due to the heating of the mullion by the sun. For example, a sensor may be disposed in a temperature conducting (e.g., metallic) window transom disposed in a northern facing wall. During the winter, snow may accumulate on the transom, thus cooling it down. The sensor disposed in, or attached to, that northern facing transom is experiencing heat lower than the heat of the interior of the room in which the transom in disposed. In such a case, that sensor measures a temperature that is biased towards lower temperature measurements at least in part due to the cooling of the transom by the snow. In order to utilize measurements of sensors disposed in an outer envelope of a facility that is exposed to ambient external conditions, for estimating interior temperatures of the facility, a temperature bias correction may be beneficial. The bias correction (e.g., environmental correction) may provide an estimated adjacent environmental (e.g., air) temperature based at least in part on influences associated with the relative spatial position of the sensor mounting in the enclosure (e.g., in a window mullion). The bias-corrected temperatures may be extrapolated across a spatial grid to estimate respective environmental (e.g., air) temperatures at points of a grid spanning the area(s) of interest (e.g., the occupied areas of a floor of a building). Thermal comfort metrics can be derived from the extrapolated atmospheric (e.g., air) temperatures.

In some embodiments, the temperature bias caused by one or more environmental characteristics may be quantified in one or more manners. This may include, for example, a temperature gradient, such as gradient within a particular range and/or rate, a change in thermal value above or below a particular magnitude, or both. For example, a temperature sensor that is biased due to direct solar radiation heating a mullion in which that temperature sensor is positioned may detect and measure temperature changes that have a faster rate of increase and/or higher magnitude than other temperature sensors that are not subject to the bias caused by the direct solar radiation. In one example, a first temperature sensor in a south facing mullion may be subject to temperature bias due to the direct solar radiation on the mullion in which it is placed, while concurrently, a second temperature sensor in a north facing mullion may not receive that same direct solar radiation and temperature bias. The bias of this first temperature sensor may detect temperatures that have higher magnitudes and/or higher rates of increase than the second temperature sensor.

In some instances, bias of the temperature sensors may be quantified by a temperature gradient of the temperature sensor's measurements. This gradient may be expressed as, for example, a gradient of at least about 5° C. per hour, about 10° C. per hour, or about 15° C. per hour. In some additional or alternative instances, bias of the temperature sensors may be quantified by a difference in temperature of one temperature sensor and at least one other temperature sensor. The difference may be, for example, at least about 3° C., about 5° C., about 8° C., about 10° C., about 15° C., or about 20° C. The one or more temperature sensors to which one temperature sensor may be compared for determining a bias may be selected in various manners, such as using one or more temperature sensors in a different mullion on the same façade, on the same side of the enclosure as the one temperature sensor, in an adjacent or proximate structure (such as an adjacent mullion), in a different façade, in a different side of the enclosure, historical data, or a combination thereof.

Some embodiments may include detecting, determining, and/or receiving information that one or more temperatures are being subjected to, or affected by, a temperature bias from one or more environmental characteristics. This may include information identifying that one or more temperature sensors are historically prone to temperature bias. The detecting, determining, information, or a combination thereof may be based on data, such as the data associated with environmental characteristics described herein, such as weather conditions around the enclosure, an outside atmospheric (air) temperature, solar angle (e.g., with respect to the ground and/or floor of the facility), solar elevation (e.g., with respect to the ground), difference between solar azimuth and window azimuth, solar intensity, solar radiation wavelengths, solar penetration depth into the facility (e.g., from a window), tint states of the tintable windows, sensor orientation, framing portion (e.g., mullion) properties (e.g., heat conductance), external surface properties (e.g., absorbane), proximity to HVAC, proximity to diffuser, and/or insulation properties, façade-level oriented (e.g., photo, electromagnetic, and/or optical) sensor readings, skyward (e.g., photo, electromagnetic, and/or optical such as visible, UV, and/or IR) sensor readings, cloud cover, humidity, quality index readings, compass position of the temperature sensor, facing direction of the temperature sensor, other positioning information of the temperature sensor, or a combination thereof. In some such embodiments, the application of the bias-correction models may be based at least in part on a detection, determination, and/or information that the temperature sensor is subject to a temperature bias.

In some embodiments, the detecting, determining, and/or receiving information may include monitoring one or more temperature sensors and determining from at least the temperature data produced by the one or more temperature sensors are being subjected to temperature bias. For example, a determination or detection may be made that temperature measurements from one temperature are changing at a rate, and/or are of a magnitude, indicative of temperature biasing. In some embodiments, the determination, detection, and/or information may be based on data, such as the data provided above, such as data associated with environmental characteristics described herein, such as weather conditions around the enclosure, an outside atmospheric (air) temperature, solar angle (e.g., with respect to the ground and/or floor of the facility), solar elevation (e.g., with respect to the ground), difference between solar azimuth and window azimuth, solar intensity, solar radiation wavelengths, solar penetration depth into the facility (e.g., from a window), tint states of the tintable windows, sensor orientation, framing portion (e.g., mullion) properties (e.g., heat conductance), external surface properties (e.g., absorbane), proximity to HVAC, proximity to diffuser, and/or insulation properties, façade-level oriented (e.g., photo, electromagnetic, and/or optical) sensor readings, skyward (e.g., photo, electromagnetic, and/or optical such as visible, UV, and/or IR) sensor readings, cloud cover, humidity, quality index readings, compass position of the temperature sensor, facing direction of the temperature sensor, other positioning information of the temperature sensor, or a combination thereof.

In some additional or alternative embodiments, the temperature sensors that are subject to a bias may be based on the location of the temperature sensor, such as those that are placed in particular physical structures, e.g., mullions or door frames, and/or locations in an enclosure, such as the outer perimeter of the enclosure and/or the compass direction where the temperature sensor is positioned or facing. For instance, temperature sensors placed in the periphery of an enclosure may be subjected to temperature bias. In another example, temperature sensors placed in particular structures, such as mullions or door frames may also be subject to temperature bias. In one example, a temperature sensor within a particular distance from HVAC port, such as a vent, may be subject to a temperature bias. Based on this information, e.g., the location of the temperature sensor, the bias-correction models may be applied to that temperature sensor.

In some embodiments, bias correction and spatial extrapolation are each based at least in part on machine learning (ML) processes. For example, machine learning algorithms and/or multilayer neural networks (such as deep learning algorithms) may be used for predictive outcomes. For example, for predicting adjacent air temperature from mullion-mounted sensors and environmental conditions. For example, predicting interior room temperatures from (machine) learned characteristics of heat flow. Deep learning algorithms may include an unbounded number of layers of bounded size, to progressively extract higher-level features from the raw (e.g., sensor) inputs. The layers may be hierarchical such that each layer's output is a higher-level abstraction of inputs from previous layers. A heuristic technique (e.g., gross model & sensor data) may be used, which could speed the output of a reliable prediction. To obtain optimization (e.g., in terms of accuracy and/or computations speed), factors to consider may include neural network size (e.g., number of layers and number of units per layer), learning rate, and/or initial weights (e.g., of artificial neurons and/or algorithms (e.g., when several algorithms are utilized to generate the result)). Machine learning (ML) challenges may include overfitting, which can be addressed by applying user regularization methods for rare instances (e.g., adding synthetic information to solve a well-posed problem and/or to prevent overfitting). The synthetic information may be generating by adding various noise schemes to a signal. In the event attempts to perform machine learning become impractical, the computation time may be reduced, e.g., by decreasing architectural and/or model complexity.

In some embodiments, an aim of ML is to learn from experience E with respect to task(s) T and a performance measure P. The ML algorithm may adjust performance of tasks T such that performance measured by P improves with experience E. For example, experience E may be comprised of temperature comfort, tasks T may be comprised of temperature adjustment, and performance measure P may be comprised of sensed temperature.

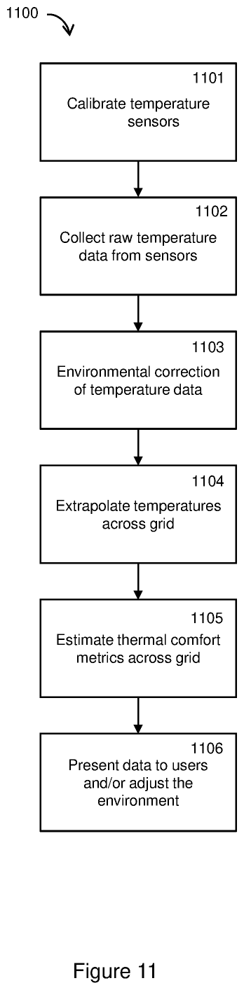

Once machine learning is performed to characterize a given arrangement of an enclosure and the devices in it, derivation and use of thermal comfort may proceed, e.g., as shown in the example of FIG. 11. An (e.g., on-going) operation 1101 may be performed in which temperature sensors deployed at respective locations in an enclosure are calibrated. Calibration may include exposing a particular sensor and a high-accuracy reference sensor in close proximity to a common temperature, and obtaining a correction factor in accordance with any difference between the resulting temperature measurements. Calibration may include in-service comparisons of sensor readings from groups of sensors to identify any sensors that may drift or experience a fault so that readings from those sensors can be re-calibrated. Examples of sensor calibration can be found in International Patent Application Serial No. PCT/US21/15378, which is incorporated herein by reference in its entirety. In operation 1102, raw temperature measurement data is collected from sensors (e.g., from a plurality of device ensembles, each mounted in a respective window mullion along the perimeter of a floor of a building, and each having at least one temperature sensor). Using a trained model (e.g., comprising machine learning model), an environmental correction is applied to the raw (e.g., and calibrated) temperature measurement data in operation 1103. Operation 1103 includes quantifying one or more environmental characteristics which bias the temperature measurements with respect to the interior environmental temperatures of volumes of atmosphere (e.g., air) adjacent the sensor locations. The raw temperature measurements are input to the trained model along with the quantified environmental characteristics for generating corrected temperature measurements. The quantified environmental characteristics are utilized as correction factors. In an operation 1104, the corrected temperature measurements are extrapolated according to a plurality of grid points, which are laid out over an area of interest on the floor of the building. The extrapolation utilizes a corresponding model from machine learning, and/or may be comprised of other numerical analysis such as applying computational fluid dynamics. The grid points may be arranged between, or at, locations of the temperature sensors. The grid may be any grid disclosed herein (e.g., 2D or 3D grid). The grid may extend two-dimensionally to span an interior space where the thermal comfort of occupants is to be quantified/controlled. Extrapolated temperatures are utilized in an operation 1105 to estimate thermal comfort metrics at the grid points and/or at other locations within the occupied space in the form of a mapping. The thermal comfort (e.g., an operative temperature) may be characterized using extrapolated atmospheric (e.g., air) temperatures, e.g., with other measured and/or calculated variables such as mean radiant temperature, air speed, relative humidity, clothing worn by occupants, and/or metabolic rates of occupants. In operation 1106, the thermal comfort mapping is utilized (i) to inform users of the thermal comfort (e.g., for monitoring purposes and/or to assist in finding a comfortable location) and/or (ii) to control (e.g., adjust) the environment, e.g., using a control system. For example, a climate control element may be controlled. For example, the data may be utilized to make changes to a setpoint temperature, blower speed of an HVAC unit, and/or to a tint level of a tintable window.

In some embodiments, the temperature sensors providing temperature data for quantifying the atmospheric (e.g., air) temperatures and/or radiant temperatures within an occupied space of an enclosure, include temperature sensors mounted to, or disposed in, a fixture. The fixture may include a window framing (e.g., window mullion), a device housing, a cover of a device ensemble, or other trim piece. The fixture may separate the temperature sensor from directly contacting the nearby volume of air for which an accurate temperature measurement is requested. Thus, thermal characteristics associated with the fixture may bias (e.g., alter) the detected temperature from the actual temperature of the interior air. For example, the constituent materials and layout of a mullion, the paint color of fixture surfaces, thermal conductivity, and atmospheric (e.g., air) exchange properties may result in a predictable bias in the temperature measurements. Additional environmental characteristics may be present which represent heat source(s) and/or heat sink(s), e.g., that bias the measured temperatures. Environmental characteristics may include orientation of the outer face of a sensor (e.g., cardinal direction, height, pointing toward another wall or window), exposure to sunlight, exposure to environmental water form (e.g., rain, hail, and/or snow), HVAC setpoints, humidity, ventilation speed, and/or proximity to HVAC air diffusers. For example, daytime exposure to solar radiation may overheat a window mullion casing in which a temperature sensor is located, thereby biasing the results. Examples of temperature conditioning, control system, network, sensors, and device ensembles can be found in Provisional Patent Application Ser. No. 63/170,245 filed Apr. 2, 2021, titled “DISPLAY CONSTRUCT FOR MEDIA PROJECTION AND WIRELESS CHARGING,” and in Provisional Patent Application Ser. No. 63/079,851, filed Sep. 17, 2020, titled “DEVICE ENSEMBLES AND COEXISTENCE MANAGEMENT OF DEVICES,” each of which is incorporated herein by reference in its entirety.

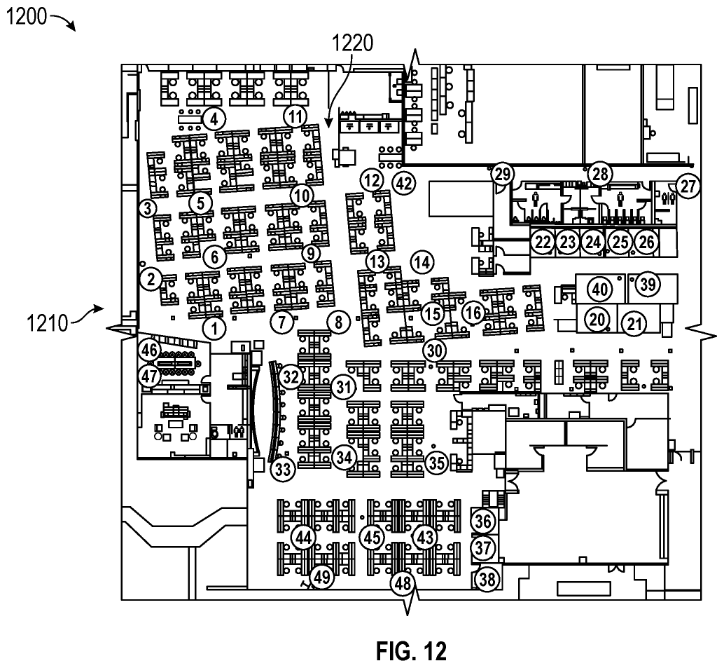

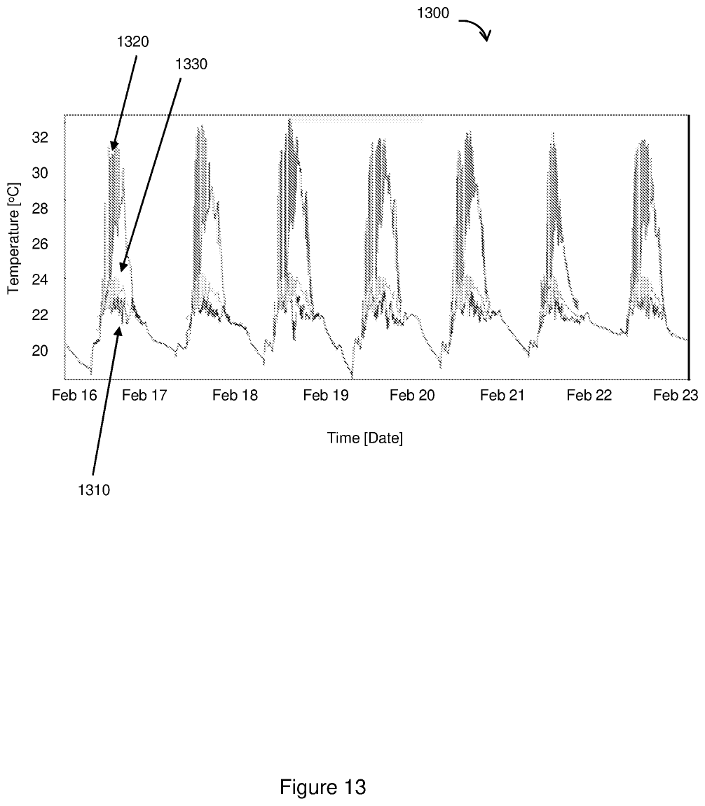

FIG. 12 shows an example of a floorplan 1200 with an outer wall having façade 1210 and an interior occupied space 1220. Temperature sensor locations are shown by numbered circles 1-49. Temperature sensors 2 and 3 are mounted in window framing (e.g., in respective device ensembles or not) which may be impacted by environmental characteristics which predictably bias their measured temperatures. FIG. 13 shows example temperature data 1300 collected for a location of a mullion-mounted sensor demonstrating biasing related to solar radiation. Peaks in the data reflect a daily cycle of sunlight. A lowest trace 1310 corresponds to a “ground truth” temperature measurement from a high accuracy reference sensor exposed directly to the volume of air adjacent to mullion location. Due to the thermal bias, a highest trace 1320 corresponds to the temperature readings generated by the mullion-mounted sensor (which may be about 8° C. higher than the ground truth temperature). Using machine learning and/or models based at least in part on environmental factors that estimate difference between air temperature at the sensor and the actual interior air temperature close to the sensor, an improved (bias-corrected) temperature can be obtained as show by a middle trace 1330.

In some embodiments, artificial intelligence (e.g., including machine learning (ML)) is used for bias correction at the individual sensor level based at least in part on the spatial characteristics of the sensor (e.g., (i) is it in direct sunlight, (ii) is it near a HVAC diffuser, and/or (iii) what is its orientation, surrounding materials, and/or color). Bias correction using a (e.g., machine learning) model as a correction factor, may be applied to temperature sensor measurements. The application of the model to the sensor measurements may be done repeatedly, e.g., at regular or irregular intervals. For example, the application of the model to the raw measurements may be once every minute, once every second, or at smaller intervals. The application of the model to the sensor measurements may be done at times when bias is estimated and/or predicted. For example, during times when sun irradiation is intense. For example, based on detected, actual, or predicted weather conditions, such as during snow fall. The weather conditions may be detected by one or more sensors or obtained from external publicly available sources, such as weather feed data from external websites. For example, at a time sufficient for the control system to prepare the facility for occupation (e.g., before the start of a business day, or before a planned event). The application of the model may utilize a schedule and/or timetable of the facility. For example, at times when a building system, such as an HVAC system, is operating. The resulting bias correction may gain (e.g., significant) improvements in sensor accuracy and precision, e.g., as compared to traditional calibration approaches. Mean radiant temperature (MRT) may be estimated, e.g., using machine learning algorithms that factor in the sensor position and/or metadata (e.g., what type of housing is it in (e.g., mullion, wall mount, ceiling mount), what its orientation is, whether it is in direct sunlight, and whether the housing is thermally mitigated, decoupled, or not). In some embodiments, empirical data is collected with standardized sensor installation configurations across a range of the one or more environmental characteristics. For example, representative installations using distinct variations of sensor mounting designs, materials, and placements (e.g., representative framing portion modules at various orientations relative to solar movements) may be deployed and characterized. The characterization may be made by collecting target sensor measurements, ground truth temperature measurements, and/or data characterizing the associated environmental characteristics. Test data collection may use off the shelf sensors (e.g., Awair or Hobo room temperature readings) to provide the ground truth approximation and/or global temperature readings (e.g., mean radiant temperature approximation).

Machine learning using the collected data may generate correction factors. The correction factors may be derived at least in part by a machine learning module (e.g., software) that associates bias among (i) temperature measurements in the empirical data from sensors in the standardized sensor installation configurations and (ii) auxiliary temperature measurements of volumes of air at or adjacent to the standardized sensor installation configurations across the range of the one or more environmental characteristics. The one or more environmental characteristics may include an outside atmospheric (air) temperature, solar angle (e.g., with respect to the ground and/or floor of the facility), solar elevation (e.g., with respect to the ground), difference between solar azimuth and window azimuth, solar intensity, solar radiation wavelengths, solar penetration depth into the facility (e.g., from a window), tint states of the tintable windows, sensor orientation, framing portion (e.g., mullion) properties (e.g., heat conductance), external surface properties (e.g., absorbane), proximity to HVAC, proximity to diffuser, and/or insulation properties. The external surface may comprise paint, or another coating. The coating may be opaque. The coating may be transparent (e.g., to visible light). Data, such as environmental data, collection may utilize façade-level oriented (e.g., photo, electromagnetic, and/or optical) sensor readings, skyward (e.g., photo, electromagnetic, and/or optical such as visible, UV, and/or IR) sensor readings, cloud cover, humidity, and/or air quality index readings (e.g., obtained with the BreezoMeter API available from BreezoMeter Ltd. of Haifa, Israel). Based at least in part on the correction factors (e.g., model), a Bias Reduction Factor (RMSE) may be obtained. The BMSE may be of from about a factor of 3.0 times to about a factor of 3.5 times.

In some embodiments, data pre-processing is performed (e.g., prior to machine learning) based at least in part on the collected data. Pre-processing may include façade-level mean imputation of missing values. Pre-processing may include standardized feature scaling. In some embodiments, machine learning is performed using linear-kernel support vector regression. A resulting model can be deployed in a control system for a facility having corresponding temperature sensor installations and implementing thermal (e.g., comfort) monitoring and/or adjustment. Over time, later facility installations may be used as test beds (e.g., used as a training set) to provide additional inputs (e.g., data collection) for model improvement.

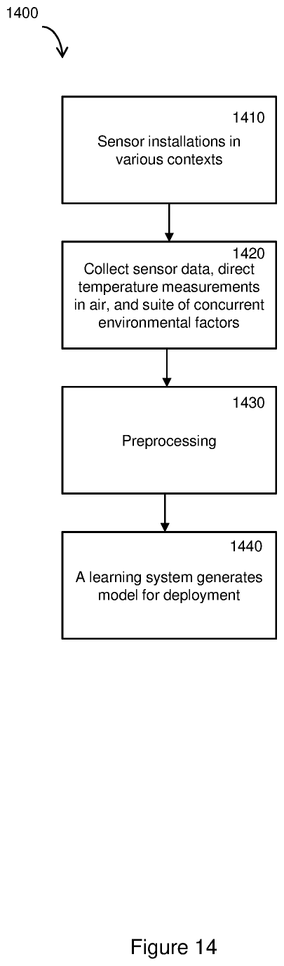

FIG. 14 shows an example flowchart of operations employed for bias correction of temperature measurements. In operation 1410, an available suite of sensor types (e.g., a variety of predetermined temperature sensor elements) are incorporated into various contexts (e.g., different physical orientations toward or away from a cardinal direction, different levels of exposure to open sky, different levels of exposure to areas of direct sunlight, and/or different surrounding materials). For example, a manufacturer or service provider involved with construction of temperature control (e.g., monitoring) systems for several facilities (e.g., several buildings) may build up a database of installation contexts which broadens over time. In operation 1420, temperature sensor data is collected along with (i) (e.g., reference) temperature measurements of volumes of interior atmosphere near the target sensors and (ii) one or more environmental factors. The one or more environmental factors can be identified (e.g., in advance) as being useful in correcting for environmental bias. The one or more environmental factors may be collected concurrently (e.g., in real time) during the sensor measurements. The temperature measurements and environmental factor(s) can be stored (e.g., as respectively linked data), in a databased. The collected data is processed in an operation 1430 and then applied to learning system in operation 1440, to generate a model for deployment in subsequent installations to avoid the need for continuous real-time testing at the subsequent installations. The learning system may comprise artificial intelligence incorporated in machine learning, e.g., as disclosed herein.

In some embodiments, a spatial modeling of thermal parameters in an occupied space in a facility depends upon the space being discretized into smaller parts. A control system may be provided with the locations of measuring devices (e.g., sensors) and dimensions of the discretized space (e.g., spatial grid of points on a floorplan). The grid may be any grid disclosed herein. Thermal modeling for bias correction and for extrapolating atmospheric temperatures at grid points, may utilize additional environmental characteristics. The additional environmental characteristics may comprise HVAC setpoint (e.g., flat floor/space level reading, diurnal/seasonal schedules), sensor ensemble heat transfer parameters, thermal properties of sensor mounting fixtures, sunload, location of vents, airflow speed, air pressure, humidity, or other factors affecting temperature of the environment. For example, sun-load data may include penetration depth of direct sunlight (solar azimuth and elevation, geographic coordinates of the facility and orientation of its façades, window azimuth, elevation (e.g., of the window and/or of the facility, size and/or placement of facility overhangs) and intensity of sunlight (e.g., including a tint state of a tintable window). Thermal modeling for bias correction may be based at least in part on environmental factor(s), e.g., to translate measured temperature within a sensor mounting location to verified atmospheric (e.g., air) temperature nearest the sensor mounting location. The thermal properties (e.g., of sensor mounting fixture) may consider window framing heat transmittance, measure of the heat transmission through a facility part (such as a wall or a window), a given thickness of a material (such as insulation, window, wall, framing portion, and/or sensor housing). The thermal properties may be indicated as U-values (with lower numbers indicating better insulating properties).

In some embodiments, a grid of points spanning an occupiable space on a floorplan is defined in reference to locations along an outer perimeter wall (e.g., comprising a façade) of a building, along which temperature sensors are mounted (e.g., device ensembles mounted in window mullions). For example, lines extending from specified points of measurement are defined which may be generally perpendicular to the outer wall. The measurement lines (e.g., grid lines) may mark a direction along which temperatures are calculated for spaced points of interest, e.g., as disclosed herein. The lines may or may not be aligned with devices at the mullions and may extend perpendicularly with respect to the outer wall(s) (e.g., transverse to a façade). In a building with adjacent walls containing temperature sensors, when the walls are orthogonal then such lines extending from the temperature sensors along both walls may provide a two-dimensional orthogonal grid. Non-orthogonal façades may be used to generate an orthogonal grid, e.g., by extending the measuring lines non-orthogonally, or a non-orthogonal grid can be used. For an occupied space having temperature sensors mounted along one wall, a plurality of grid lines orthogonal to the measurement grid lines from the first façade may be defined, e.g., according to a minimal interval of measurement (e.g., 1 meter apart), and/or taking into account the coverage range of the sensor. The grid spacing may be finer than a spacing that is used by heat transfer projection. In some embodiments, heat transfer based projection uses grid lines defined by the distance between devices. In some embodiments, one set of parallel grid lines extent orthogonally from device ensembles installed in window mullions along one wall, and a second set of parallel grid lines are placed orthogonally to the façade at an interval equal to the distance separating the devices (e.g., incorporated in framing portions such as mullions). Intersecting points of the grid lines may become grid points for estimated temperature measurement. Interpolation (e.g., cubic interpolation) may be performed to estimate grid point temperatures using temperature readings from nearby devices along their projected lines of measurement. Generating of the grid lines may be based at least in part on coordinates of devices obtained from a Building Information Modeling (BIM) file (e.g., a Revit file, AutoCAD file, json file, or Spaces API).

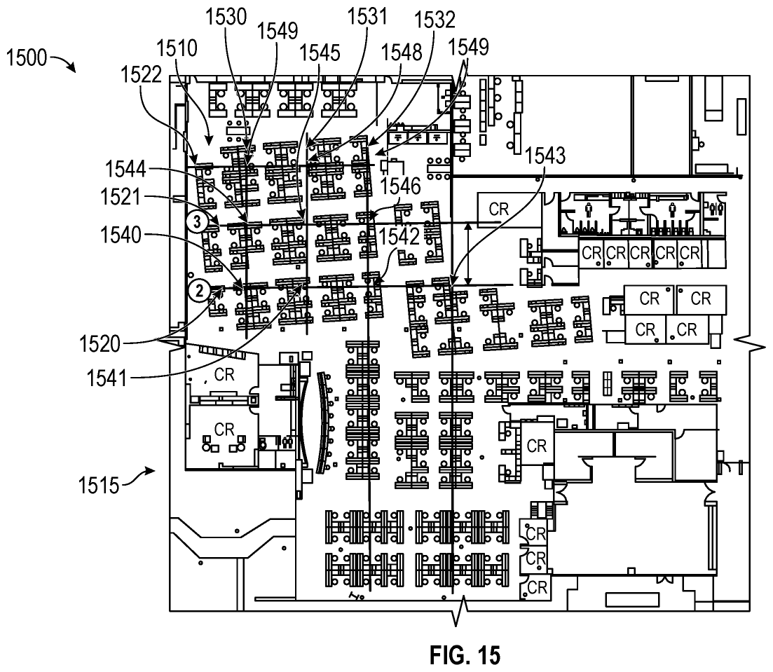

FIG. 15 shows an example of a floorplan 1500 onto which a grid 1510 has been superimposed. A horizontal grid line 1520 extends from the location of a device ensemble number 2 that is encircled 2, which horizontal grid 1520 is orthogonal with respect to an outer wall 1515. A horizontal grid line 1521 extends from the location of a device ensemble number 3 that is encircled 33, which horizontal grid 1521 is orthogonal with respect to the outer wall 1515. Additional horizontal grid lines such as a grid line 1522 extend orthogonally from wall 1515 at a predetermined spacing and with a sufficient number to span a requested region of an occupied area of floorplan 1500. Orthogonally to grid (e.g., measurement) lines 1520, 1521, and 1522 are a plurality of vertical grid lines such as grid lines 1530, 1531, and 1532. The crossing points of the grid lines determine a plurality of grid points including grid points 1540-1549 which coincide with corresponding occupiable positions on floorplan 1500 where, or adjacent to where, a person for whom the thermal comfort is being monitored may be located (e.g., see seating arrangement indicated in floorplan 1500).

In some embodiments, bias-corrected temperature measurements are extrapolated across the occupiable space according to the plurality of grid points based at least in part on an estimate of heat transfer in the enclosure, in order to generate grid point temperatures (e.g., temperature estimates at grid points). In some embodiments, one or more heat transfer methods are utilized to project estimated atmospheric (e.g., air) temperature values near the temperature sensors (e.g., bias-corrected values) across (e.g., arbitrary) grid locations. For example, grid point temperatures may be estimated using calculations which assume a certain temperature gradient across the enclosure (e.g., room). In some embodiments, temperature gradients are calculated based at least in part on a time-based heat transfer model, which assumes heat transfer by conduction (e.g., devoid of convective motion). In some embodiments, temperature gradients are calculated according to a convection-based model of heat transfer. In some embodiments, temperature gradients are calculated according to a radiation-based model of heat transfer. Calculations may be based on any combination of conductive, convective, and radiative models.

In some embodiments, heat transfer models are based at least in part on empirically measured rates of heat transfer measured in representative (e.g., typical) enclosures of a matching type, and/or measured for the specific enclosure where a system is being deployed. A rate of conductive heat transfer can be calculated using temperature measurements for two locations (e.g., sensor location and a grid point), a cross-sectional area through which the heat conducts, and the distance between the points. A rate of heat transfer by convection can be calculated based on estimates of the mass of transferred air, the specific heat of air, and the difference in temperature between two surfaces exchanging the air. The rate of heat transfer by emitted radiation can be determined using the Stefan-Boltzmann law of radiation.

In some embodiments, heat transfer is estimated using computational fluid dynamics (CFD). CFD may comprise a set of tools used to simulate heat transfer. The CFD models may be based at least in part on the location(s) of temperature sensing devices (e.g., window mullion or interior of room), measured temperatures from the devices, humidity readings, proximity and flow to/from air inlets/outlets, HVAC diffuser placements, HVAC setpoints and schedules, dimensions of the room, and other relevant building/site details which may be obtained from Revit files or other 3D modelling of the site. CFD analysis may take into account the material attributes of different surfaces in the building/occupant space and/or air flow regimes based at least in part on the above parameters (e.g., for simulation/training purposes). The simulations can help identify heat flow regimes (conduction, convection and radiation) based at least in part on the above parameters, leading to an accurate approximation of the physical temperature of the surfaces in the room. The output of the simulation approach can be used to generate training datasets for use by an ML system which can be deployed at a building site.

In some embodiments, an overall heat transfer coefficient method is utilized to project grid temperature values using estimated rates of heat transfer that are supported by available data and/or modelling. If (e.g., only) minimal input data is available, then the heat transfer rate (HTR) approach may be used to obtain a gross estimate. Additional auxiliary information may be used to fine tune the results. For example, data collected by other sensors (e.g., humidity or air flow) may provide indications of a grid point temperature. Some fine tuning may occur after converting the temperature measurements into thermal comfort profiles. For example, non-temperature based data may be obtained such as optical recognition of clothing to fine tune the characterization of a person's thermal comfort. Fine tuning thermal comfort control may include (e.g., periodic) re-calibration of the temperature sensors. For example, a traveler (e.g., human or robotic) carrying a ground-truth temperature sensor, may traverse the occupiable space to report temperature reference data that can be fed back to align a nearby temperature sensor to the reference data. A self-calibration methodology can be utilized as described in International Patent Application Serial No. PCT/US21/15378, which is incorporated herein by reference in its entirety.

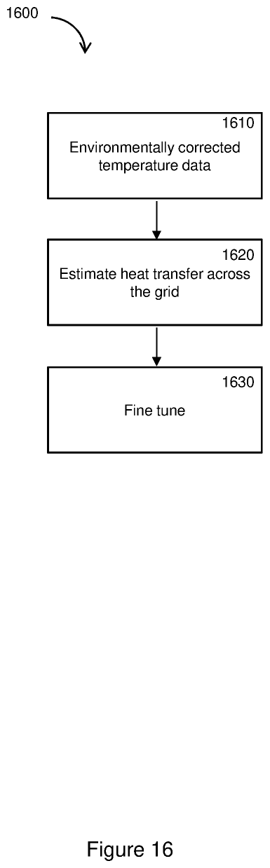

FIG. 16 shows an example of operations 1600 in extrapolating bias-corrected temperature values across a grid superimposed on an enclosure of a facility. Environmentally corrected (e.g., bias-corrected) temperature data is obtained in operation 1610. In operation 1620, a heat transfer is estimated across the grid spanning an occupiable space. For example, corrected temperature values based at least in part on measurements at the sensor locations on the façade(s) may be extrapolated, e.g., using a distance-weighted average for (e.g., any) requested grid intersection point and/or interpolated to any points in between. An extrapolated temperature is fine tuned to the requested point(s) in operation 1630.

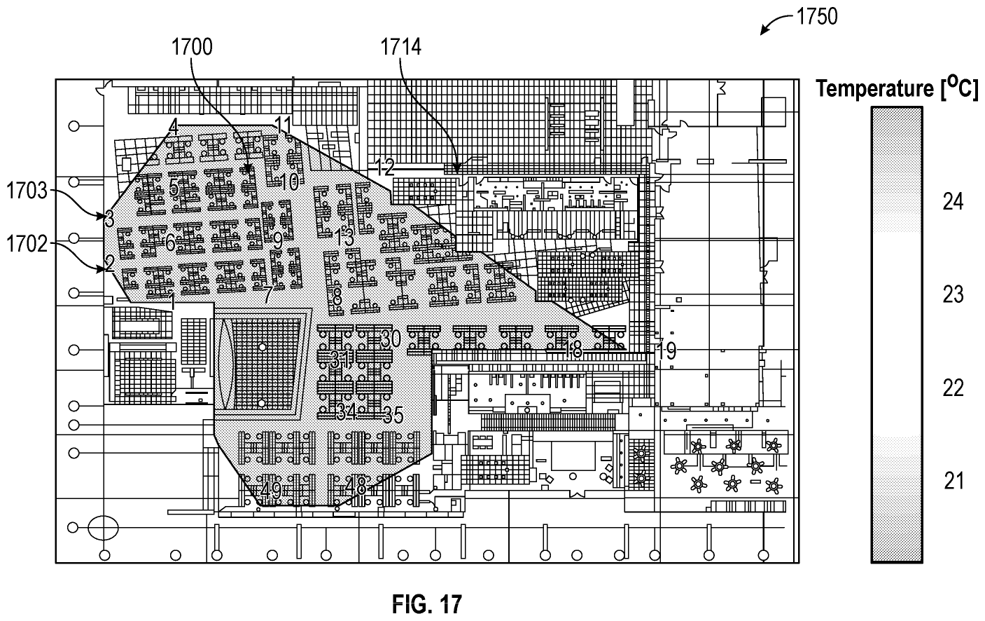

FIG. 17 shows an example of atmospheric temperature mapping 1700 extrapolated over a requested portion of an occupiable space at a first measurement time (e.g., without a sun-load falling on the façade), which space has a floorplan 1750. Temperature mapping 1700 is compiled for a first time. Mapping 1700 is shown as a grayscale coded to represent the extrapolated temperatures corresponding to each point within the requested space. Black filled circles across the floorplan such as 1714, 1702, and 1703 designate location of temperature sensors mounted across the space. Some of the sensors are additionally indicated by numerals 1, 2, 3, 4, 5, 6, 7, 8, 9, 10, 11, 12, 13, 18, 19, 30, 31, 34, 35, 48, and 49.

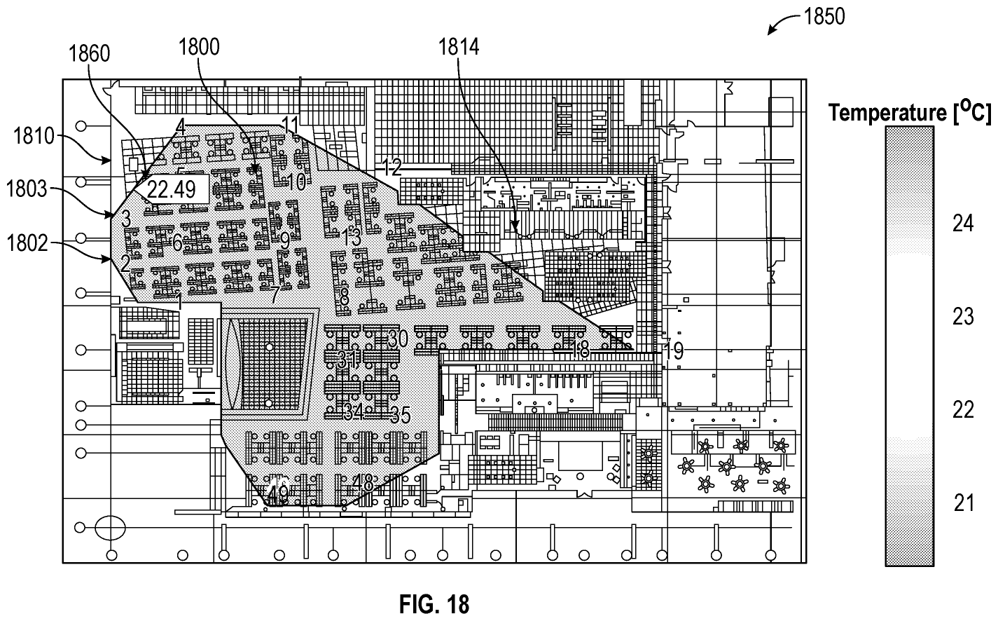

FIG. 18 shows an example of an atmospheric temperature mapping 1800 extrapolated over the same requested portion of the occupiable space at a second measurement time (e.g., with a sun-load falling on the façade) such that higher temperatures occur near an outer wall 1810 as compared to the first time as shown for FIG. 17. Temperature mapping 1800 is compiled for a second time. Black filled circles across the floorplan such as 1814, 1802, and 1803 designate location of temperature sensors mounted across the space. Some of the sensors are additionally indicated by numerals 1, 2, 3, 4, 5, 6, 7, 8, 9, 10, 11, 12, 13, 18, 19, 30, 31, 34, 35, 48, and 49. FIG. 18 shows an example of point 1860 in the temperature map superimposed on the floorplan, indicating as having a temperature of 22.49° C., which temperature is indicated. Based at least in part on the extrapolated atmospheric temperature mapping, qualification of a thermal comfort profile across the same requested space can be performed. For example, bias-corrected grid point temperatures (e.g., corresponding to temperature measurements from façade-mounted and/or interior mounted temperature sensors) can be converted into data representing the actual (e.g., real) thermal comfort at the space environment, e.g., as experienced by personnel who may be present at the corresponding grid points (e.g., occupants of the space).

In some embodiments, thermal comfort (which is also known as “operative temperature”) is based at least in part on factors including mean radiant heat transfer, gas (e.g., air) speed, atmospheric (e.g., air) temperature, relative humidity, clothing worn by occupant(s), and/or metabolic rate of occupant(s). For example, an operative temperature can be calculated from the formula:

Operative temperature=(tᵣ+(tₐ×√10v))/(1+√10v)
where tᵣ is mean radiant temperature, tₐ is atmospheric (e.g., air) temperature, and v is gas (e.g., air) speed (e.g., velocity). The operative temperature can be calculated from mean radiant temperature, atmospheric (e.g., air) temperature, convective heat transfer coefficient, and/or radiative heat transfer coefficient. Using a thermal comfort which can be obtained for all points in the atmospheric temperature mapping of the enclosure, a thermal comfort profile mapping may be obtained. The thermal comfort profile mapping may be utilized at least in part for controlling (e.g., monitoring) conditions for occupants in the space. For example, the thermal comfort profile mapping may be used to control one or more environmental characteristics of the enclosure, e.g., in order to obtain a target thermal profile.

For example, the mean radiant temperature (MRT) can be used as a means of expressing the influence of surface temperature(s) on occupant comfort. MRT may be based, at least in part, on angle factors. An MRT analysis may consider individual surface temperatures, a surface area, a distance of those surface(s) from the occupant(s), and/or whether the occupant(s) is/are seated or standing. Mean radiant heat may correspond to a uniform temperature of an enclosure in which the radiant heat transfer from the occupant is equal to the radiant heat transfer in the enclosure. MRT may depend on any factors disclosed herein (e.g., for bias correction). For example, MRT may depend upon the sensor position, sun position modeling to determine the presence of direct sunlight, and/or mounting type, surface absorbance, (e.g., color) and/or surface reflectance, to determine thermodynamics of a sensor bias (e.g., which sensor may be disposed in a housing such as a housing of a device ensemble. The sensor may be disposed in, or attached to, a fixture). Gas (e.g., air) speed (e.g., at respective grid points for use in determining thermal comfort) can be derived at least in part from an airflow model which is estimated using ventilation, air exchange rate, the locations of HVAC diffusers, and/or CFD modeling. Gas speed may be derived at least in part from gas speed sensors. Gas pressure may be derived at least in part from gas pressure sensors. Gas speed may be derived at least in part from comparison of (e.g., variance in) gas pressure between various sensors and/or grid points.

At times, humidity may be a contributing factor to thermal mapping, e.g., considering the heat capacity of water. Depending on the humidity level (e.g., as a function of time), lower levels of relative humidity (e.g., below 30%) may be a smaller factor contributing to the thermal comfort, e.g., as compared to gas velocity and/or external heating from sun radiation. Humidity measurements can be obtained using humidity sensors. The humidity sensor may or may not be located in the same device ensembles where temperature sensors are disposed. Personal factors may be taken into account in order to quantify thermal comfort values. For example, thermal comfort for an occupant may be affected by the clothing worn by the occupant, his muscle mass, and/or the degree of his physical activity at a certain time. The type of clothing and/or how it is being worn, may be detected using an optical camera. A learning system (e.g., comprising artificial intelligence such as machine learning), which correlates the detecting clothing, may estimate the clothing's impact on thermal comfort to the occupant. Another personal factor may be the metabolic rate of an occupant. Metabolic rate can be estimated using radar, infrared sensors, and/or optical sensors to determine an occupant's posture, position, movement, and muscle mass. CO₂ sensors may be utilized to assess the degree of metabolic rate and/or physical activity.

In some embodiments, a mapping of thermal comfort projected over the grid of a space, is used for monitoring purposes to enable a facility manager and/or a facility management system to determine conformance with requested thermal comfort metrics (e.g., to achieve compliance with: industry guidelines, jurisdictional standards, energy consumption goals, and/or occupant wellbeing and productivity). Temperature and/or thermal comfort mappings may be used in connection with monitoring pathogenic conditions such as approximating the temperature of surfaces and/or adjacent environments. The monitoring may be based at least in part on temperature and/or humidity values derived from the sensors. Such mapping may be utilized to identify areas of potential pathogen growth (e.g., fungus, bacteria and/or virus such as Covid-19). In some embodiments, differences between an actual (e.g., real) thermal comfort profile mapping and a target thermal profile may be used to control one or more environmental characteristics of the enclosure. For example, a thermal comfort profile in excess of a target (e.g., above a specified operative temperature threshold) may result in actions to reduce the air temperature at a corresponding point by lowering an HVAC temperature setpoint, increasing HVAC blower speed, and/or increasing a tint level of a nearby tintable window to reduce sun-loading.

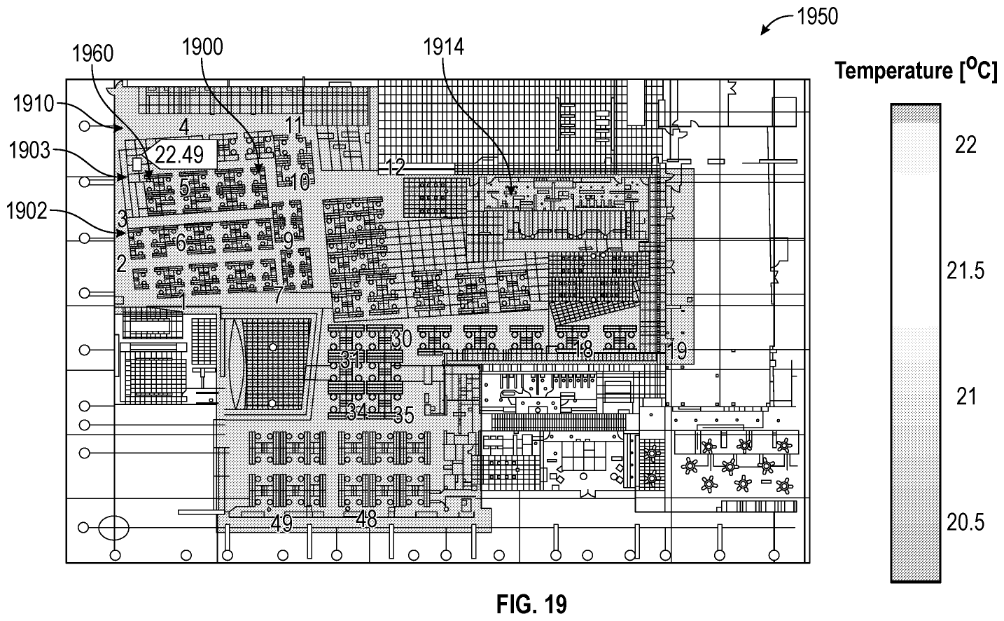

FIG. 19 shows an example of a mapping of a thermal comfort profile 1900 superimposed on a floorplan 1950. Grayscale coding and/or lines of equal thermal comfort may be used to indicate an operative temperature determined at each respective position in the mapping. Black filled circles across the floorplan such as 1914, 1902, and 1903 designate location of temperature sensors mounted across the space. Some of the sensors are additionally indicated by numerals 1, 2, 3, 4, 5, 6, 7, 8, 9, 10, 11, 12, 13, 18, 19, 30, 31, 34, 35, 48, and 49. A thermal comfort profile may typically exhibit at least a small gradient from points near an exterior wall to the points most remote from the exterior. A user might consult with a graphical representation of thermal comfort shown in FIG. 19, e.g., to identify an optimal place for the user to occupy. The user may use an app having a graphical user interface (GUI) that depicts the floorplan and the heat map superimposed on it. The GUI may indicate placement of the occupant in the floorplan. The occupant may zoom in and out of the floorplan. The user may request to indicate a temperature in a position of the floorplan. FIG. 19 shows an example of point 1960 in a temperature map superimposed on the floorplan having a temperature of 22.49° C., which temperature is indicated. The user may use the application to request control (e.g., alteration) of the temperature at a position. The application may be operatively coupled to the control system of the facility that is configure to control the environment (e.g., to control the temperature of the enclosure atmosphere). The control system may receive inputs from one or more users. Requests to the control system may be considered, e.g., based on a hierarchy. For example, requests of a manager of the facility may have a higher priority as a request of a non-managing occupant. For example, jurisdictional standards may have a higher hierarchy as requests of the manager of the facility. The hierarchy may be based at least in part on jurisdictional standards, health guidelines, industrial guidelines, hierarchical position in a company occupying the facility, managerial role of the facility environment, emergency protocols, and/or health of the requesting user. The control system may consider requests and/or solve any conflicting requests, based at least in part on the hierarchy. The control system may utilize a learning system that tracks occupant requests (e.g., and utilizes them as a learning set). The control system may predict the comfort of occupants based at least in part on their past behavior (e.g., including past requests). The application may present to a user (e.g., upon request) the user's past requests and/or preferences, e.g., for statistical purposes and/or for any other consideration.

In some embodiments, environmental characteristics of an enclosure can be monitored and adjusted to promote enhanced health, wellness, and/or performance of the enclosure occupant(s). The control may utilize at least one Artificial Intelligence (AI) engine. The environmental characteristic(s) can be monitored by one or more sensors disposed in the enclosure. Models can be constructed using baseline readings from the sensors, three-dimensional (abbreviated herein as “3D”) schematics of the enclosure, and/or physical properties (e.g., material properties) of fixture(s) of the enclosure. A control system can use the AI engine to refine the models using sensor readings of the enclosure environment, to monitor and adjust the environment of the enclosure. The AI engine can refine the model(s), e.g., using predictive extrapolation based at least in part on trend, and/or expected physical parameters. The environment may be adjusted, e.g., by administering environmental adjustments of various devices (e.g., heating, ventilation, and air conditioning system, abbreviated herein as “HVAC”) adjustments directly, and/or by using a Building Management System (abbreviated herein as “BMS”). The AI modeling of the enclosure may include usage of locations on a grid. The grid may be adjustable. The grid may have a higher spatial resolution than the spacing of the sensors. The grid may have varied resolution on some of its portions. The grid may be non-homogenous.

In some embodiments, an artificial Intelligence (AI) engine can be used for control and/or prediction of environmental characteristics in the environment. The AI engine can provide recommendation regarding an alteration of one or more environmental characteristics based at least in part on the results (e.g., predications) of the AI engine. The AI engine may use data from one or more buildings. A facility may comprise one or more buildings. The AI engine may use structural data of the facility (e.g., building, and/or layout such as workplace layout), (e.g., real time) sensor data, simulation data, third party data, and/or experimental (e.g., sensor) data. The structural data of the facility may be historical, presently planned interior (e.g., workplace) configuration and/or updated in real-time. Data gathered from building(s) may be received by a physics engine. The physics engine may use physics based simulations of a subject property characteristic(s) (e.g., its preparation in time and space), the material property characteristic(s) of the one or more buildings, and the interaction of the subject property with the at least one material properties of the one or more buildings. The physics simulation may use energy distribution simulation. The physics model may utilize occupancy characteristics (e.g., number of predicted occupants, their physical nature, and/or predicted time of occupancy). The physics engine may utilized a digital twin of the building that may incorporate the structure of the building and various (e.g., network connected) devices in the building. The physics engine can be implemented, for example, using a processing system programmed with ray-tracing software. The physics engine can generate simulation data based at least in part on the material properties of the building data. Models (used by the physics engine and/or AI engine) can be constructed using baseline readings from the sensors, three-dimensional (abbreviated herein as “3D”) schematics of the enclosure, and/or physical properties (e.g., material properties and/or configuration) of fixture(s) of the enclosure. In some embodiments, the physics engine does not use the baseline readings from the sensors. For example, the simulation data can be used to construct a first model for use by the AI engine. Experimental (e.g., sensor) data can be used to construct a second model for use by the AI engine. The experimental data can be gathered by placing a plurality of sensors sensing the subject property in the enclosure (e.g., when the enclosure is unoccupied and/or not in typical operational service (e.g., not deployed)) or in another enclosure substantially similar to the subject enclosure (e.g., building). The experimental data can be gathered from a set of test sense devices (e.g., sensors). A model can be constructed using the experimental data, and/or experimental data gathered by a device ensemble. Raw data can be gathered by the sensor and/or device ensemble. For example, the structure can be excited with a signal and/or condition whereby the plurality of sensors measures a response signal, e.g., to develop an accurate AI engine. The raw data can be cleaned (e.g., from noise using at least one filter) to generate cleaned data (also referred to herein as “silver data” for use by the AI engine. A grid of vertices can be superimposed within the enclosure (e.g., a building or a room). One or more points of interest (POIs) can be defined with reference to the grid of vertices. The AI engine can analyze the silver data using one or more models to generate a result (e.g., a set of one or more values at the one or more POIs). The set of one or more values at the one or more POIs can be stored in a database. A control system can use the database, e.g., for prediction, for recommendations, to refine the models using sensor readings of the enclosure environment, and/or for control of (e.g., to monitor and adjust) the environment of the enclosure.

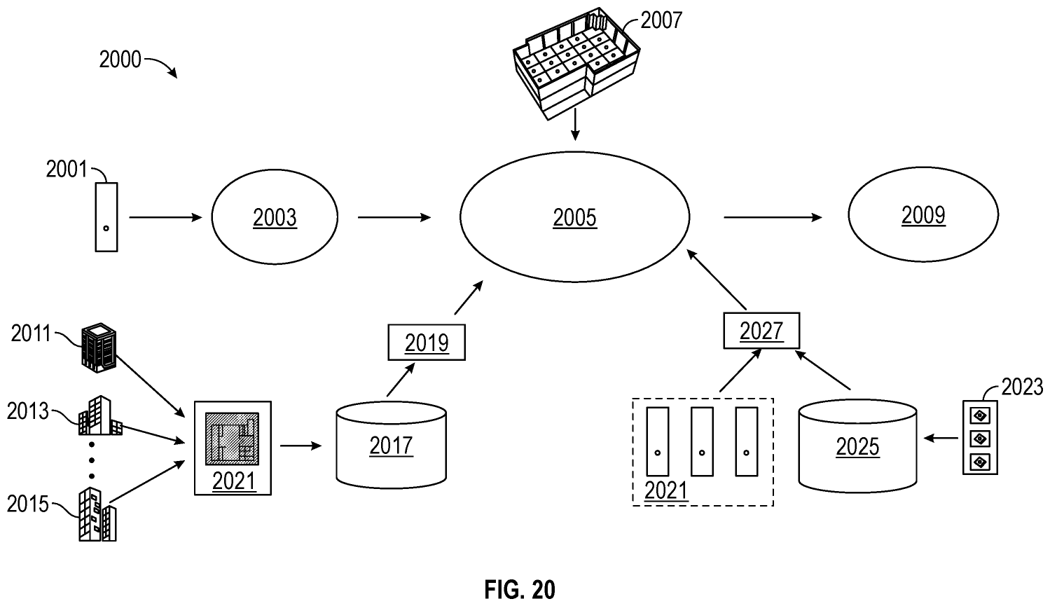

FIG. 20 schematically depicts an Artificial Intelligence (AI) engine 1105. Data gathered from a first building 2011, a second building 2012, and an N^{th} building 2015 is received by a physics engine 2021. N can be any integer 1 or greater. The physics engine 2021 can be implemented, for example, using a processing system programmed with ray-tracing software. The physics engine 2021 prepares simulation data 2017 based at least in part on the building data. Models (used by the physics engine and/or AI engine) can be constructed using baseline readings from the sensors, three-dimensional (abbreviated herein as “3D”) schematics of the enclosure, and/or physical properties (e.g., material properties) of fixture(s) of the enclosure. In some embodiments, the physics engine does not use the baseline readings from the sensors. For example, the simulation data 2017 can be used to construct a first model 2019 (e.g., physics simulation model) for use by the AI engine 2005. Experimental (e.g., sensor) data 2025 can be used to construct a second model 2027 (e.g., that utilizes real sensor data from experiments and/or deployed sensors). for use by the AI engine. The experimental data 2025 is gathered from a set of test sense devices 2023 (e.g., sensor(s) that are used for testing). The second model 2027 is constructed using the experimental data 2025 and data gathered by a device ensemble 2001. In the example shown in FIG. 20, raw data is gathered by the device ensemble 2001. The raw data is cleaned and/or filtered by a cleaning and/or filtering module 2003 to generate silver data for use by the AI engine 2005. A grid of vertices can be superimposed within a virtual representation of an enclosure 2007 (e.g., a building, a floor, or a room). The virtual enclosure model comprising the grid vertices may include an area and/or point of interest (POI). One or more points of interest (POIs) can be defined with reference to the grid of vertices. The AI engine 2005 analyzes the silver data using the first model 2019 and the second model 2027 (e.g., real sensor data driven model) to generate a set of one or more values at the one or more POIs. The set of one or more values at the one or more POIs can be stored in an insights database 2009. The AI engine can computer and store results of sensor value(s) (e.g., at points of interest) in the insights database 2009. A control system can use an insights 2009 database to refine the models using sensor readings of the enclosure environment, to monitor and adjust the environment of the enclosure 2007.

In some embodiments, one or more environmental characteristics are measured in an enclosure using one or more sensors. A virtual (e.g., electronic) map is used to model the enclosure and to control the environmental characteristic(s). The virtual map may be a topographic type map. The map may comprise one or more levels of at least one sensed environmental characteristic. In some embodiments, the enclosure may be divided into portions that form a grid. The grid may parcel the enclosure into grid portions (e.g., grid segments). In some embodiments, the grid includes a number of vertices. A user may define a point of interest (abbreviated herein as “POI”) in the enclosure. The POI may include a sensor, and/or may be at a distance from the sensor. When the POI is in a location devoid of a sensor, data from one or more sensors (e.g., disposed at grid vertices adjacent to the point of interest) can be input into the model for extrapolating a sensed property at the point of interest.

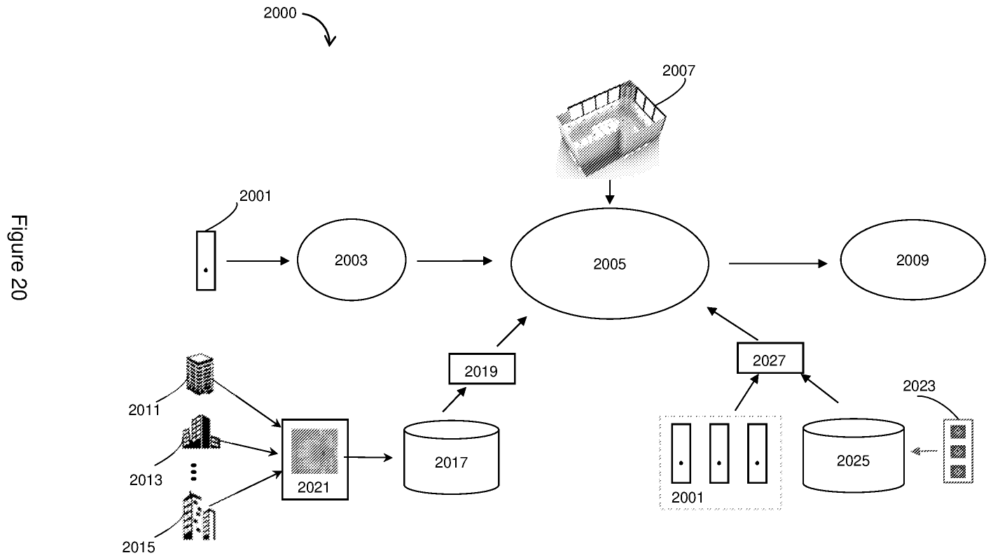

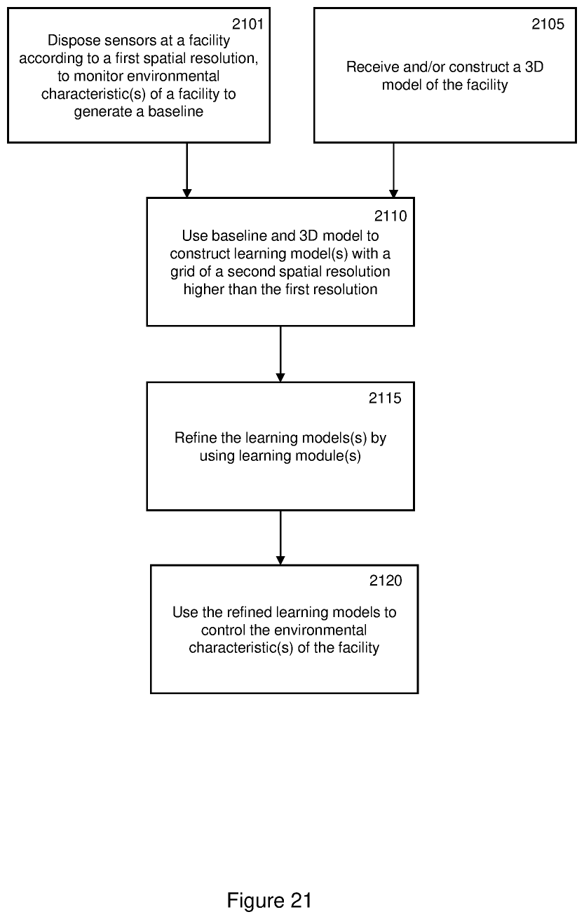

FIG. 21 shows an example of a flowchart illustrating one example of simulating a set of environmental characteristics for a facility. In block 2101, the set of environmental characteristics are simulated for the facility by modeling the facility using a grid of vertex points. In block 2102, a first selection is received which designates a vertex point from the grid as a first POI. In block 2103, the set of environmental characteristics at the first point of interest is simulated using a greater precision relative to a non-selected vertex point of the grid. In block 2105, a second selection is received which designates a second POI that is not on the grid. At block 2109, in some embodiments, the grid is altered in response to the second selection. At block 2107, in some embodiments, the second POI is migrated to a closest vertex point on the grid.

In some embodiments, the enclosure may be divided into grid portions that form a grid. The grid may parcel the enclosure into grid portions. In some embodiments, the grid includes a number of vertices. The grid can be defined in terms of a coordinate system. The coordinate system can comprise Cartesian, Polar, Cylindrical, Canonical, or Trilinear. For example, the grid can be defined in terms of an x, y, z Cartesian coordinate system. The grid may comprise space-filling polygons. The grid may comprise tessellations. The grid may comprise a boundary representation topological model (e.g., of the enclosure). The grid may be defined such that there is a minimum distance and a maximum distance between any two adjacent vertex points of the grid. The two adjacent vertex points of the grid may be disposed in the enclosure. For example, the minimum distance may be about 1 foot and the maximum distance may be about 3 feet. The grid may be defined such that there is a constant distance between any two adjacent vertex points of the grid. For example, the constant distance may be about 2 feet. The grid may divide the enclosure into portions. The portions may be of the same fundamental length scale. The fundamental length scale may comprise a length, a width, a height, or a radius of a bounding circle. The fundamental length scale is abbreviated herein as “FLS.” The FLS of the grid portion may be smaller than the FLS of the enclosure. There may be a plurality of grid portions in the enclosure.

In some embodiments, one or more sensors are placed throughout the enclosure (e.g., the facility). A sensor of the one or more portions may be disposed at a grid coordinate (e.g., at a vertex of the grid). The sensor can be located (i) at vertex point, or (ii) between vertex points. At least one sensor can be located at vertex points with one or more sensors being located between vertex points. A user may define a point of interest in the enclosure. The POI includes a sensor or be at a distance from the sensor. When the point of interest is in a location devoid of a sensor, data from one or more sensors (e.g., disposed at grid vertices adjacent to the point of interest) can be input into the model for extrapolating a sensed property at the point of interest. When a grid point (e.g., vertex) is devoid of a sensor, data from one or more sensors (e.g., disposed at other grid vertices adjacent to the vertex of interest) can be input into the model for extrapolating a sensed property at the vertex of interest that is devoid of a sensor.

In some embodiments, a partitioning of the facility using the grid is performed. The partitioning can be performed manually and/or automatically. For example, a user can manually alter the grid, e.g., by adding one or more vertex points to the grid. The grid can be automatically partitioned, e.g., in response to receiving a user input specifying a POI that is not a vertex point of the grid. The grid can include cross points which may be treated as vertices. The grid can be automatically partitioned, e.g., by specifying and/or altering a mesh size of the grid. The grid can be automatically partitioned, e.g., by adding one or more additional points to the grid. The portions of the grid may have the same FLS. The portions of the grid may have different FLS. The grid may be formed of space-filling polygons. The space-filing polygons may be of at least one type, two types, three types, or more. The POIs can be visualized as pinpoints on a grid (mesh). The grid can be placed manually (e.g., for some properties such as sound), and/or automatically (e.g., for other properties such as temperature). Determining whether to place the grid manually or automatically can be performed according to the property (e.g., humidity, temperature, CO₂, VOCs, atmospheric movement, and/or vent speed), and/or to cover (e.g., significant) variability of the data.

Determining whether to place the grid manually or automatically can be performed depending on the room (e.g., size, location, openings), and/or depending on the density of the grid (e.g., enclosures can have multiple sensors or a single sensor). The grid can be provided with multiple vertices or with a single vertex in the enclosure. This can minimize the required number of grid points.

In some embodiments, if the POI is not on the grid, the POI will migrate to the closest grid point. The migration can be facilitated using a “snap to grid” procedure (e.g., algorithm). The POI can coincide with a place of a sensor. The POI can coincide with a place devoid of a sensor. The POI can be at a distance from the sensor.

In some embodiments, sensor data from relevant sensors is input into the model(s) for extrapolating a sensed property, e.g., to compensate for an absence of a sensor at a grid point (e.g., vertex). Behavior of the property in space and/or time can be calculated and/or estimated. The calculation and/or estimation can utilize physical behavior of the sensed property and/or accumulated data regarding the sensed property. The accumulated data can be in the enclosure or in similar enclosures. The similar enclosures can be in the facility, or outside of the facility (e.g., in a remote location). The similar enclosure may have a similar setting and/or experience similar environmental conditions. Behavior of the sensed property (e.g., data thereof) sensed by a first sensor at a first location can be extrapolated to a second location that is at a distance from the first sensor, which second location does not have a second sensor. For example, a first set of measured property data from the first sensor can be utilized to simulate a virtual second set of property data, which property is the environmental characteristic sensed by the first sensor. The first location can be a grid vertex. The second location can be a grid vertex, or can be a location that is outside of the grid vertex. A third location can have a third sensor that senses the property. Data from the third sensor can be used to simulate the virtual second set of property data at the second location. The third location can be at another grid vertex. The second data set derived from the first sensor data can be compared with the second data set derived from the third sensor data. The comparison can measure differences that may be used to optimize the model(s) and/or the extrapolation of the virtual sensor data. The model(s) can be optimized iteratively. The iterative optimization can use (i) data from different sensors, (ii) data from the same sensors sensed different times, or (iii) any combination thereof. Predictive models of physical parameters may be compared between themselves (e.g., using different sets of sensed data to estimate an environmental characteristic at a location), and/or to actual (e.g., real world) readings from the sensors (e.g., disposed on grid vertices and/or outside of grid vertices). Such comparison can be used to further refine the model(s).

In some embodiments, an initial physics simulation is conducted to simulate propagation of the environmental characteristics in the enclosure. A separate simulation may be performed for an environmental characteristic (e.g., for each environmental characteristic). The results of a physics simulation can be compared to a sample (e.g., naturally occurring and/or manually orchestrated) real-time sensor readings of the environment. This comparison can be performed during an experimentation phase. A delta (e.g., difference) may be formed between the physics simulation and the sensed reality in the environment. In response to the delta, a neural network model can be revised. The neural network model may account for a physics engine (e.g., model) according to the comparison results. The physics engine may comprise a number of models. One or more sensor samples can be used to simulate additional samples. A parametric analysis may be performed to feed the model. The analysis can focus on representative samples. The analysis can utilize information from a Building Performance Database (BPD) in the jurisdiction, such as the one maintained by the U.S. Department of Energy. The BPD can combine, cleanse and/or anonymize data collected from buildings by jurisdiction authorities (e.g., federal, state and/or local governments), utilities, energy efficiency programs, building owners and/or private companies. The BPD can make this information available to the public. A variety of physical and operational characteristics for a plurality of building types can be stored in the BPD, e.g., to document trends in energy performance.

In some embodiments, one or more sensors are placed in a grid vertex for experimentation to correlate (e.g., validate) measurements. A learning model may be used (e.g., using Artificial Intelligence (AI) such as neural networks, linear regression, or polynomial) to revise adjustable coefficients in the model according to the sensor samples and according to the delta. In some embodiments, the physics simulation may not be used for the updating process in the learning model. A weighted average can be used to fill in the sensor reading of a grid point that is devoid of sensors.

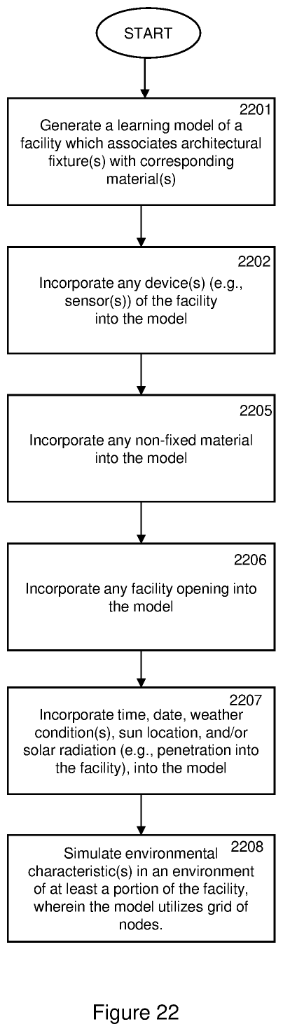

FIG. 22 shows an example of a flowchart depicting an exemplary refinement of a learning model. At block 2201, a learning model is generated for a facility. The learning model associates architectural fixture(s) with corresponding material(s). Next, at block 2202, any device(s) (e.g., sensors) of the facility are incorporated into the model. Any non-fixed material is incorporated into the model at block 2205. Any facility opening (e.g., window, door, and/or ventilation opening) is incorporated into the model at block 2206. At block 2207, date, time, weather condition(s), sun location, and/or solar radiation (e.g., penetration into the facility) is incorporated into the model. Environmental characteristic(s) are simulated in an environment of at least a portion of the facility at block 2208. The model can utilize a grid of nodes (e.g., vertex points).

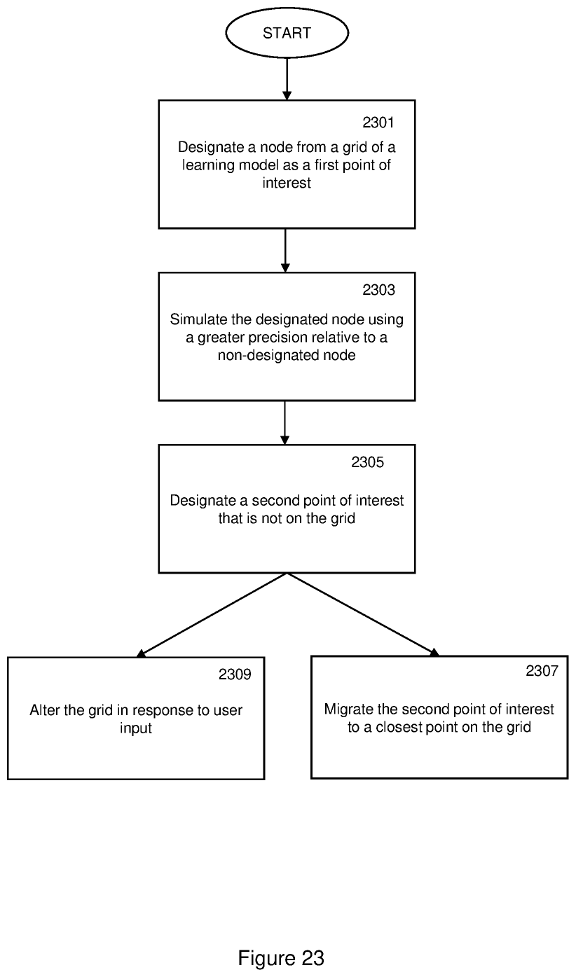

FIG. 23 shows an example of a flowchart depicting example modeling using a grid of vertex points. At block 2301, a node (e.g., vertex point) is designated from a grid of a learning model as a first point of interest (POI). The designated node (e.g., vertex point) is simulated using a greater precision relative to a non-designated node (e.g., vertex point) at block 2303. Then, at block 2305, a second point of interest (POI) that is not on the grid is designated. According to one embodiment, the grid is altered in response to user input at block 2309. According to one embodiment, the second point of interest is migrated to a closest point on the grid at block 2307.

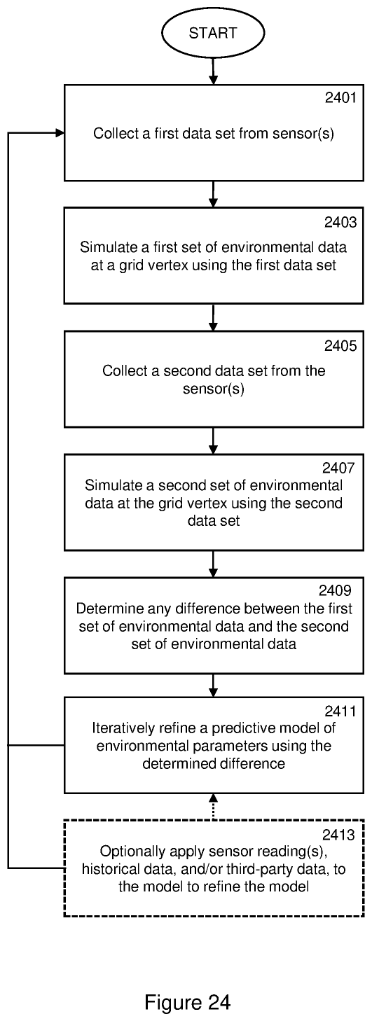

FIG. 24 shows an example of a flowchart depicting an example collection of sensor data. A first data set is collected from sensor(s) at block 2401. A first set of environmental data is simulated at a grid vertex using the first data set at block 2403. Next, at block 2405, a second data set is collected from the sensor(s). A second set of environmental data is simulated at the grid vertex using the second data set at block 2407. Then, at block 2409, any difference between the first set of environmental data and the second set of environmental data is determined. A predictive model of environmental parameters is iteratively refined at block 2411 using the determined difference, and the operational sequence loops back to block 2401. Optionally, the operational sequence flows form block 2411 to block 2413 where sensor reading(s), historical data, and/or third party data are applied to the model to refine the model. The operational sequence then loops back to block 2401.

In some embodiments, a deep convolutional neural network (e.g., deep learning) can be used to fill in the sensor reading of the grid point that is devoid of sensor(s). One or more sensors can be placed in missing grid points for training, model adjustment, and/or model validation purposes. This placement may occur in a sample of the space of the enclosure. Regression analysis may be performed to fill in the sensor reading of the grid point that is devoid of sensor(s). An analysis may be performed using an input and an output of a function. Linear regression (e.g., a weighted average) can be used to fill in the sensor reading of the grid point that is devoid of sensors. A non-linear function can be employed to fill in the sensor reading of the grid point that is devoid of sensors. The non-linear function may be used, e.g., in a situation of constant variance (e.g., a light sensor measuring a minimum amount of natural light at night, no fluctuation in CO₂ at night). A linear function may be used to fill in the sensor reading of the grid point that is devoid of sensors, e.g., in a situation where unequal variance is present (e.g., nonlinear flux and temperature during daylight hours).

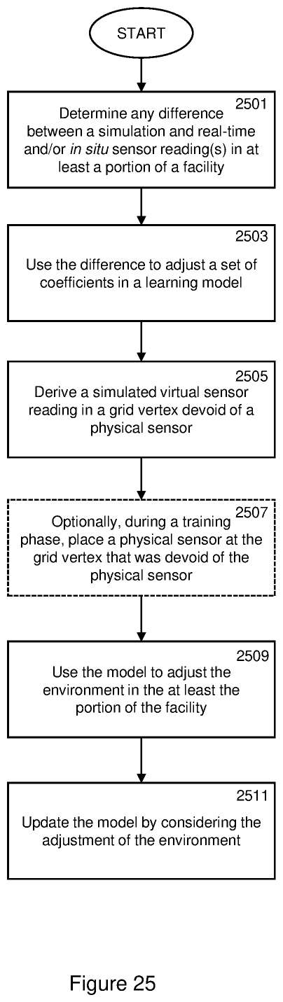

FIG. 25 shows an example of a flowchart depicting an exemplary performance of environmental adjustments. Any difference between a simulation and real-time (and/or in-situ) sensor reading(s) in at least a portion of a facility is determined at block 2501. This difference is used to adjust a set of coefficients in a learning model at block 2503. Next, at block 2505, a simulated virtual sensor reading is derived in a grid vertex that is devoid of a physical sensor. Optionally, during a training phase at block 2507, a physical sensor is placed at the grid vertex that was devoid of the physical sensor. The operational sequence progresses from block 2505 or block 2507 to block 2509 where the model is used to adjust the environment in at least a portion of the facility. The model is updated at block 2511 by considering the adjustment of the environment.

In some embodiments, the learning model continues to be used after system deployment to update the model. A control system can direct adjustment, or can be directed to adjust, the environment (e.g., preemptively) of the enclosure by using the learning model.

In some embodiments, various environmental characteristics of the enclosure are controlled (e.g., monitored and/or adjusted). These characteristics can be controlled to provide an optimized occupant environment (e.g., in terms of wellness, health, and/or comfort). The one or more environmental characteristics may be monitored by sensor(s). The sensor(s) may be disposed in the enclosure. One or more models may be constructed using baseline readings and/or 3D schematics of the space. At least one controller (e.g., a control system) and/or a processor can use the AI algorithm(s). The AI algorithms may comprise predictive extrapolation. The predictive extrapolation may be based at least in part on trend, and/or expected physical parameters. The AI algorithm(s) may be utilized to further refine the models using sensor readings of the enclosure space. The AI algorithm(s) may be utilized to control the environment of the enclosure. Controlling the environment may include directly or indirectly controlling any device. The device can be operatively coupled with the building (e.g., HVAC). Indirect control may comprise using a building management system (BMS). The BMS may or may not be communicatively coupled to the controller(s). The BMS may or may not be communicatively coupled to the processor(s). The AI modeling of the enclosure space may include locations on a grid. The AI modeling of the enclosure space may utilize locations on a grid. The locations of the grid may have a different (e.g., higher or lower) spatial resolution than the spacing of the sensors.

In some embodiments, an enclosure includes one or more sensors. The sensor may facilitate controlling the environment of the enclosure, e.g., such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. Sensor may provide on/off indications of the occurrence and/or presence of an environmental event (e.g., one pixel sensors). In some embodiments, the accuracy and/or resolution of a sensor may be improved via artificial intelligence (abbreviated herein as “AI”) analysis of its measurements. Examples of artificial intelligence techniques that may be used include: reactive, limited memory, theory of mind, and/or self-aware techniques).

In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique. Sensors may be configured to process, measure, analyze, detect and/or react to: data, temperature, humidity, sound, force, pressure, concentration, electromagnetic waves, position, distance, movement, flow, acceleration, speed, vibration, dust, light, glare, color, gas(es) type, and/or other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting and/or in the facility. A sensor may be optimized to performing accurate measurements of one or more environmental characteristics present in the factory setting and/or in the facility in which it is deployed.

In some embodiments, a processor interfaces with actuators and/or sensors. This interfacing may be provided for control purposes. The processor may include a hierarchy of controllers. The processor may control an enclosure such as a smart building. A smart building can be any structure that uses one or more automated processes to automatically control the operation of the building. These automated processes can include heating, ventilation, air conditioning, lighting, security, window blind controls, and/or other systems. The smart building may use sensors, actuators and/or microchips to collect data. The smart building can use this data to manage the environment of the building. This infrastructure may help owners, operators and facility managers to enhance the comfort of building occupants. Energy use may be reduced. The manner in which space is used may be improved. The environmental impact of buildings can be reduced.

In some embodiments, the enclosure may have interacting systems. The enclosure can be a facility, a room, and/or a collection of portions of multiple buildings. The enclosure can be any enclosure disclosed herein. The processor may operate in a network environment, e.g., the processor may be operatively (e.g., communicatively and/or physically) coupled to a network. The network environment may be configured for remote (e.g., Cloud) interaction. The remote interaction may include users and/or a service provider. The network environment may include wired and/or wireless communication. The processor may execute a control scheme. The control scheme may include feed forward, fast forward, open loop, and/or closed loop. The processor may control the BMS and/or any controllable device such as a sensor, emitter, antenna, or tintable window (e.g., an IGU). The controllable device may include optically controllable electrochromic devices. The processor may be communicatively coupled to sensors and/or emitters. Multiple sensors, emitters, actuators, transmitters, and/or receivers may be integrated into a single assembly. The single assembly may be provided in the form of a digital architectural element. The general processor may be communicatively coupled to other output devices. The other output devices may include an HVAC system and/or one or more antennas.

In some embodiments, processing data derived from the sensor comprises applying one or more models. The models may comprise a mathematical model. The processing may comprise fitting of model(s) (e.g., curve fitting). The model may be multi-dimensional (e.g., two or three dimensional). The model may comprise a linear or non-linear equation. The model may comprise an exponential or logarithmic equation. The model may comprise one or more Boolean operations. The model may consider the enclosure. Considering the enclosure may include the structure and/or makeup of the enclosure. Makeup of the enclosure may comprise material makeup of any fixture and/or non-fixture the model in the enclosure. The model may consider a Building Information Modeling (BIM) (e.g., Revit file) of the enclosure before, during, and/or after its construction. The model may consider a two dimensional (e.g., floor plan) and/or three dimensional modeling (e.g., 3D model rendering) of the enclosure. The model may or may not comprise a finite element analysis. The model may comprise, or be utilized in, a simulation. The simulation may be of at least one environmental characteristic of at least a portion of enclosure (e.g., depicting status in various positions in the enclosure such as a POI). The model may be represented as a graph (e.g., 2 or 3 dimensional graph). For example, the model may be represented as a contour map. The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change.

In some embodiments, the model of the enclosure comprises the architecture of a building (e.g., including one or more fixtures). The model may be a 3D model. The model may identify one or more materials of which these fixtures are comprised. The model may comprise Building Information Modeling (BIM) software (e.g., Autodesk Revit) product (e.g., file). The BIM product may allow a user to design a building with parametric modeling and drafting elements. In some embodiments, the BIM is a Computer Aided Design (CAD) paradigm that allows for intelligent, 3D and/or parametric object-based design. The BIM model may contain information pertaining to a full life cycle for a building, from concept to construction to decommissioning. This functionality can be provided by the underlying relational database architecture of the BIM model, that may be referred to as the parametric change engine. The BIM product may use .RVT files for storing BIM models. Parametric objects—whether 3D building objects (such as windows or doors) or 2D drafting objects—may be referred to as families, can be saved in .RFA files, and can be imported into the RVT database. There are many sources of pre-drawn RFA libraries.

The BIM (e.g., Revit) may allow users to create parametric components in a graphical “family editor.” The model can capture relationships between components, views, and annotations, such that a change to any element is automatically propagated to keep the model consistent. For example, moving a wall updates neighboring walls, floors, and roofs, corrects the placement and values of dimensions and notes, adjusts the floor areas reported in schedules, redraws section views, etc. The BIM may facilitate continuous connection, updates, and/or coordination between the model and (e.g., all) documentation of the facility, e.g., for simplification of update in real time and/or instant revisions of the model. The concept of bi-directional associativity between components, views, and annotations can be a feature of BIM.

The BIM model can use a single file database that can be shared among multiple users. Plans, sections, elevations, legends, and schedules can be interconnected. The BIM can provide (e.g., full) bi-directional associativity. Thus, if a user makes a change in one view, the other views can be automatically updated. Likewise, BIM files can be updated automatically in response to an input received from a sensor. BIM drawings and/or schedules can be fully coordinated in terms of the building objects shown in drawings. A base facility (e.g., building) can be drawn using 3D objects to create fixtures (e.g., walls, floors, roofs, structure, windows, and/or doors) and other objects as needed. The BIM model (e.g., BIM virtual model, or BIM virtual file) can incorporate information regarding the structure and/or material associated with the facility. Generally, if a component of the design is going to be seen in more than one view, it can be created using a 3D object. Users can create their own 3D and 2D objects for modeling and drafting purposes. Small-scale views of building components may be created using a combination of 3D and 2D drafting objects, or by importing drafting work done in another computer aided design (CAD) platform, for example, via DWG, DXF, DGN, SAT or SKP.

In some embodiments, when a project database is shared using BIM, a central file can be created which stores a master copy of the project database on a file server. A user can work on a copy of the central file (known as the local file), stored on his/her workstation. Users can save to the central file to update the central file with their changes, and to receive changes from other users. the BIM model can check with the central file whenever a user starts working on an object in the database to see if another user is editing the object. This procedure may prevent two people from making the same change simultaneously and causing a conflict. Multiple disciplines working together on the same project can make their own project databases and link in databases from other consultants for verification. BIM can perform interference checking, which may detect if different components of the building are occupying the same physical space.

In some embodiments, when a structural change takes place in the facility, the BIM model may require manual updates to at least one document associated with the facility to document the change and remain updated. The control system (e.g., using the sensor(s)) of the facility) may (e.g., automatically) feed structural updates to the BIM model, to the AI engine, and/or to the physics engine. The structural updates fed by the control system may be done in real time (e.g., as the changes occur), or at a time in which the facility is not occupied (e.g., at night, during the weekend, or during a holiday). The update may be scheduled (e.g., pre-scheduled). The update may take place at a closest time frame to the structural change made (e.g., the first time in which the facility is idle after the structural change has been made). The update and/or sensor scan may be at a predetermined (e.g., pre-scheduled) intervals.

In some embodiments, one or more models (as disclosed herein) are used by the AI engine. The model may incorporate non-fixed materials, for example, water that occupies pipes, heat capacity of materials, optical absorbance/reflectivity, heat signature, acoustic properties, and/or outgassing/VoC's of materials versus temperature. The model may incorporate openings, time of day, sun angle, and/or penetration depth. The model may be applied to a scenario where room assignments and/or walls are unknown. The model may be applied to a scenario where a dry wall, hallway, open area, reception area, stairs, and/or a closed area are known. The model may include building elements such as fixtures and non-fixtures. The building elements may comprise partitions, walls, floors, roofs, structure, windows, doors, ceilings, cabinets, furniture, desks, cubicles, tables, chairs, ventilation ducts, electrical conduits, lighting fixtures, water supply lines, roof vents, and/or piping for utilities. The model may associate a fixture with one or more physical properties, such as a material for the fixture, a heat capacity for the fixture, an acoustical property for the fixture, and/or any of a number of other physical properties.

The model can include information about the energy-related characteristics of commercial and/or residential buildings. For example, as mentioned previously, the model can include information from a Building Performance Database (BPD) maintained by the U.S. Department of Energy. In some embodiments, the BPD combines, cleanses and/or anonymizes data collected from buildings by jurisdictional authorities (e.g., federal, state and local governments), utilities, energy efficiency programs, building owners and/or private companies. A variety of physical and operational characteristics for a plurality of building types can be stored in the BPD, e.g., to document trends in energy performance. The BPD can allow users to create and/or save customized datasets based on specific variables, e.g., including building types, locations, sizes, ages, equipment, and/or operational characteristics. The BPD can allow users to compare buildings using statistical or actuarial methods. The BPD can comprise a graphical web interface and/or a web API (application programming interface) that allows applications and/or services to dynamically query the BPD.

In some embodiments, an initial physics simulation is conducted to simulate propagation of the environmental characteristics in the enclosure. A separate simulation may be performed for an environmental characteristic (e.g., for each environmental characteristic). The AI model may be configured using outputs of the physics simulation. The AI model may be an AI engine comprising a neural network, or any other sensor analysis methodology and/or mathematical model disclosed herein. The physics simulation may be lengthy, for example, on the order of hours or days. The physics simulation may simulate the interior as well as the exterior of the enclosure. The physics simulation may simulate the (e.g., entire) interior environment of the enclosure. The interior environment may encompass areas beyond the perimeter skin of the enclosure. The interior of the enclosure may be simulated based at least in part on the grid of nodes (e.g., vertex points). The grid of vertex points may be an intersection of 3D grid lines. There may be any number of vertex points in the grid. The grid may have a constant density or a varied density. For example, at least one portion of the grid may have a higher density (e.g., adjacent to and including the POI). One or more sensors may be placed throughout the enclosure. The at least one of the sensors may be included in an ensemble of sensors (e.g., suite of sensors). The ensemble of sensors may comprise any device disclosed herein (e.g., sensor, emitter, controller, and/or antenna). The sensors may be disposed at coordinates of the grid. The grid may have a vertex occupied by at least one sensor. The grid may have a vertex devoid of any sensor.

In some embodiments, the model uses a variate model. The variate model may be a single-variate model or a multi-variate model. The single-variate model may be applicable to one type of environmental characteristic (and use corresponding one type of sensor data). The multi-variate model may be applicable to a plurality of environmental characteristic types (and use corresponding multiple types of sensor data). The multi-variate model may be applicable to one environmental characteristic type (and use multiple types of sensor data). The variate model may determine a missing value imputation. The missing value imputation may be used to increase the trust in a sensor reading (e.g., verify that the sensor reading is correct). The multi-variate model can use sensors reading of different properties (e.g., different environmental characteristics). The multi-variate model can use sensors reading at different portions of the enclosure (e.g., different rooms in a floor, different floors of a building, or different building of a facility). The single-variate model can use (e.g., only) one sensor property. The variate model may use anomaly detection of sudden spikes and/or outliers.

FIG. 26 shows an example of a schematic cross-section of an electrochromic device 2600 in accordance with some embodiments. The EC device coating is attached to a substrate 2602, a transparent conductive layer (TCL) 2604, an electrochromic layer (EC) 2606 (sometimes referred to as a cathodically coloring layer or a cathodically tinting layer), an ion conducting layer or region (IC) 2608, a counter electrode layer (CE) 2610 (sometimes referred to as an anodically coloring layer or anodically tinting layer), and a second TCL 2614. Elements 2604, 2606, 2608, 2610, and 2614 are collectively referred to as an electrochromic stack 2620. A voltage source 2616 operable to apply an electric potential across the electrochromic stack 2620 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL.

In various embodiments, the ion conductor region (e.g., 2608) may form from a portion of the EC layer (e.g., 2606) and/or from a portion of the CE layer (e.g., 2610). In such embodiments, the electrochromic stack (e.g., 2620) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725 filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 2620. Various layers, including transparent conducting layers (such as 2604 and 2614), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack (e.g., 2620) such that available ions in the stack that can cause the electrochromic material (e.g., 2606) to be in the tinted state reside primarily in the counter electrode (e.g., 2610) when the window is in a first tint state (e.g., clear). When the potential applied to the electrochromic stack is reversed, the ions can be transported across the ion conducting layer (e.g., 2608) to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., un-tinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to un-tinted state).

In certain embodiments, at least a portion (e.g., all of) the materials making up electrochromic stack are inorganic, solid (i.e., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

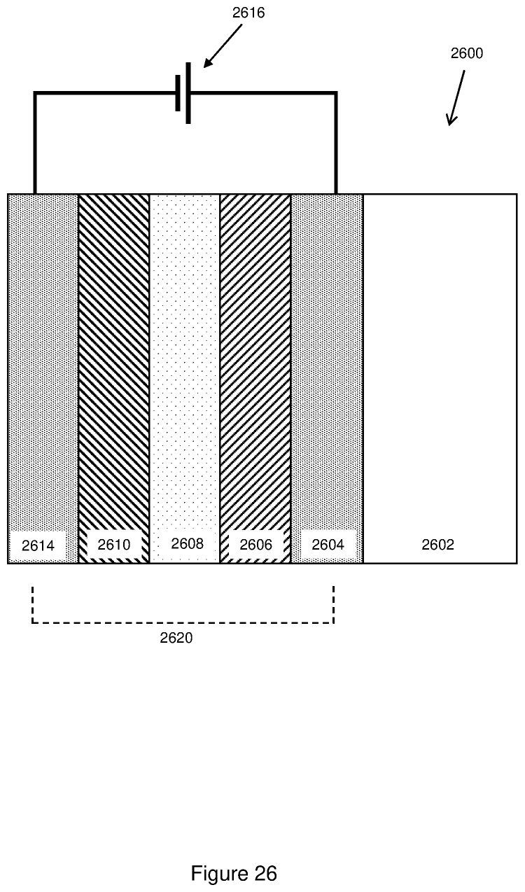

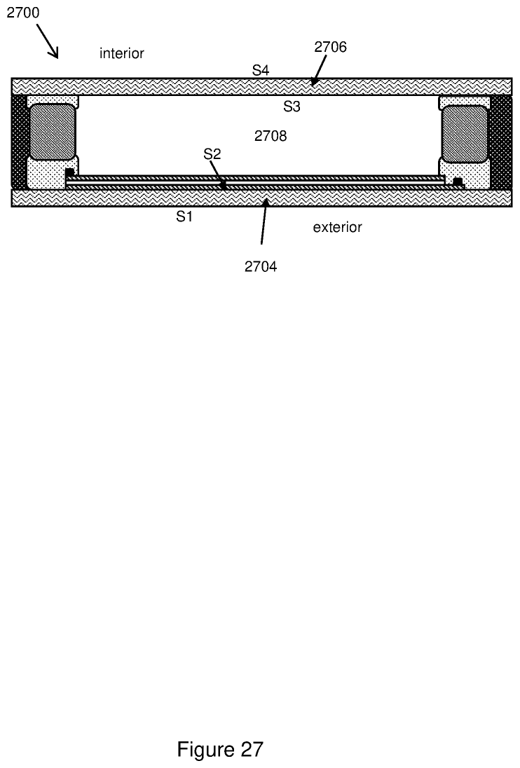

FIG. 27 show an example of a cross-sectional view of a tintable window embodied in an insulated glass unit (“IGU”) 2700, in accordance with some implementations. The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume (e.g., 2708) of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g., connect) one or more electrochromic devices to a voltage source, switches and the like, and may include a frame that supports the IGU or laminate. A window assembly may include a window controller, and/or components of a window controller (e.g., a dock).

FIG. 27 shows an exemplary implementation of an IGU 2700 that includes a first pane 2704 having a first surface S1 and a second surface S2. In some implementations, the first surface S1 of the first pane 2704 faces an exterior environment, such as an outdoors or outside environment. The IGU 2700 includes a second pane 2706 having a first surface S3 and a second surface S4. In some implementations, the second surface (e.g., S4) of the second pane (e.g., 2706) faces an interior environment, such as an inside environment of a home, building, vehicle, or compartment thereof (e.g., an enclosure therein such as a room).

In some implementations, the first and the second panes (e.g., 2704 and 2706) are transparent or translucent, e.g., at least to light in the visible spectrum. For example, each of the panes (e.g., 2704 and 2706) can be formed of a glass material. The glass material may include architectural glass, and/or shatter-resistant glass. The glass may comprise a silicon oxide (SOₓ). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

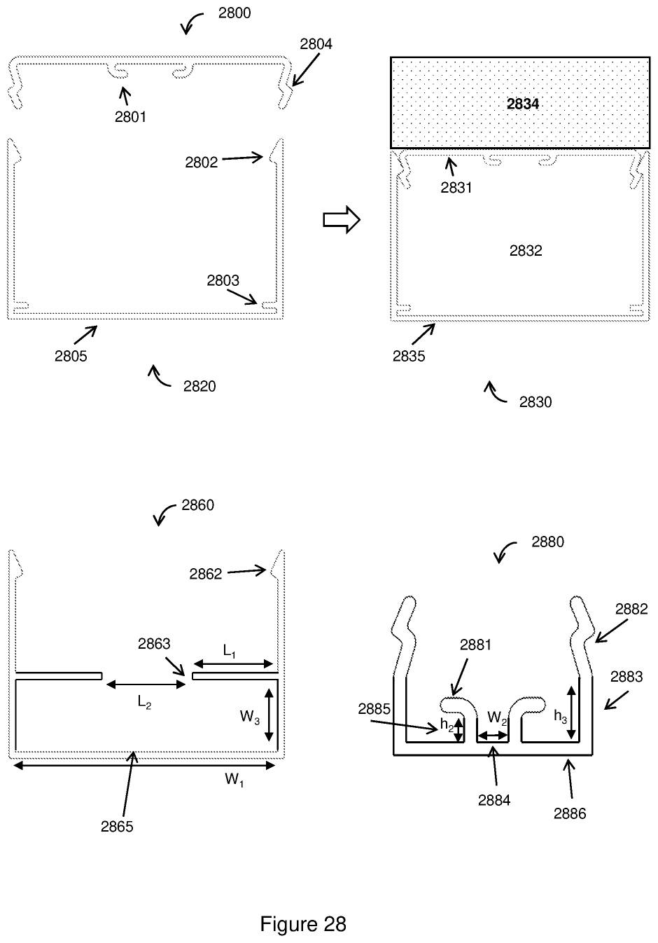

In some embodiments, the framing portion (e.g., of a window) comprises portions that integrate with each other, e.g., using screws, snap cap, and/or adhesion. The framing portion can comprise a mullion or a transom. The framing portion can be configured to accommodate a sensor and/or a device ensemble. The framing portion can be configure for attachment of a sensor and/or a device ensemble. FIG. 28 shows example of various cap portions shown as vertical cross sections. First cap portion 2800 comprising two splines including spline 2801, which two splines points towards each other, and dent 2804 configured to engage with a snap fit. First cap portion 2800 is configured to be attached (as in 2831) to an existing framing portion such as 2834. Second cap portion 2820 comprises sides having snap fits such as 2802 configured to couple to the dents (e.g., 2804) in the first cap portion 2800. The side comprising 2802 can act as a snap fit cantilever. The second cap portion 2820 includes a railing 2803. The railing may extend along the entire second cap portion, or extend only to a portion of the second cap portion. The second cap portion 2820 is configured to engage (e.g., as shown in 2831) with the first portion 2831. The interior 2832 of the framing cap is configured to hold cables and/or devices (e.g., sensors, emitters, controllers, circuitry (e.g., circuit boards), and/or other electrical components). The railing side (e.g., 2863) may have any length L1 that is smaller than the width W1 of the framing cap. The width of the framing cap W1 can be the same or larger than the width of the existing framing such as 2834. The width of the railing W3 should be sufficient to accommodate the wiring. The length of the railing L1 should be configured to hold the wiring in place. The length of the opening to the railing cavity should be sufficient for the wiring to go through. Cap portion 2860 comprises a snap fit 2862 that can be substituted for an external railing that would configured to engage with an external railing (or dent) in another cap portion with which cap portion 2860 is configured to couple to cap portion 2880 comprises dents 2882 that are separated from the front cap portion 2886 by a straight side portion 2883 having a height h3. The height may be configured to facilitate engagement of wiring and/or holders. Framing cap portion 2880 comprises splines such as 2881 that point towards the sides of the cap (e.g., towards 2883). The splines are configured to engage with a holder (not shown). The holder may extend into the cap portion in which the spline is disposed, or beyond the height of the cap portion in which the spline is disposed.

In some embodiments, the framing cap comprises a polymer (e.g., an organic polymer), resin, or an allotrope of elemental carbon. In some embodiments, the framing cap comprises metal including elemental metal and/or metal alloy. In some embodiments, the framing cap comprises a composite material. In some embodiments, the framing cap comprises non-composite material. In some embodiments, a surface of the framing cap is treated. The framing cap may be configured to be resistance to electricity (e.g., be non-conductive). The at least one surface of the framing cap may be treated. For example, the framing cap may comprise aluminum that has been surface treated to generate anodized aluminum. The surface may be configured for self-lubrication. The surface may comprise impregnated polytetrafluoroethylene (PTFE) Teflon (e.g., for increased lubricity and/or low friction). As compared to the non-treated surface, at least on surface of the framing cap may be configured to increased lubricity, higher corrosion resistance, and/or higher electrical resistance. The such surface treatment may facilitate a tool-less installation and removal process (e.g., via snapping), e.g., of the framing cap portions to each other. The tool-less installation may save time during commissioning.

In some embodiments, the framing cap and/or the framing (or a portion thereof) is configured for temperature conditioning. The framing cap and/or the framing (or a portion thereof) can comprise one or more ventilation holes. The one or more ventilation holes can be configured to facilitate gas flow within the framing cap and/or the framing (or a portion thereof), e.g., from one end of the framing cap and/or the framing (or a portion thereof) to its opposing end. The one or more ventilation holes can be configured to facilitate temperature conditioning of an interior of the framing cap and/or the framing (or a portion thereof). The framing cap and/or the framing (or a portion thereof) is part of a framing system, e.g., of a door, a wall, a supporting structure, a window such as a tintable window, or any combination thereof. The one or more ventilation holes may be configured to facilitate temperature conditioning of an interior of the framing cap and/or the framing (or a portion thereof), e.g., during temperature variation in a framing system. The one or more ventilation holes are configured to facilitate gas flow in the vicinity of at least one device integrated with (e.g., disposed in and/or on) the framing cap and/or the framing (or a portion thereof). The device can be disposed partially inside and partially outside of the framing cap and/or the framing (or a portion thereof). The device can be disposed partially inside and partially at the external surface of the framing cap and/or the framing (or a portion thereof). The device may comprise a sensor ensemble, or a media display. The one or more ventilation holes may be configured to facilitate temperature conditioning in the vicinity of at least one device disposed in the framing cap portion, e.g., to facilitate temperature conditioning of the device (e.g., thermally equilibrating, heating, or cooling the device). The device can be disposed partially inside and partially outside of the framing cap and/or the framing (or a portion thereof). The framing cap and/or the framing (or a portion thereof) can comprise an insulating coating configured to reduce temperature variation in the interior of the framing cap and/or the framing (or a portion thereof), e.g., respectively. The framing cap and/or the framing (or a portion thereof) can comprise an insulating coating configured to reduce temperature equilibration between an external environment and an interior of the framing cap and/or the framing (or a portion thereof). The framing cap and/or the framing (or a portion thereof) can comprise an insulating coating configured to reduce temperature equilibration between a framing (as part of the framing system) and the framing cap (e.g., an interior of the framing cap). The insulating coating can be disposed in an interior and/or at an exterior of the framing cap and/or the framing (or a portion thereof). The framing system (e.g., the kit and/or the frame) may comprise an intermediate body (e.g., a thermal insulator or a heat conductor) disposed between the framing cap and the framing (that is a part of the framing system). The intermediate body may be an insert, an intermediary body, or an interposing body. The intermediate body may be configured to reduce heat transfer (e.g., temperature equilibration) between the framing system and the framing cap portion (e.g., which is part of the kit). The intermediate body can comprise a solid, semi-solid (e.g., gel), liquid, or gaseous material (e.g., low heat conductive material). The intermediate body (e.g., insulator) material can include a polymer, a cloth, and/or a foam. The intermediate body may be a low pressure gas (e.g., lower than the ambient pressure in an environment in which the framing cap and/or the framing (or a portion thereof) is disposed), e.g., lower than about one (1) atmosphere. The intermediate body can be passive. The passive intermediate body may comprise a heat conductive plate, or a heat conductive pipe. The intermediate body may be active. The active intermediate material comprises a thermostat, a circulating coolant, a heat conductive plate, a heat conductive pipe, a heater, or a cooler. The intermediate body may be disposed in a manner that facilitates temperature shielding, limit heat exchange, or any combination thereof. The device, device housing, intermediate body, the framing cap and/or the framing (or a portion thereof), may comprise a, insulator, a heat exchanger and/or a cooling element. The heat exchanger and/or cooling element may comprise a heat pipe, or a metallic slab. Metallic may comprise elemental metal or metal alloy. The metal may be configured for (e.g., efficient and/or rapid) heat conduction. The metal may comprise copper, aluminum, brass, steel, or bronze. The thermal exchanger (e.g., cooling element) may comprise a fluid, gaseous, or semisolid (e.g., gel) material. The thermal exchanger may be active and/or passive. The thermal exchanger may comprise a circuiting substance. The thermal exchanger may be operatively coupled to an active cooling device (e.g., thermostat, cooler, and/or refrigerator). The active cooling device may be disposed externally to the device, device housing, intermediate body, the framing cap and/or the framing (or a portion thereof), or to any combination thereof. The thermal exchanger may be disposed in a fixture (e.g., the floor, ceiling, or wall) of the enclosure (e.g., building or room) in which the device, device housing, intermediate body, the framing cap and/or the framing (or a portion thereof), or to any combination thereof, is located. The heat exchange may comprise radiation, conduction, or convection. The intermediate body may comprise a polymer. For example, polyurethane, styrene, vinyl, Teflon, Kapton, Nylon, or polyimide. The intermediate body may comprise a foam, a tape, or an extruded shape (e.g., sheet). The coating may be anodized (e.g., anodized aluminum). The coating may be a polymer. e.g., any of the polymers disclosed herein. The intermediate body may comprise at least one thermal break.

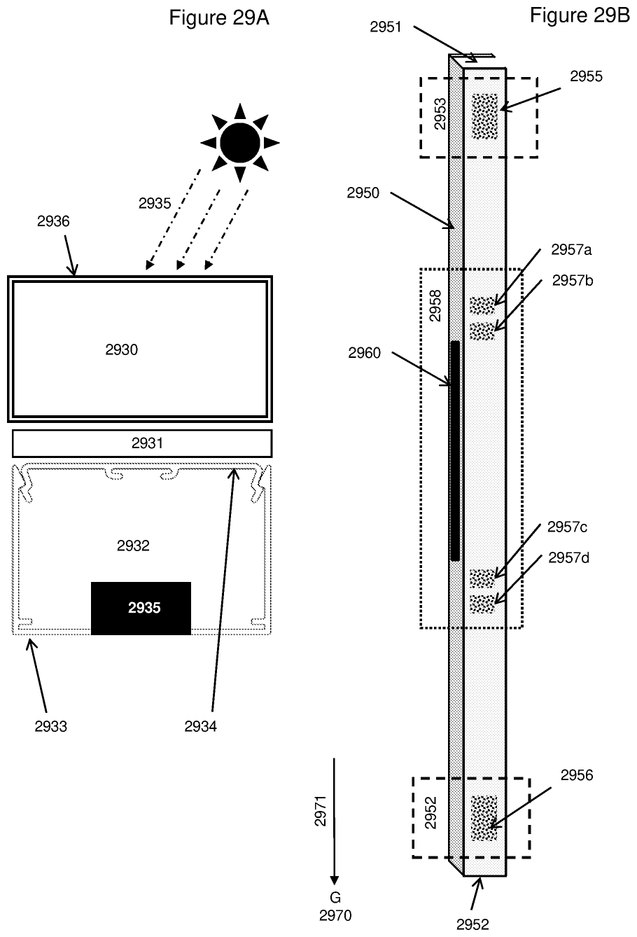

FIG. 29A shows example of various framing system portions shown as vertical cross sections and an example for head conditioning. First cap portion 2934 comprising splines two, which two splines points towards each other, and dent configured to engage with a snap fit. First cap portion 2934 is configured to be attached to an existing framing portion such as 2936. Second cap portion 2933 comprises sides having snap fits configured to couple to the dents in the first cap portion 2934. The second cap portion 2933 includes a railing. The railing may extend along the entire second cap portion, or extend only to a portion of the second cap portion. The second cap portion 2933 is configured to engage with the first portion 2934 as shown in FIG. 29A. The interior 2932 of the framing cap is configured to hold cables and/or devices (e.g., sensors, emitters, controllers, circuitry (e.g., circuit boards), and/or other electrical components), e.g., such as housing 2935, which may be a housing of one or more devices. The railing side may have any length that is smaller than the width of the framing cap. The width of the framing cap can be the same or larger than the width of the existing framing such as 2936. The width of the railing may be configured to accommodate the wiring. The length of the railing may be configured to hold the wiring in place. The length of the opening to the railing cavity may be configured for the wiring to go through. The housing 2935 is disposed partially in the interior of the framing cap 2932 and partially flush with an external surface of the framing cap portion 2933. The framing cap is disposed adjacent to a framing portion 2936 (e.g., mullion or transom) as part of the framing system. An intermediate body 2931 is disposed between the framing portion 2936 and the framing cap (including 2933 and 2934). The intermediate body may be configured to reduce heat exchange between the framing portion 2936 and (i) the framing cap (including 2933 and 2934), (iii) an interior of the framing cap 2932, (iii) the housing 2935, (iv) any device in the housing 2935, or (v) any combination thereof (e.g., any combination of (i), (ii), (iii), and (iv)). For example, sun radiation 2935 may shine on framing 2936 that is exposed to an ambient external environment of a facility, which sun radiation may cause the framing 2936 (e.g., and optionally also an interior of the framing 2930) to heat up. The intermediate body 2931 may be configured to reduce heat transfer from framing portion 2936 towards (i) the framing cap (including 2933 and 2934), (iii) an interior of the framing cap 2932, (iii) the housing 2935, (iv) any device in the housing 2935, or (v) any combination thereof. The intermediate body may reduce the heat transfer passively or actively. The intermediate body may reduce the heat transfer by cooling and/or by insulating.

FIG. 29B shows an example of a frame or framing cap portion shown in perspective view and an example for head conditioning. Portion 2950 is a framing cap or a framing portion (e.g., mullion or transom) as part of a framing system. Frame or framing cap portion 2950 is configured to accommodate a housing 2960 that includes one or more devices (e.g., a device ensemble). Frame or framing cap portion 2950 includes one end portion 2951 a second end portion 2952 opposing end portion 2951 along the length of frame or framing cap portion 2950. The frame or framing cap portion 2950 includes a first area 2953 close to the first end 2951, and a second area 2952 close to the second end 2952. The first area 2953 shows perforations (holes) 2955 located on the frame or framing cap portion 2950. The second area 2954 shows perforations (holes) 2956 located on the frame or framing cap portion 2950. The frame or framing cap portion 2950 includes a third area 2958 surrounding the housing 2960, and preformation 2957a, 2957b, 2957c, and 2957d in the third area. The perforations (e.g., holes) can be an array. The perforations may be grouped in groups such as 2955, 2957a/b/c/d, or 2956. The perforation in a group can be organized or disorganized (e.g., randomly located). The perforations can be arranged as a repeating lattice (e.g., as a matrix). The perforations can be disposed at any side of the frame or framing cap portion 2950. In the example shown in FIG. 29B, the perforation groups are disposed on a side of the frame or framing cap portion 2950. There may be one or more groups of perforations located anywhere along the Frame or framing cap portion. FIG. 29B shows an example of perforation groups located close to the ends of frame or framing cap portion 2950 and close to the housing 2960, which housing is disposed in the frame or framing cap portion 2950, and is flush with an external surface of the frame or framing cap portion 2950. The housing can be partially or entirely in the frame or framing cap portion. The housing can be partially or entirely out of the frame or framing cap portion. When the housing is disposed entirely out of the frame or framing cap portion, it may be attached to the frame or framing cap portion. The frame or framing cap portion can be disposed horizontally or vertically with respect to the gravitational center such as 2970. FIG. 29B show an example where the frame or framing cap portion 2950 is disposed along gravitational vector 2957 that points towards the gravitational center 2970. When the frame or framing cap portion 2950 experiences heat in its interior, which is higher than the ambient temperature, heat exchange may initiate. For example, gas (e.g., air) may travel upwards in the direction from the second end 2952 towards the first end 2952, opposing gravitational vector 2971. The gas (e.g., air) may exit any of the perforations it encounters along its travel path in the frame or framing cap portion 2950. Gas (e.g., air) may be sucked into the interior of the frame or framing cap portion 2950, e.g., during cooling and/or heat exchange. For example, the gas may enter through the perforations (e.g., 2956). The gas may preferentially enter one group of perforations (e.g., 2956) and exit another group of perforations (e.g., 2955), e.g., creating a convective heat exchange. Heat may be generated from one or more devices in the housing, e.g., during operation of the devices. The heat may exit through perforations, e.g., adjacent to the housing. Examples of temperature conditioning, control system, network, sensors, and device ensembles can be found in Provisional Patent Application Ser. No. 63/170,245 filed Apr. 2, 2021, titled “DISPLAY CONSTRUCT FOR MEDIA PROJECTION AND WIRELESS CHARGING,” which is incorporated herein by reference in its entirety.

In some embodiments, a housing of a device ensemble encloses at least one circuit board. The circuit board can be configured to accommodate (e.g., and accommodate) one or more devices. The board may have one side on which the circuitry and/or devices are disposed. The one side may face the front of the housing. The front of the housing may face an occupant in the enclosure in which the housing is disposed. The one side may face the back of the housing. The back of the housing may face away from an occupant in the enclosure in which the housing is disposed. The board may have two sides onto which the circuitry and/or devices are disposed. The board may have one or more holes (e.g., FIG. 10, 1003). The holes may facilitate passing of at least one environmental characteristic. The holes may facilitate passing of gas, sound, or electromagnetic radiation. For example, a sensor may be disposed at a back of the circuit board and sense an environmental quality that reaches the sensor from the enclosure, through the one or more holes. The board may have first device(s) disposed on a first side, and circuitry disposed on a second side. The board may have first device(s) disposed on a first side, and second device(s) disposed on a second side. The board may include one or more heat sinks. The heat sink(s) may be disposed at locations that are prone to heat generation and/or accumulation. The board may be operatively coupled and/or include partition(s). The partition(s) may be utilized to reduce unwanted consequences (e.g., interference) of device coexistence in the housing and/or on the board. The housing may comprise one or more circuit boards. The circuit boards may be communicatively coupled with each other (e.g., directly or indirectly). The circuit boards may be operatively (e.g., communicatively) coupled to each other by wiring and/or wireless. The circuit boards may be operatively (e.g., communicatively) coupled to the network by wiring and/or wirelessly.

In some embodiments, the device ensemble (e.g., digital architectural element DAE) comprises a processing unit. The processing unit may comprise circuitry, memory, and be configured for processing capabilities. The device ensemble may comprise a plurality of circuit boards. At least two of the plurality of circuit boards may be disposed (e.g., substantially) parallel to each other (e.g., in the DAE housing). At least two of the plurality of circuit boards may be disposed (e.g., substantially) in the same plane. At least two of the plurality of circuit boards may be disposed (e.g., substantially) in different planes. At least two of the plurality of circuit boards may be disposed (e.g., directly) adjacent to each other. Directly adjacent to each other excludes an intervening circuit board. At least two of the plurality of circuit boards may be disposed to allow shielding element, cooling element, and/or gas to flow therebetween.

In some embodiments, at least two of the plurality of circuit boards may be disposed in a manner that facilitates gas flow therebetween. The gas flow may be active or passive. The gas flow may comprise conduction or convection. The gas flow may comprise heating of gas surrounding at least one of the circuit boards, followed by (e.g., passive) temperature equilibration. The gas flow may comprise hot gas flow to cooler area. The gas flow may comprise laminar and/or turbulent gas flow. The gas flow may be in an upwards direction (e.g., against the gravitational center). The gas flow may comprise movement of gas during its temperature equilibration. The gas flow may be active. The gas flow may be directed into the device ensemble by a gas tube and/or actuator (e.g., fan). At least one actuator (e.g., fan) may be disposed in the DAE housing, as part of the DAE housing, or outside of the DAE housing. At least one actuator may be configured to suck external gas (e.g., air) and direct it into the DAE interior (e.g., push gas into the DAE). At least one actuator may be configured to suck internal gas (e.g., air) and direct it out of the DAE interior (e.g., expel gas out of the DAE). The gas may be directed into the DAE by a tube. The DAE may comprise one or more opening through which the gas can ingress and egress out of the DAE (e.g., passively and/or actively). The opening(s) may comprise slits or holes. At least one opening may be the same as the opening in the lid of the housing (e.g., configured to allow functionality of the sensor(s) and/or emitters). At least one opening may be different from the opening in the lid of the housing (e.g., configured to allow functionality of the sensor(s) and/or emitters). At least one opening may be a gap between the DAE housing and its lid. At least one opening may be at or adjacent to connectors (e.g., sockets) of the DAE. The gas entering the DAE may be cooled. The gas may be cooled before or during its entry into the DAE. The gas cooler may be any (e.g., active) cooling device disclosed herein.

In some embodiments, at least two of the plurality of circuit boards may be disposed in a manner that facilitates shielding, heat exchange and/or cooling element disposed therebetween. At least one shielding element may be disposed between a first circuit board and a second circuit board that are located (e.g., directly) adjacent to each other. The shielding element may comprise electrical and/or electromagnetic (e.g., radio frequency) shielding. The shielding may or may not act as a heat exchanger and/or cooling element. The ensemble may comprise a heat exchanger and/or cooling element that is separate from the shielding. The heat exchanger and/or cooling element may comprise a heat pipe, or a metallic slab. Metallic may comprise elemental metal or metal alloy. The metal may be configured for (e.g., efficient and/or rapid) heat conduction. The metal may comprise copper, aluminum, brass, steel, or bronze. The cooling element may comprise a fluid, gaseous, or semisolid (e.g., gel) material. The cooling element may be active and/or passive. The cooling element may comprise a circulating substance. The cooling element may be operatively coupled to an active cooling device (e.g., thermostat, cooler, and/or refrigerator). The active cooling device may be disposed externally to the device ensemble housing. The cooling element may be disposed in a fixture (e.g., the floor, ceiling, or wall) of the enclosure (e.g., building or room) in which the device ensemble is disposed. The fixture may comprise a mullion or transom.

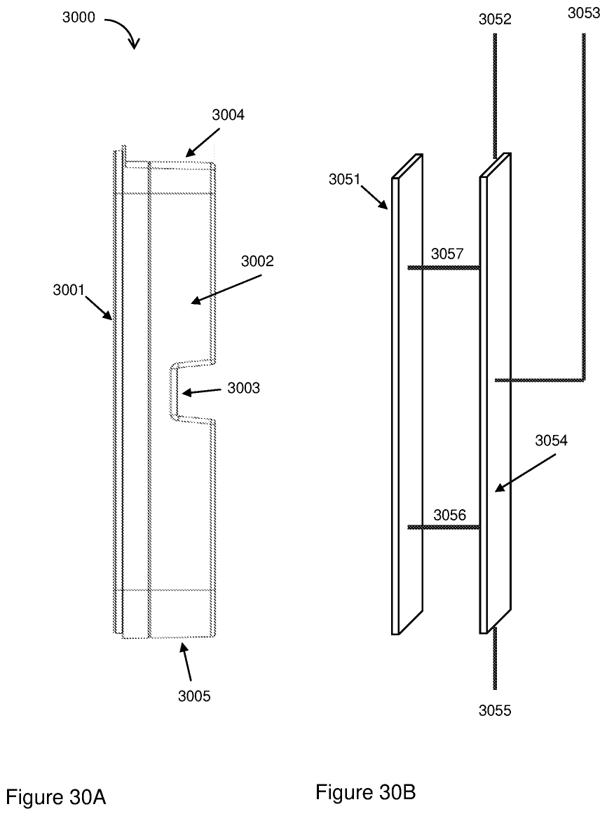

FIG. 30A shows an example of a side view of a device ensemble housing (DAE housing). 3002 shows a side view of a body of the DAE, and 3001 show a side view of a lid of the DAE. The DAE may comprise one or more openings and/or connectors, which may be disposed in various DAE portions, e.g., in 3004, 3003, and 3005. The connectors may be any of the ones disclosed herein. FIG. 30B shows a perspective view of two circuit boards 3051 and 3054. The circuit boards can be housed in the DAE. The two circuit boards 3051 and 3054 are disposed parallel to each other, and directly adjacent to each other. When housed in a DAE housing, circuit board 3051 can be a front facing circuitry board that is closer to the lid 3001, and circuit board 3054 can be a back facing circuitry board, that is more distant from the lid 3001 relative to circuit board 3051. The circuitry boards can be electrically connected or disconnected. FIG. 30B show two section 3057 and 3056 between circuitry board 3051 and 3054. At least one of the two sections 3057 and 3056 may comprise electrical connections (e.g., wires and/or cables) that electrically connect the circuitry of 3051 to 3054. At least one of the two sections 3057 and 3056 may comprise an electrical insulator that electrically separate the circuitry of 3051 to 3054. At least one of the circuitry boards may be electrically connected to an external network via wiring (e.g., cabling). FIG. 30B shows an example in which circuit board 3054 is connected externally to a network via wiring (e.g., 3052, 3053, and 3055). The electrical wiring may be configured to transmit power and/or communication. In some examples, the cable transmitting the power is separate from the cable transiting the communication. In some examples, the cable transmitting the power also the cable transiting the communication (e.g., a coaxial cable). At least one of the wiring is configured to transit power over ethernet (POE). At least one of the wiring can be an incoming communication port, and at least one of the wiring can be an outgoing communication port. For example, wiring 3052 and 3053 can be incoming PoE wiring, and wiring 3055 can be an outgoing PoE wiring.

In some embodiments, the DAE may have a plurality of circuit boards. Two of the plurality of circuit boards may differ by at least one functionality. Two of the plurality of circuit boards may have at least one functionality that is the same. For example, one circuit board (e.g., 3051) may comprise sensor(s) that are absent from the second circuit board (e.g., 3054). For example, one circuit board (e.g., 3051) may comprise emitter(s) (e.g., buzzer) that are absent from the second circuit board (e.g., 3054). For example, one circuit board (e.g., 3054) may comprise a processor (e.g., comprising a memory) that is absent from circuit board (e.g. 3051). The processor may be any processor disclosed herein. The processor may process information relating to functionalities of the DAE in which it is disposed (e.g., coexistence), relating to functionalities of another DAE (e.g., disposed in the same or in another enclosure), to information unrelated to (e.g., any) DAE, or to any combination thereof (e.g., at different times).

In some embodiments, the DAE may comprise a circuitry disposed in a circuit board (e.g., a printed circuit board (PCB)). The circuitry board may comprise a central processing unit (CPU), graphical processing unit (GPU), memory (e.g., of the GPU and/or CPU), protocol data unit (PDU), network components (e.g., to enable wired and/or wireless communication), and security related components (e.g., encryption and/or decryption codes). The central processing unit may comprise a graphical processing unit. In some examples, the circuit boards may comprise a plurality of processing units. FIG. 31 shows a schematic example of a circuit board 3102 comprising a GPU, PDU, network components (abbreviated as “network comp.”), memory, and security related information (e.g., tokens).

In some examples, the device ensemble may comprise sensors. The sensors may be disposed in one circuit board. At least two sensors may be disposed in the same circuit board of the DAE. At least two sensors may be disposed in different circuit boards of the DAE. In some examples, the device ensemble may comprise emitters. The emitters may be disposed in one circuit board. At least two emitters may be disposed in the same circuit board of the DAE. At least two emitters may be disposed in different circuit boards of the DAE. A circuitry board may comprise one type of functionality while another circuit board may comprise different functionality. For example, one circuit board may comprise processor and network related functionalities, while another circuit board may comprise sensing and/or emitting functionality. For example, one circuitry board may be dedicated to devices related sensing, while the other circuit board may be dedicated to devices relating to collaboration between individuals. FIG. 31 shows an example of circuit board section 3101 to which various sensors are connected (e.g., volatile organic compounds (VOC), light, carbon dioxide (CO₂), dust, infrared (IR), temperature and humidity (abbreviated as “T/H”) sensors); and circuit board section 3103 to which collaboration related devices are connected (e.g., a camera, a microphone (Mic), and speaker(s). The microphone device can comprise a microphone array. each of the circuit board section 3101 and 3102 can be a different circuitry board. The circuit board section 3101 and 3102 can be disposed in the same physical board and/or circuit board.

The DAE may comprise a plurality of functionalities. The functionalities may include collaboration, processing, memory, storage, power, network communication, sensing, emitting, and/or security. The power may comprise power supply and/or regulation. The sensors may include temperature, humidity, VOC, carbon dioxide, particulate matter 9 e.g., dust), light (e.g., lux), and/or vibration. The sensors may be any sensor disclosed herein. The Network related components (e.g., network module) may include protocol data unit (PDU), ethernet components (e.g., gigabit ethernet (GigE) components), ultrawideband (UVB) components, Bluetooth (BLE) components, and/or Wi-Fi components. The processing related module may comprise 1, 2, or more (e.g., quad-core ARM) CPUs, random access memory (e.g., 16 GB RAM), storage device. The storage device may comprise flash memory. The storage device may comprise a solid state storage device (SSD). The storage device may comprise at least about 2, 4, 6, or 8 terabits (TB). The storage device may operate using total productive maintenance (TPM). The memory module may comprise a temporary file storage that appears as a mounted file system (tmpfs), in which data is stored in volatile memory (e.g., instead of in a persistent storage device). The processor may comprise a graphic processing unit (GPU), e.g., a NVIDIA® Jetson Nano™ GPU. The processor may be configured to facilitate operating a plurality of neural networks (e.g., in parallel). The processing unit may be configured for applications like image classification, object detection, segmentation, and/or speech processing. The processing unit may require at most 3, 4, 5, 8, or 10 watts to operate. The DAE (e.g., processor, network, and/or collaboration module) may be configured for media display and/or touch screen capabilities. Examples of media display (e.g., display construct) and touch screen and their control can be found in International Patent Application Serial No. PCT/US20/53641 filed on Sep. 30, 2020, titled “TANDEM VISION WINDOW AND MEDIA DISPLAY,” which is incorporated herein by reference in its entirety.

In some embodiments, the DAE comprises a plurality of circuit boards. At least one of the circuit boards of the DAE (e.g., at least two of the circuit boards and/or all of the circuit boards) can be a double sided circuit board (e.g., both sides of the circuit board comprise circuitry. At least one of the circuit boards of the DAE (e.g., at least two of the circuit boards and/or all of the circuit boards) can be a single sided circuit board (e.g., one side of the circuit board comprise circuitry. Devices can reside on one side of the circuit boards or on one side. In some embodiments, the sensor(s) and/or emitter(s) reside on the same board where the processor, storage and/or network functionalities reside. In some embodiments, the side of the circuit board comprising the sensor(s) and/or emitter(s) is where the processor, storage and/or network functionalities reside. In some embodiments, the side of the circuit board comprising the sensor(s) and/or emitter(s) is different from the side where the processor, storage and/or network functionalities reside. In some embodiments, the circuit boards are connected (e.g., back to back) to form a single unit. In some embodiments, the circuit boards are disconnected to form different units (e.g., that may be electrically connected via wiring, e.g., as in FIG. 30B). Examples of temperature conditioning, control system, network, sensors, and device ensembles can be found in U.S. Provisional Patent Application Ser. No. 63/079,851, which is incorporated herein by reference in its entirety.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A method, comprising:
collecting temperature measurements from a plurality of temperature sensors mounted at locations in an enclosure, wherein one or more of the temperature sensors are subject to temperature biasing by one or more environmental characteristics;
applying the temperature measurements to a bias-correcting model and thereby correcting bias in the temperature measurements and generating corrected temperature measurements; and
controlling, based at least in part on the corrected temperature measurements, an environment of the enclosure to maintain a thermal profile in the enclosure.

2. The method of claim 1, wherein the controlling includes controlling one or more elements of the enclosure include a building system, a climate control element, heating, ventilation, and air conditioning (HVAC) system, a tint level of a tintable window, or a combination thereof.

3. (canceled)

4. The method of claim 1, wherein:
the plurality of temperature sensors includes a first subset of temperature sensors and a second subset of temperature sensors,
the first subset of temperature sensors includes the one or more temperature sensors that are subject to the temperature biasing by the one or more environmental characteristics,
the second subset of temperature sensors does not include the one or more temperature sensors that are subject to the temperature biasing by the one or more environmental characteristics, and
the bias-correcting model is applied to the first subset of temperature sensors and not to the second subset of temperature sensors.

5. The method of claim 1, wherein at least one temperature sensor of the one or more temperature sensors that are subject to the temperature biasing by the one or more environmental characteristics is disposed in an envelope of the enclosure, in a framing portion of a window or door, a mullion, and/or a transom, a southern facing or partially southern facing wall of the enclosure.

6-7. (canceled)

8. The method of claim 1, wherein the environmental characteristics include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof.

9. (canceled)

10. The method of claim 1, further comprising collecting data regarding the environmental characteristics, wherein the bias-correcting model is based, at least in part, on the data.

11. (canceled)

12. (canceled)

13. The method of claim 1, wherein the bias-correcting model comprises a machine learning model.

14. The method of claim 1, wherein the bias-correcting model comprises associating bias among (i) temperature measurements in empirical data from sensors in standardized sensor installation configurations and (ii) auxiliary temperature measurements of volumes of air at or adjacent to the standardized sensor installation configurations across a range of one or more environmental characteristics.

15-16. (canceled)

17. The method of claim 1, wherein the applying is performed at one or more times when biasing of the one or more temperature sensors is estimated and/or predicted.

18. The method of claim 17, wherein the one or more times are based, at least in part, on weather conditions, predicted weather conditions, predicted sun irradiation, measured sun irradiation, occupation of the enclosure, a schedule, a timetable of the enclosure, operation of one or more building systems, an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, or a combination thereof.

19-21. (canceled)

22. The method of claim 1, further comprising extrapolating the corrected temperature measurements according to a plurality of grid points arranged between the locations of the temperature sensors based at least in part on an estimate of heat transfer in the enclosure to generate grid point temperatures.

23. The method of claim 22, wherein extrapolating the corrected temperature measurements comprises projecting temperature gradients extending from the locations of the temperature sensors to the grid points.

24. The method of claim 23, wherein the temperature gradients are calculated from a heat transfer rate and the heat transfer rate is characterized by heat conduction.

25-26. (canceled)

27. The method of claim 23, wherein the temperature gradients are modeled based at least in part on a physics simulation.

28-33. (canceled)

34. The method of claim 22, further comprising converting the grid point temperatures to a mapping of a thermal profile.

35. The method of claim 34, wherein the mapping of the thermal profile is utilized to define an operative temperature at a specified grid point that combines a corresponding grid point temperature and an estimated statistical computation based at least in part on a radiant temperature to generate estimated radiant temperature.

36-43. (canceled)

44. The method of claim 1, further comprising determining that the one or more of the temperature sensors are subject to a temperature bias, wherein the determining is based, at least in part, on the collected temperature measurements.

45. The method of claim 44, wherein the determining is further based, at least in part, on environmental characteristics that include one or more of an outside atmospheric temperature, a solar angle, a solar elevation, a difference between solar azimuth and window azimuth, a solar intensity, solar radiation wavelengths, a solar penetration depth into the enclosure, a tint state of one or more tintable windows of the enclosure, a sensor orientation, one or more properties of a framing portion proximate to a temperature sensor, one or more surface properties external to the enclosure, a proximity of the temperature sensor to an HVAC outlet, a proximity of the temperature sensor to a diffuser, one or more insulation properties of the enclosure, geographic coordinates of the facility and/or orientation of its façades, window elevation, facility elevation, size and/or placement of facility overhangs, HVAC setpoint, sensor ensemble heat transfer parameters, thermal properties of sensor mounting fixtures, sun-load information, location of vents, airflow speed, air pressure, humidity, window framing heat transmittance, data collected by façade-level oriented photosensor readings, façade-level oriented electromagnetic sensor readings, façade-level oriented optical sensor readings, external photosensor readings, skyward photosensor readings, skyward electromagnetic sensor readings, skyward optical sensor readings, cloud cover, humidity, air quality index readings, or a combination thereof.

46-51. (canceled)

52. An apparatus, the apparatus comprising at least one controller comprising circuitry, which at least one controller is configured to:
collect, or direct the collection of, temperature measurements from a plurality of temperature sensors mounted at locations in an enclosure, wherein one or more of the temperature sensors are subject to temperature biasing by one or more environmental characteristics;
apply, or direct the application of, the temperature measurements to a bias-correcting model and thereby correcting bias in the temperature measurements and generating corrected temperature measurements; and
control, or direct the control of, based at least in part on the corrected temperature measurements, the environment of the enclosure to maintain a thermal profile in the enclosure.

53-125. (canceled)

126. A method for maintaining a target thermal profile in an enclosure, the method comprising:
collecting temperature measurements from temperature sensors mounted at locations in the enclosure;
quantifying one or more environmental characteristics biasing the temperature measurements with respect to temperatures of volumes of air at or adjacent to the locations of the sensors;
correcting bias in the temperature measurements based at least in part on the one or more environmental characteristics as one or more correction factors to generate corrected temperature measurements;
extrapolating the corrected temperature measurements according to a plurality of grid points arranged between the locations of the temperature sensors based at least in part on an estimate of heat transfer in the enclosure to generate grid point temperatures;
converting the grid point temperatures to a mapping of a thermal profile; and
using the mapping to control the one or more environmental characteristics of the enclosure in order to obtain the target thermal profile.

127-210. (canceled)
